(19) United States
(12) Patent Application Publication
(10) Pub. No.: US 2010/0179926 A1
(43) Pub. Date: Jul. 15, 2010

(54) FACILITATING COMMERCIALIZATION OF INNOVATIVE IDEAS

(76) Inventors: Todd Stancombe, Charlotte, NC (US); Chad Tillman, Matthews, NC (US); Matt Spangard, Charlotte, NC (US); John Meacham, Charlotte, NC (US); Louis Foreman, Huntersville, NC (US)

Correspondence Address: TILLMAN WRIGHT, PLLC, P.O. BOX 49309, CHARLOTTE, NC, 28277-0076, US

(21) Appl. No.: 12/649,012

(22) Filed: Dec. 29, 2009

Related U.S. Application Data
(63) Continuation-in-part of application No. 11/423,447, filed on Jun. 11, 2006.
Application No. 11/423,447 is a continuation-in-part of application No. 11/423,448, filed on Jun. 11, 2006.
(60) Provisional application No. 60/746,651, filed on May 7, 2006.
(60) Provisional application No. 60/746,651, filed on May 7, 2006.
(60) Provisional application No. 61/141,234, filed on Dec. 29, 2008.

(51) Int. Cl. G06Q 90/00

(52) U.S. Cl. 705/500

(57) ABSTRACT

A method includes receiving at a publicly advertised casting call ideas without any confidentiality obligations and without any use restriction; identifying a product embodying each idea; considering patentability and commercial feasibility of the product; selecting some of the ideas based on these considerations; acquiring all intellectual property rights in the selected ideas in exchange for predetermined consideration; bringing to market respective commercial products embodying the respective selected ideas; video recording performance of the steps; and producing a broadcast program including the video recording. A method of commercializing an idea includes contracting to deliver an idea for a product; requesting that ideas be submitted; providing a website configured to allow users to submit ideas; storing submitted ideas; communicating one of the submitted ideas; and receiving compensation.

### CROSS-REFERENCE TO RELATED APPLICATIONS

The present application is
(a) a U.S. continuation-in-part patent application of, and claims priority under 35 U.S.C. §120 to, U.S. nonprovisional patent application Ser. No. 11/423,447, filed Jun. 11, 2006, which '447 application and any patent application publications thereof, including U.S. patent application publication No. 2007/0260468, are hereby incorporated herein by reference, and which '447 application is
   (i) a U.S. nonprovisional patent application of, and claims priority under 35 U.S.C. §119(e) to, U.S. provisional patent application Ser. No. 60/746,651, filed May 7, 2006, which '651 application is hereby incorporated herein by reference;
(b) a U.S. continuation-in-part patent application of, and claims priority under 35 U.S.C. §120 to, U.S. nonprovisional patent application Ser. No. 11/423,448, filed Jun. 11, 2006, which '447 application and any patent application publications thereof, including U.S. patent application publication No. 2007/0260469, are hereby incorporated herein by reference, and which '447 application is
   (i) a U.S. nonprovisional patent application of, and claims priority under 35 U.S.C. §119(e) to, U.S. provisional patent application Ser. No. 60/746,651, filed May 7, 2006; and
(c) a U.S. nonprovisional patent application of, and claims priority under 35 U.S.C. §119(e) to, U.S. provisional patent application Ser. No. 61/141,234, filed Dec. 29, 2008, which '234 application is hereby incorporated herein by reference.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to systems, methods, and apparatus for facilitating the commercialization of innovative ideas.

Ordinary people have extraordinary ideas. Unfortunately, ordinary people do not know what to do when they have such extraordinary ideas. Moreover, ordinary people may not be able to correctly assess whether their ideas are, indeed, extraordinary. They often lack the funds necessary to fully assess marketability and patentability of their ideas, both of which are important in determining whether an idea is, in fact, truly extraordinary. As a consequence, extraordinary ideas often are lost to the public at large.

Perhaps worse still, an ordinary person having an idea, whether extraordinary or not, may become the victim of an invention promotion company. In this regard, the ordinary person may be enticed to spend significant money without understanding the services or the benefits provided by services of an invention promotion company, and the ordinary person may be enticed or even deceived into thinking that the idea is extraordinary and of great commercial value. Indeed, often the ordinary person has a misconception as to the services that are being provided by the invention promotion company and as to the worth of the idea.

Moreover, no code of ethics or professional responsibility governs invention promotion companies. This has resulted in cases of abuse by invention promotion companies and, in fact, the federal authorities and several state authorities have made attempts, through appropriate legislation and other means, to safeguard such ordinary people from the abuses that too often occur. An as example of this, the Federal Trade Commission recently won a lawsuit against an invention promotion company for deceptive practices including false and misleading statements that were being made to inventors. The lawsuit resulted in $26 million in redress to wronged inventors. Needless to say, however, many ordinary people do have extraordinary ideas and do engage invention promotion companies, only to ultimately find themselves dissatisfied with the results and without remedy or restitution.

An alternative to ordinary people engaging invention promotion companies is for such ordinary people to seek patent protection individually as independent inventors by engaging professional legal counsel. As a practical matter, however, this approach generally is not viable. The patent process in the United States often requires significant monetary investment, especially if professional services are utilized, and such investment often is out of reach of the ordinary person.

Moreover, any patent that is obtained protects from copying in the marketplace by competitors, but it does not, in and of itself, bring a great idea to market nor provide a source of revenue. To fully commercialize extraordinary ideas, ordinary people with extraordinary ideas must be successful in bringing products embodying their ideas to market or in finding licensees to do so on their behalf. Unfortunately, successfully engaging in product design, manufacturing, and distribution for retail sale for a product embodying a great idea can be more complex, more time consuming, and more expensive than the patenting process itself, and such ordinary people are faced with an almost insurmountable challenge in doing so.

From the foregoing, it will be apparent that the odds are discouraging that an extraordinary idea of an ordinary person will ever be commercialized. Consequently, society likely will not benefit from the creative inventiveness of the ordinary person.

Further, many commercial entities are reluctant to converse directly with individuals. A need exists for an interface between innovators and commercial entities that can provide innovative ideas to entities, and assist innovators with commercializing their innovations. This, and other needs, are addressed by one or more aspects of the present invention.

### SUMMARY OF THE INVENTION

The present invention includes many aspects and features. Moreover, while many aspects and features relate to, and are described in, the context of facilitating the commercialization of innovative ideas, the present invention is not limited to use only in this context, as will become apparent from the following summaries and detailed descriptions of aspects, features, and one or more embodiments of the present invention.

Accordingly, one aspect of the present invention relates to a method of finding extraordinary ideas of ordinary people for commercialization. The method includes: (a) receiving, by a first party, from each of a plurality of persons, a disclosure of an idea of the person; (b) for each person from whom a disclosure of an idea is received in said step (a), (i) identifying, by the first party, a good or service (collectively “Product”) embodying the disclosed idea, (ii) considering, by the first party, patentability of the Product; and (iii) considering, by the first party, commercial feasibility of the Product; (c) selecting, by the first party, an idea from the plurality of received ideas based on the considerations of said step (b); and (d) acquiring, by the first party, intellectual property rights in the idea selected in said step (c) in exchange for certain consideration.

The first party may include a company and any subsidiaries and affiliates thereof. Each of the companies, subsidiaries, and affiliates may be a limited liability company, a corporation, a partnership, or a trust, or any other legal entity. Preferably, all rights in the intellectual property are acquired in said step (d). This would include title to any patent or patent application for an apparatus and/or method that embodies the idea that is selected.

In a feature of this aspect, the certain consideration (i.e., “consideration” in a legal contract sense) of said step (d) is predetermined prior to receiving the disclosure of the idea from the person disclosing the idea. The consideration may be an annuity agreement between the first party and the person from whom the disclosure of the selected idea is received. The consideration may include, for example: the right to receive a percentage of monies received from sales of the Product; the right to receive a percentage of monies received from sales of any good or service that is covered by a patent application that is filed disclosing the Product; the right to receive a percentage of monies received from sales of any good or service that is covered by a patent that is granted disclosing the Product; and/or the right to receive a percentage of monies received from licensing of rights under a patent application that is filed that discloses the Product, or under a patent that is granted that discloses the Product, or both.

In another feature, the method further includes the step of requiring each person, from whom an idea is received in said step (a), to first agree to an obligation of assignment of intellectual property rights in the idea from such person to the first party should the idea be selected in said step (c), the agreement to the obligation of assignment being a “condition precedent” (in a legal contract sense) to performance of the method by the first party with regard to such person's idea.

In yet another feature of the invention, the method further includes the step of requiring each person, from whom an idea is received in said step (a), to first consent to the video recording of the person for use in a broadcast program, the consent being a condition precedent to performance of the method by the first party with regard to such person's idea. The video recording may include any story behind the idea of the person, such as, for example, how the person conceived of the idea and if it was to address any particular problem with which the person was confronted. The broadcast program comprises one of the group of a reality television program and a documentary, or both.

In still yet another feature of this aspect, said step (b) is performed by a panel of people. The panel of people may include at least one of (and preferably all of) a patent attorney, an engineer, and a marketing person. The method further preferably includes the video recording of a disclosure to the panel of a subset of the ideas received in said step (a).

In another feature of this aspect, said step (b) includes considering patentability and commercial feasibility of a variation of the Product; considering design and manufacturing of the Product; and/or considering market demand and size of the market for the Product.

In yet another feature of this aspect, the method includes performing said step (a) at a publicly advertised casting call for ideas and, before the casting call, publicizing a contractual agreement governing the relationship between the first party and each respective person from whom an idea is received in said step (a), execution of the contractual agreement being a condition precedent (in the legal contract sense) to performance of said step (a) by the first party.

Another aspect of the invention relates to a method of commercializing extraordinary ideas of ordinary people. The method includes the steps of: (a) receiving, by a first party, from each of a plurality of persons, a disclosure of an idea of the person; (b) for each person from whom a disclosure of an idea is received in said step (a), (i) identifying, by the first party, a good or service (collectively “Product”) embodying the disclosed idea, (ii) considering, by the first party, patentability of the Product, and (iii) considering, by the first party, commercial feasibility of the Product; (c) selecting, by the first party, a plurality of ideas from the plurality of received ideas based on the considerations of said step (b), wherein the number of ideas selected in said step (c) is less than the number of persons from whom the plurality of ideas are received in said step (a); (d) acquiring, by the first party, intellectual property rights in the ideas selected in said step (c) in exchange for consideration to each respective person who disclosed a selected idea; and (e) for each of a plurality of the ideas selected in said step (c), bringing to market a respective commercial product embodying the respective selected idea after the intellectual property rights in the selected idea have been acquired in said step (d).

In a feature of this method, said step (e) comprises conducting ideation for a commercial product embodying the idea selected in said step (c) after acquiring all intellectual property rights in the idea in said step (d).

In another feature of this method, said step (e) comprises conducting packaging design for a commercial product embodying the idea selected in said step (c) after acquiring all intellectual property rights in the idea in said step (d); conducting engineering for a commercial product embodying the idea selected in said step (c) after acquiring all intellectual property rights in the idea in said step (d); manufacturing a commercial product embodying the idea selected in said step (c) after acquiring all intellectual property rights in the idea in said step (d); and/or licensing rights under a patent property covering a commercial product embodying the idea selected in said step (c) after acquiring all intellectual property rights in the idea in said step (d). The engineering may include prototyping.

In another feature, the method further comprises performing said step (a) at a publicly advertised casting call for ideas. The casting call for ideas preferably is publicized via radio, television, or both, and the method preferably includes publicizing, before the casting call, a contractual agreement governing the relationship between the first party and each respective person disclosing an idea in said step (a). The contractual agreement preferably is published on the Internet prior to the casting call, and the Internet address for the contractual agreement preferably is included in the publication of the casting call. Preferably, the contractual agreement is executed by each of the plurality of persons disclosing an idea in said step (a) before respective performance of said step (a) by the first party for each of the persons. Indeed, execution of the contractual agreement by the plurality of persons disclosing an idea in said step (a) preferably comprises a condition precedent (in the legal contract sense) to performance of said step (a) by the first party with regard to each respective person.

Another aspect of the invention relates to a method of commercializing extraordinary ideas of ordinary people that includes the steps of: (a) receiving, by a first party, from each of a plurality of persons, a disclosure of an idea of the person; (b) for each person from whom a disclosure of an idea is received in said step (a), (i) identifying, by the first party, a good or service (collectively “Product”) embodying the disclosed idea, (ii) considering, by the first party, patentability of the Product; and (iii) considering, by the first party, commercial feasibility of the Product; (c) selecting, by the first party, a plurality of ideas from the plurality of received ideas based on the considerations of said step (b), wherein the number of ideas selected in said step (c) is less than the number of persons from whom the plurality of ideas are received in said step (a); (d) acquiring, by the first party, intellectual property rights in the ideas selected in said step (c) in exchange for consideration to each respective person who disclosed a selected idea; (e) for each of a plurality of the ideas selected in said step (c), bringing to market commercial products that respectively embody the plurality of selected ideas; (f) video recording performance of said steps (a) and (e); and (g) producing a broadcast program including the video recording of said step (f).

In a feature of this aspect, said steps (a)-(g) are performed in connection with a season of the broadcast program, and further comprising repeating said steps (a)-(g) in connection with a subsequent season of the broadcast program.

In another feature, said step of bringing to market commercial products in said step (e) includes promoting the commercial products in the broadcast program produced in said step (g).

In another feature, said step of bringing to market commercial products in said step (e) includes marketing the commercial products including conducting branding and advertising campaigns. Marketing may also include web development to commercially offer a product embodying an idea selected in said step (c) and capturing television responses from viewers who are potential consumers.

In another feature, said step (e) comprises licensing, to a third party, rights under a patent covering a commercial product embodying the idea selected in said step (c) and, further, promoting the third party in the broadcast program produced in said step (g).

In yet another feature, said step (e) comprises selling, to a third party, commercial products that embody the idea selected in said step (c) and, further, promoting the third party in the broadcast program produced in said step (g).

In still yet another feature, the method further includes the step of performing said step (a) at a publicly advertised casting call for ideas and, before the casting call, publicizing a contractual agreement governing the relationship between the first party and each respective person disclosing an idea in said step (a). The contractual agreement preferably is executed by each of the plurality of persons disclosing an idea in said step (a) before respective performance of said step (a) for each of the persons. Indeed, execution of the contractual agreement by the plurality of persons disclosing an idea in said step (a) preferably is a condition precedent to performance of said step (a), and the contractual agreement preferably provides for the transfer of all intellectual property rights in an idea received in said step (a) if the idea is selected in said step (c).

Another aspect of the present invention relates to a method of commercializing an innovative idea. The method includes contracting, with an entity, to deliver an innovative idea for a commercial product in exchange for compensation; requesting that an innovative idea be submitted; storing, in a computer readable medium at a server, a website configured to allow users of the website to submit innovative ideas; storing, in a database at a server, data representative of innovative ideas submitted by the plurality of users; communicating, to the entity, an innovative idea submitted by one of the users; and receiving, from the entity, compensation.

In a feature of this aspect of the invention, the entity is a retailer.

In a feature of this aspect of the invention, the entity is a manufacturer.

In a feature of this aspect of the invention, the commercial product is a consumer product.

In a feature of this aspect of the invention, the commercial product is a product for use in a home.

In a feature of this aspect of the invention, the commercial product is an electronic product.

In a feature of this aspect of the invention, the commercial product is a toy.

In a feature of this aspect of the invention, the commercial product is a novelty product.

In a feature of this aspect of the invention, the step of requesting that an innovative idea be submitted comprises displaying, on the website, a request for innovative ideas.

In a feature of this aspect of the invention, the step of displaying, on the website, a request for innovative ideas includes identifying the entity.

In a feature of this aspect of the invention, the website is configured to allow administrative users of the website to post a request for innovative ideas.

In a feature of this aspect of the invention, the compensation includes payments based on sales of products incorporating the communicated innovative idea.

In a feature of this aspect of the invention, the compensation includes payments based on total receipts stemming from sales of products incorporating the communicated innovative idea.

In a feature of this aspect of the invention, the payments are quarterly payments.

In a feature of this aspect of the invention, the website is written using Ruby on Rails.

In a feature of this aspect of the invention, the database utilizes MySQL.

In a feature of this aspect of the invention, the method further includes paying, to the one of the users who submitted the communicated innovative idea, an annuity.

In a feature of this aspect of the invention, the annuity is based on total receipts stemming from sales of products incorporating the communicated innovative idea.

In a feature of this aspect of the invention, the method further includes entering into an agreement with the users of the website that submit innovative ideas.

Another aspect of the present invention relates to a method of developing a product. The method includes contracting, with an entity, to deliver an innovative idea for a commercial product; requesting that an innovative idea be submitted; receiving, from a plurality of persons, a plurality of innovative ideas; reviewing the plurality of innovative ideas; selecting an innovative idea from among the plurality of innovative ideas; communicating, to the entity, the selected innovative idea; manufacturing a commercial product based on the selected innovative idea; wherein said step of manufacturing the commercial product comprises transforming raw materials into the commercial product.

In a feature of this aspect of the invention, the raw materials comprise plastic.

In a feature of this aspect of the invention, the raw materials comprise aluminum.

In a feature of this aspect of the invention, the raw materials comprise metal.

In a feature of this aspect of the invention, the raw materials comprise rubber.

In a feature of this aspect of the invention, said step of manufacturing comprises molding.

In a feature of this aspect of the invention, said step of manufacturing comprises heating.

In a feature of this aspect of the invention, said step of manufacturing comprises melting.

In a feature of this aspect of the invention, said step of manufacturing comprises securing a first raw material to a second raw material, whereby said first and second raw materials are transformed from an unsecured state to a secured state.

Another aspect of the present invention relates to a method of generating revenue by providing an innovative idea to an entity. The method includes contracting, with a first entity, to perform a first search for an innovative idea for a commercial product in exchange for compensation; storing, in a computer readable medium at a server, a website configured to allow users of the website to submit innovative ideas for the first search; displaying, on the website, a request for innovative ideas for the first search; storing, in a database at a server, data representative of innovative ideas submitted by the users; rejecting an innovative idea of the plurality of innovative ideas; storing data representative of the rejected innovative idea in a database at a server; contracting, with a second entity, to perform a second search for an innovative idea for a commercial product in exchange for compensation; communicating, to the second entity, the rejected innovative idea; and receiving, from the second entity, compensation.

Another aspect of the present invention relates to a method of commercializing an innovation. The method includes entering into an agreement, with an entity, to deliver an innovation for a commercial product; requesting that an innovation be submitted; receiving, from a plurality of users, a plurality of innovations; reviewing the plurality of innovations; selecting an innovation from among the plurality of innovations; communicating, to the entity, the selected innovation; and manufacturing a commercial product that incorporates the innovation as defined by the agreement; wherein said step of manufacturing the commercial product comprises transforming raw materials into the commercial product.

Another aspect of the present invention relates to a method of commercializing an innovation. The method includes entering into an agreement, with an entity, to deliver an innovation for a commercial product; requesting that an innovation be submitted; receiving, from a plurality of users, a plurality of innovations; reviewing the plurality of innovations; selecting an innovation from among the plurality of innovations; communicating, to the entity, the selected innovation; and selling a commercial product that incorporates the innovation as defined by the agreement.

Another aspect of the present invention relates to a server comprising a database, the database including data representative of a plurality of submissions, wherein each submission includes an innovative idea; each submission was submitted via a website in response to a request for an innovative idea; and each submission was submitted together with information relating to intellectual property rights corresponding to the innovation.

Another aspect of the present invention relates to a server comprising a database, the database including data representative of a plurality of submissions, wherein each submission includes an innovative idea; each submission was submitted via a website in response to a request for an innovative idea; and the request for an innovative idea was displayed on the website at the direction of a controlling entity, the controlling entity having entered into a contract with a sponsor to provide the sponsor with an innovative idea, the request for an innovative idea having been designed to elicit the submission of an innovative idea for the sponsor.

Another aspect of the present invention relates to a web server comprising data representative of a website, the website being configured to display a request for an innovative idea; allow users of the website to submit innovative ideas in response to the request for an innovative idea to the website in the form of submissions; automatically filter out submissions that do not meet predefined criteria; allow an administrative user of the website to pass or fail each of the plurality of submissions at a plurality of stages; and display an indication to each user who submitted an innovative idea as to whether their respective idea has passed or failed at each of the plurality of stages.

In a feature of this aspect of the invention, the web server is configured to allow an administrative user to predefine a filter used to automatically filter out submissions.

In addition to the aforementioned aspects and features of the present invention, it should be noted that the present invention further encompasses the various possible combinations and subcombinations of such aspects and features.

### BRIEF DESCRIPTION OF THE DRAWINGS

One or more preferred embodiments of the present invention now will be described in detail with reference to the accompanying drawings, wherein the same elements are referred to with the same reference numerals, and wherein:

FIG. 1 illustrates steps 110,112,114,116 of a method 100 in accordance with an embodiment of the invention;

FIG. 2 illustrates steps 210,212,214,216,218,220,224 of a method 200 in accordance with an embodiment of the invention;

FIGS. 3A-3C illustrate a contractual agreement in accordance with a preferred embodiment of the invention;

FIGS. 4-5 illustrate a questionnaire in accordance with a preferred embodiment of the invention;

FIGS. 6-27 illustrate another contractual agreement in accordance with a preferred embodiment of the invention;

FIGS. 28-30 illustrate another contractual agreement in accordance with a preferred embodiment of the invention;

FIGS. 31-33 illustrate another contractual agreement in accordance with a preferred embodiment of the invention;

FIGS. 34-37 illustrate another contractual agreement in accordance with a preferred embodiment of the invention;

FIG. 38 illustrates a home page of a website in accordance with a preferred embodiment of the invention;

FIGS. 39-41 illustrate a FAQ page of a website in accordance with a preferred embodiment of the invention;

FIG. 42 illustrates a Release by a first party of any rights or interest, in accordance with a preferred embodiment of the invention;

FIGS. 43A and 43B illustrate a search administration page of an exemplary website in accordance with an embodiment of one or more aspects of the present invention;

FIG. 44 illustrates a sponsors page of the website of FIG. 43A;

FIGS. 45A-C illustrate a basic details setup page of the website of FIG. 43A;

FIGS. 46A-I illustrate a product questions setup page of the website of FIG. 43A;

FIGS. 47A-B illustrate a patent questions setup page of the website of FIG. 43A;

FIG. 48 is a screenshot of a dashboard page of the website of FIG. 43A;

FIGS. 49A-B are screenshots of a submission opening page of the website of FIG. 43A;

FIG. 50 is a screenshot of a submission details page of the website of FIG. 43A;

FIG. 51 is a screenshot of an upload page of the website of FIG. 43A;

FIG. 52 is a screenshot of an IP page of the website of FIG. 43A;

FIGS. 53A-B are screenshots of a submission final page of the website of FIG. 43A;

FIG. 54 is a screenshot of a search results page of the website of FIG. 43A;

FIG. 55 is a screenshot of a stage summary page of the website of FIG. 43A;

FIGS. 56A-B are screenshots of a submission summary page of the website of FIG. 43A;

FIGS. 57A-C are screenshots of a query page of the website of FIG. 43A; and

FIGS. 58A-B are screenshots demonstrating needs and skill functionality of the website of FIG. 43A.

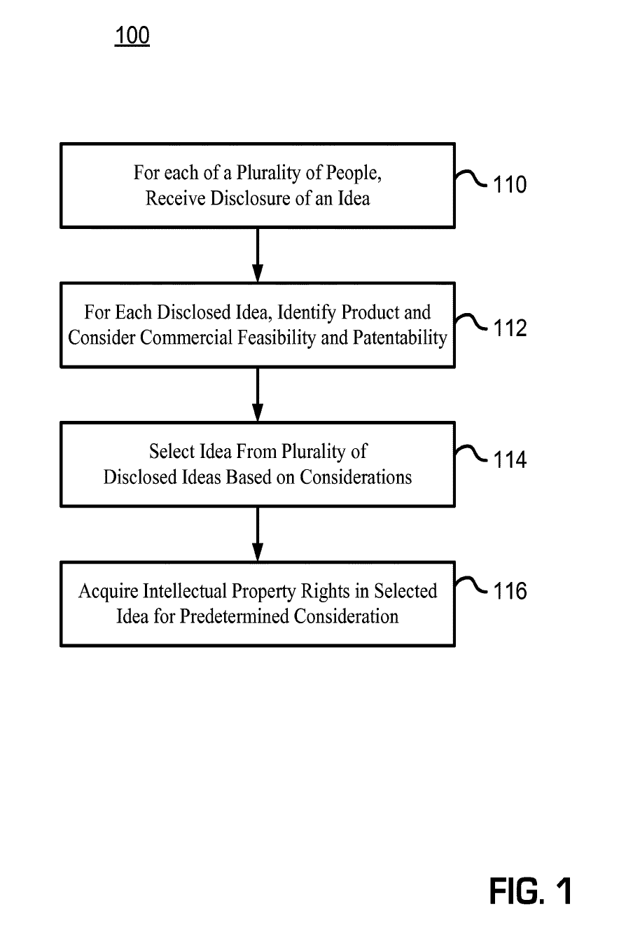

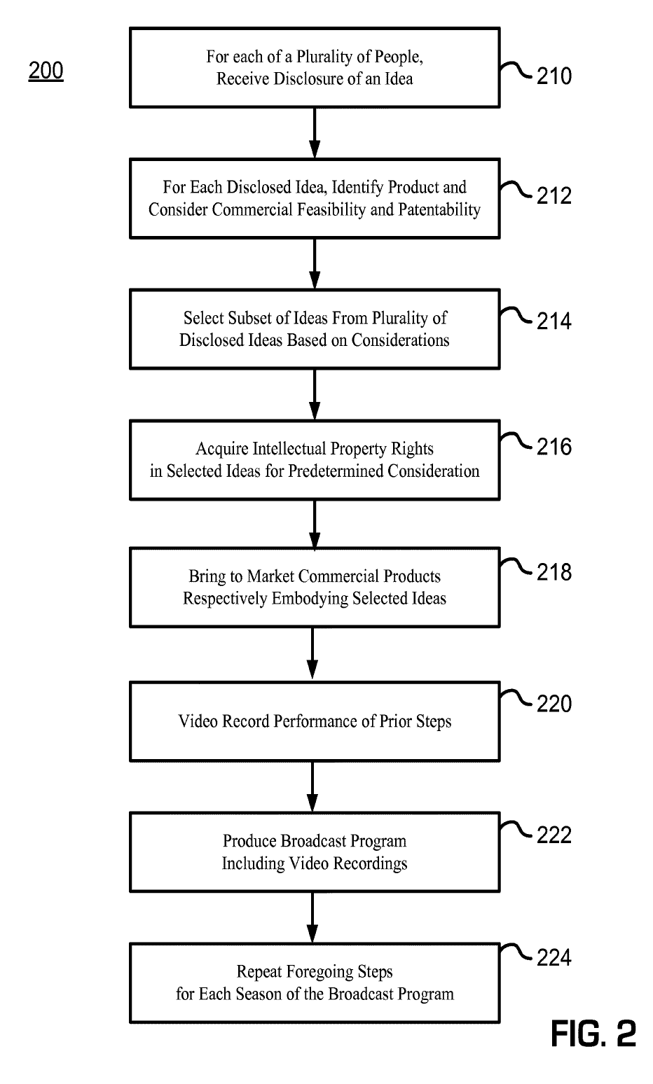

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

### Video Program Implementation

A preferred embodiment of a business method of the present invention is now described wherein a first party—for example, Bouncing Brain Productions, LLC (“BBP”)—searches for novel and unobvious ideas from ordinary people which ideas are identified by the BBP as being extraordinary. The extraordinary ideas preferably are for new commercial products, especially for retail consumer markets. BBP—and its subsidiaries and/or affiliated entities, as explained in further detail below—attempt to bring to market the new commercial products embodying the extraordinary ideas. The extraordinary ideas selected by BBP thus are those that are believed to have the best commercial feasibility based on considerations such as market size and demand, simplicity in the design or engineering of the product, and patentability.

In conjunction with this search for and commercialization of extraordinary ideas of ordinary people, the entire process is video recorded and a video program is produced. The video program (hereinafter “Show”) may be shown via network television, via cable, or over a network such as, for example, the internet, and is intended to educate viewers on the process of finding and commercializing extraordinary ideas. Moreover, the Show is not intended to be a competition.

In searching for the extraordinary ideas of ordinary people, BBP publicizes auditions (also called “casting calls”) that are held in various cities. Ordinary people are invited to attend a casting call and disclose their ideas to BBP for consideration and possible selection for commercialization in conjunction with the Show. In particular, an idea typically is embodied in an apparatus or method (hereinafter referred to as the “Invention”), and people are invited to bring in and share their Inventions with BBP. Each casting call preferably lasts only a day (preferably, the casting call is held on a Saturday), and each casting call is held at a television studio.

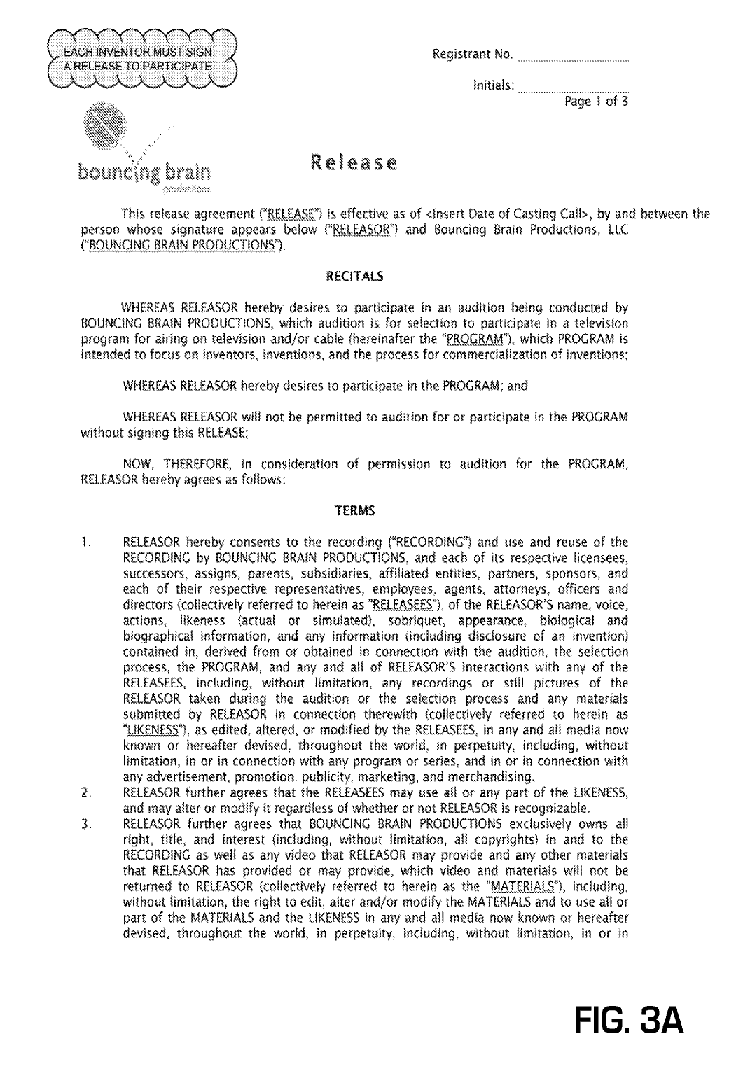

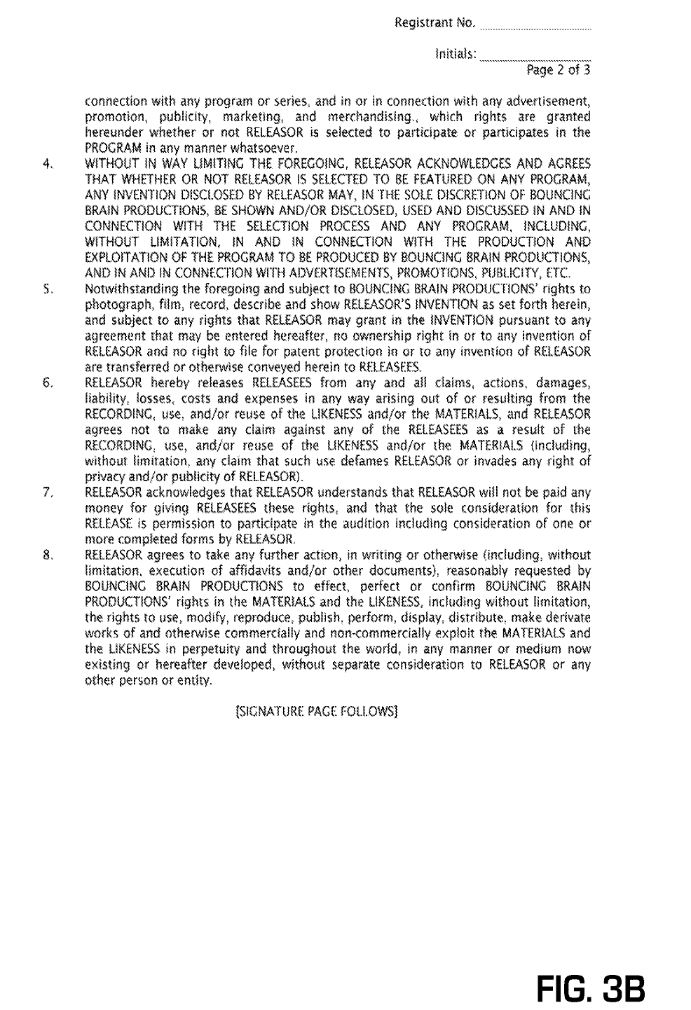

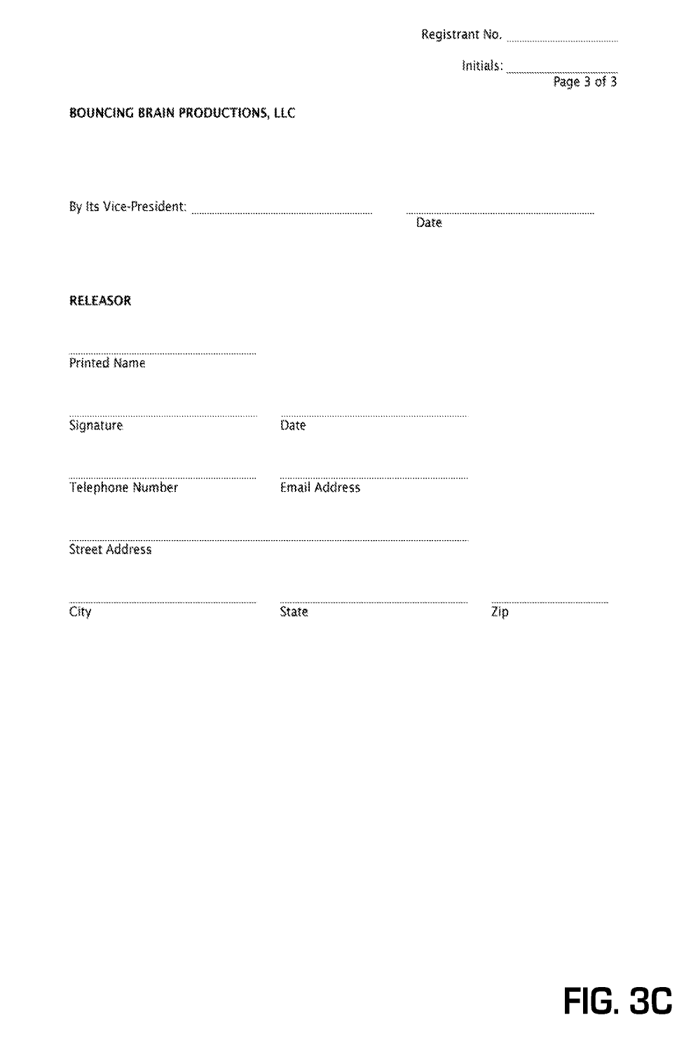

Because of the video recording, each person desiring to disclose his or her Invention for consideration and possible selection first must sign a contractual agreement for use of the video recording of that person at the casting call (the “Release”), even if that person's Invention is not selected for commercialization. An exemplary Release in accordance with a preferred embodiment of the invention is set forth in FIGS. 3A-3C.

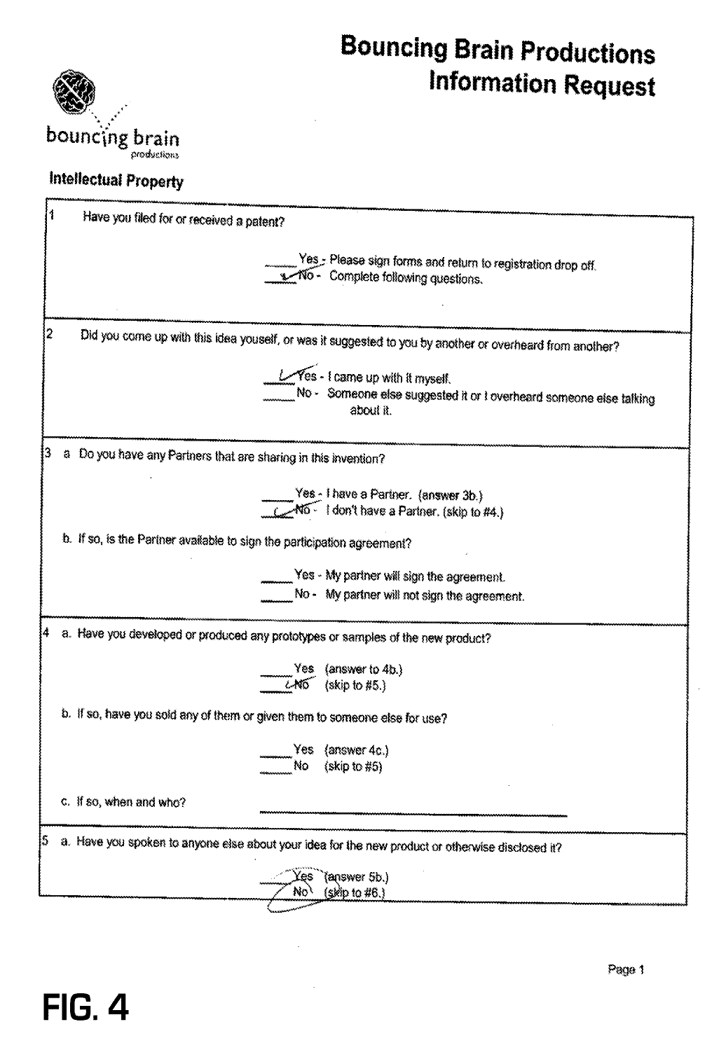

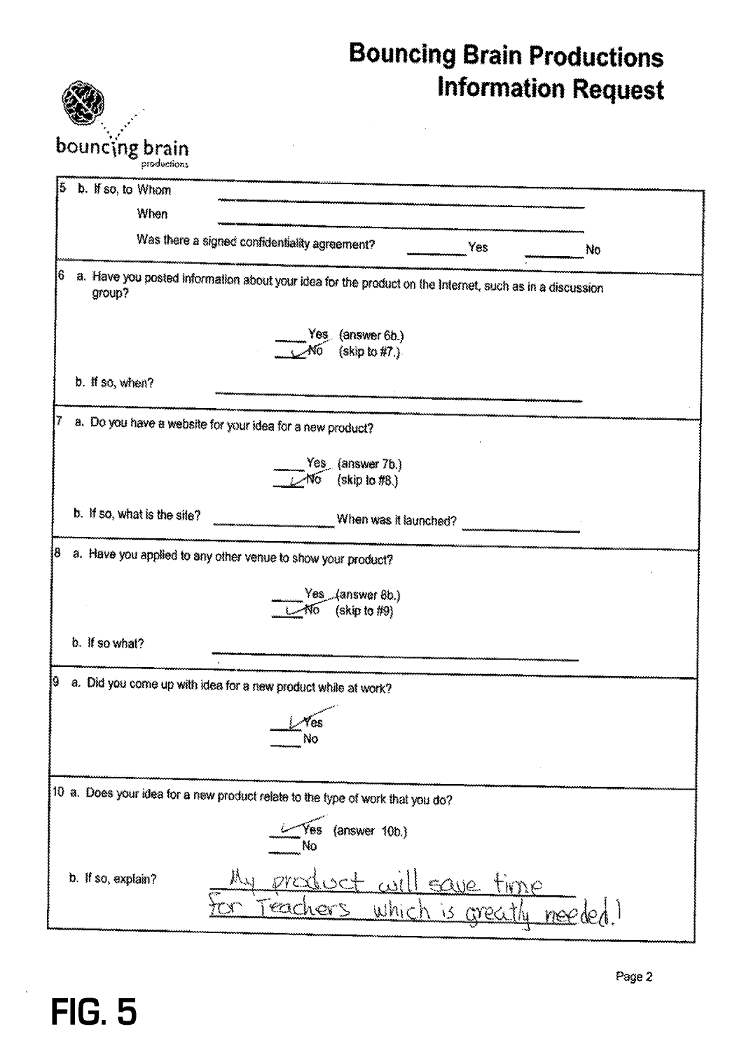

Following execution of the Release, contact information is collected from the person and a registration number is assigned as a unique identifier of that person's Invention. In addition to collecting the contact information and assigning a registration number, a short questionnaire is provided for completion by the person. The questionnaire relates specifically to that person's Invention but does not necessarily collect any information about the details of the Invention itself. Instead, the questionnaire is designed to automatically exclude consideration of an Invention based on prior acts and not based on the actual merits of the Invention. In this respect, consideration is not given to Inventions that were in public use or were subject of a printed publication more than nine months prior to the casting call, even though novelty is not lost until twelve months after such first use or publication, because less than three months is considered an inadequate amount of time in which to fully consider and fully act on the Invention before possible patent protection is lost. An exemplary questionnaire that was completed during an actual casting call, and that is in accordance with a preferred embodiment of the invention, is set forth in FIGS. 4-5.

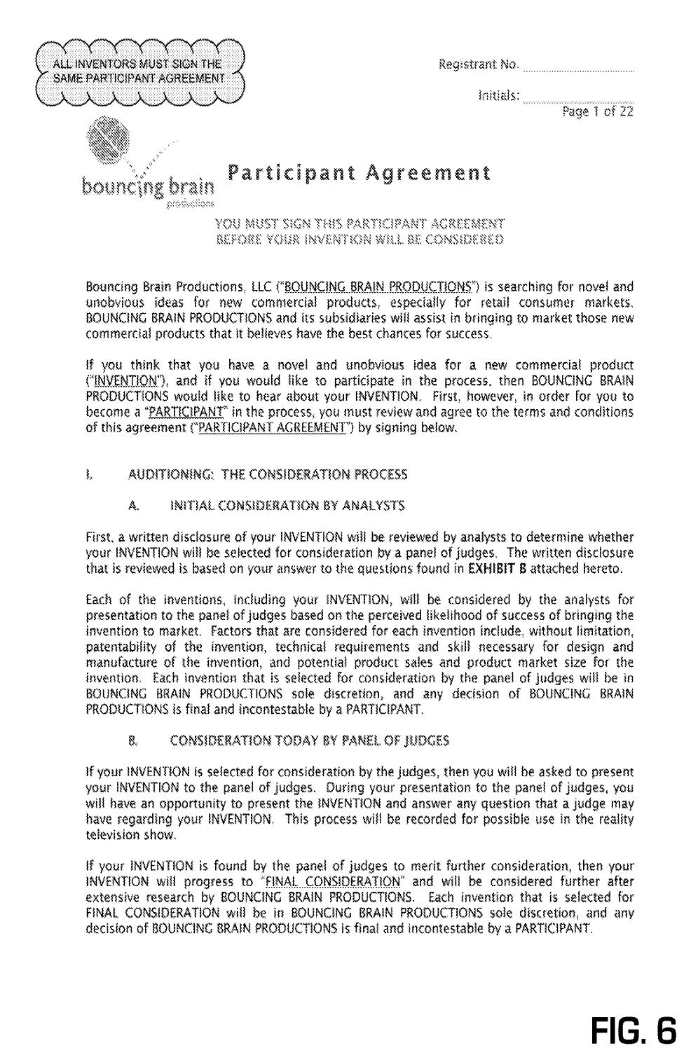

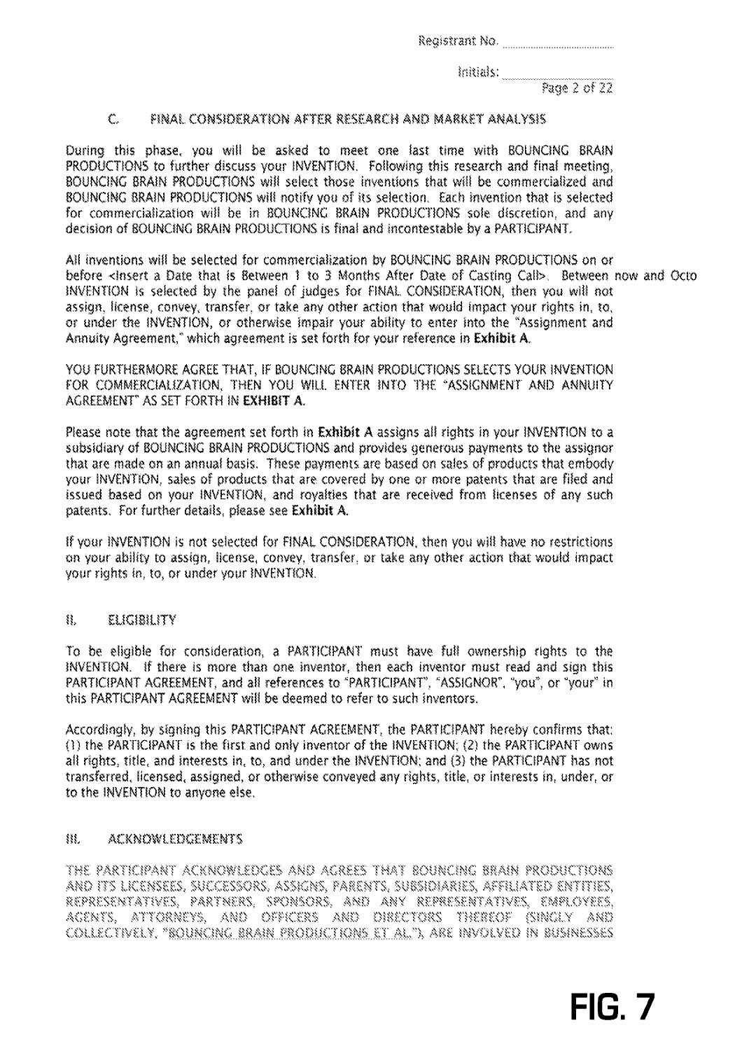

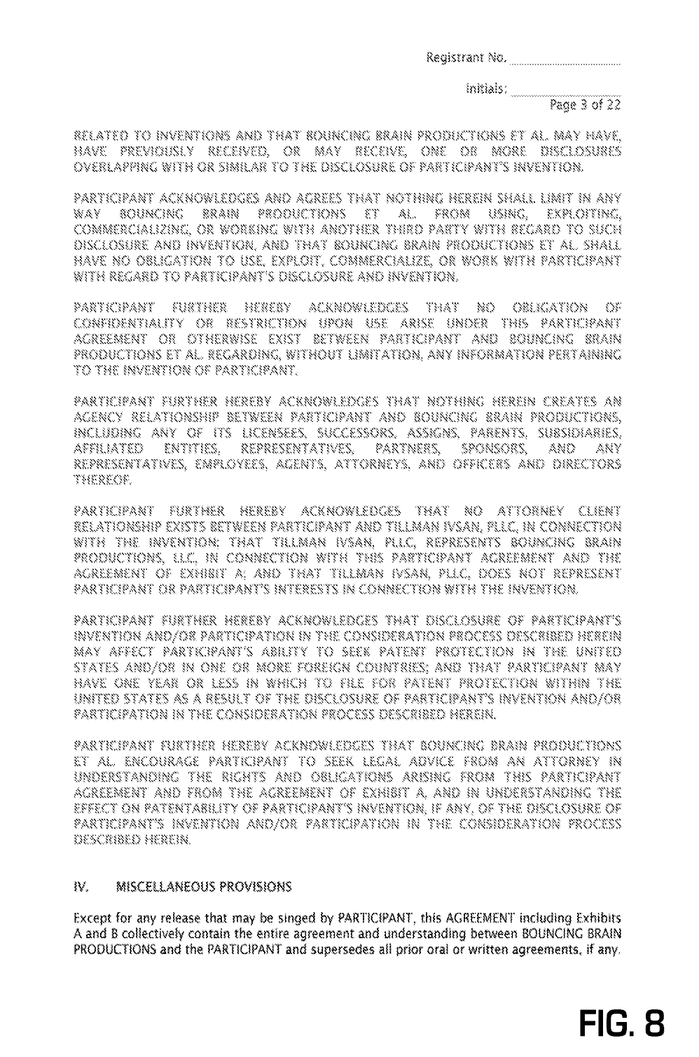

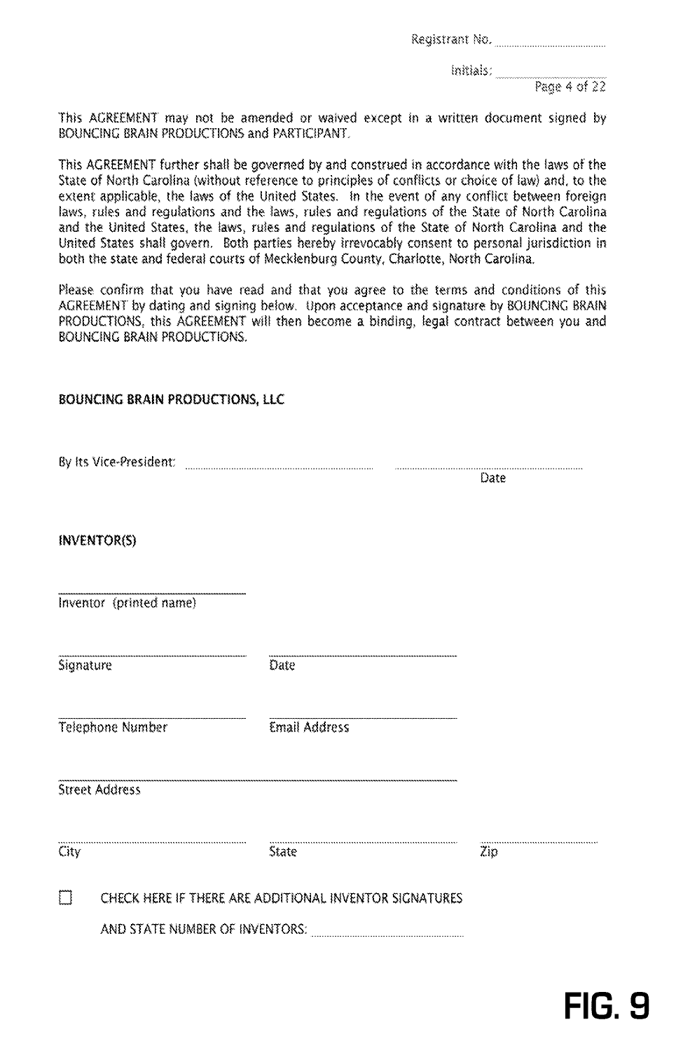

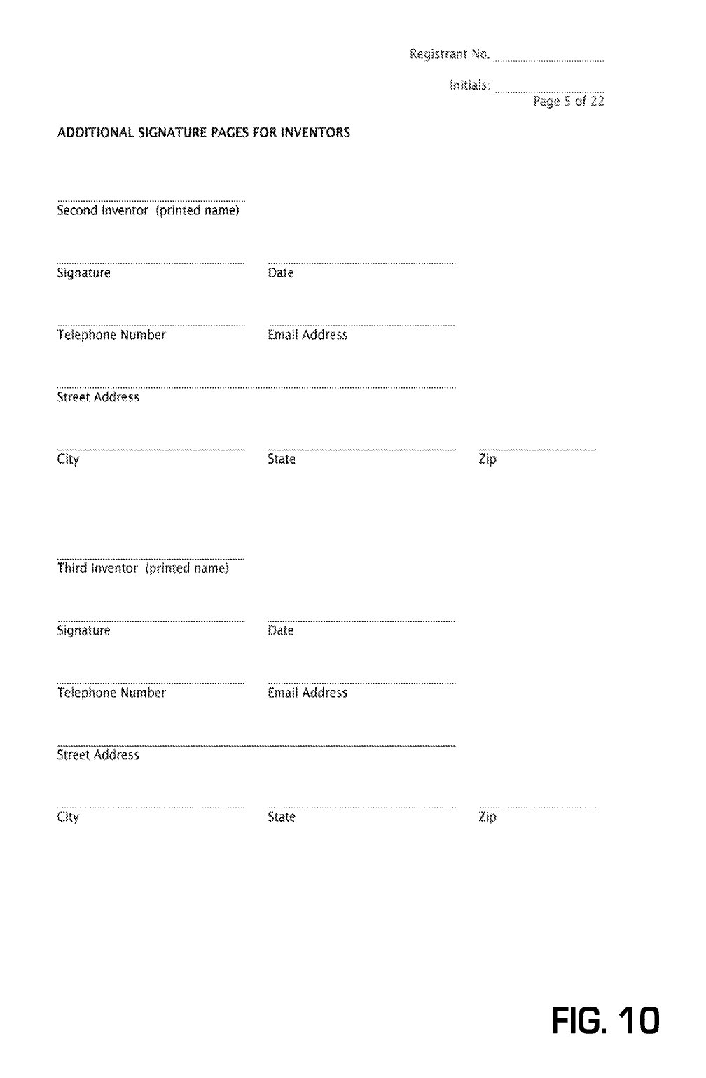

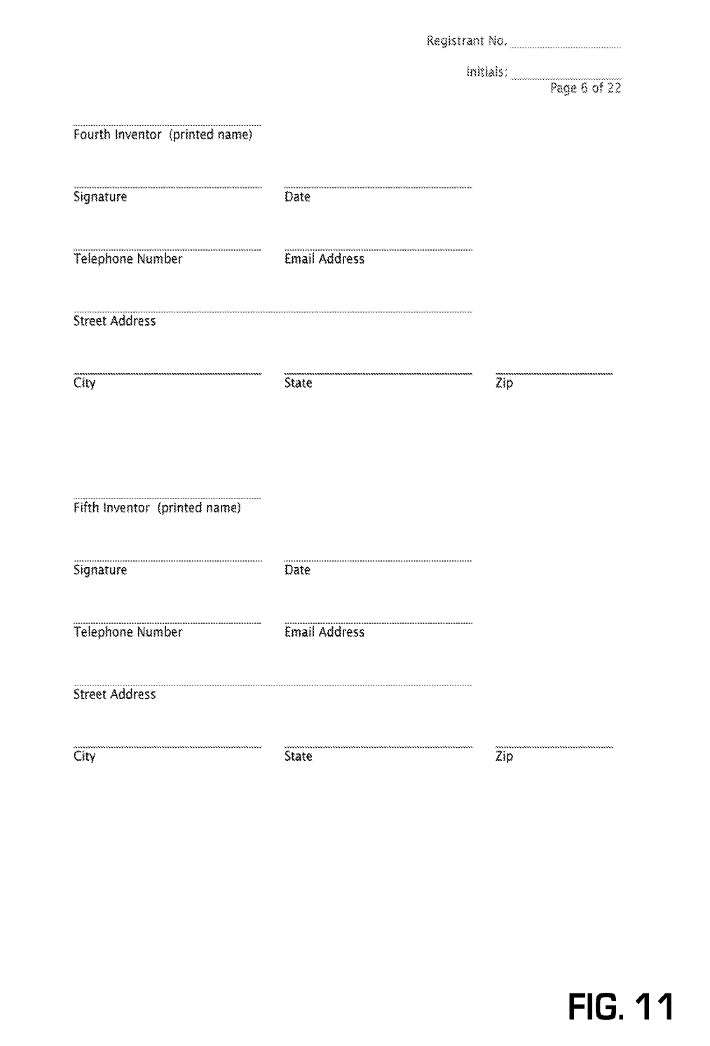

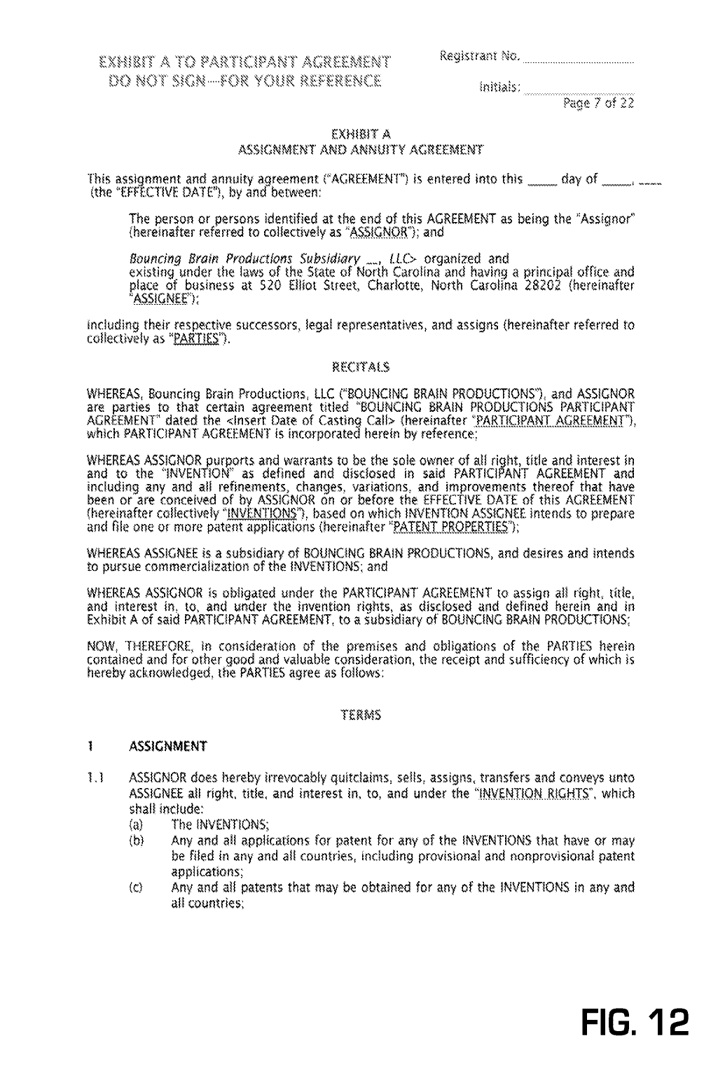

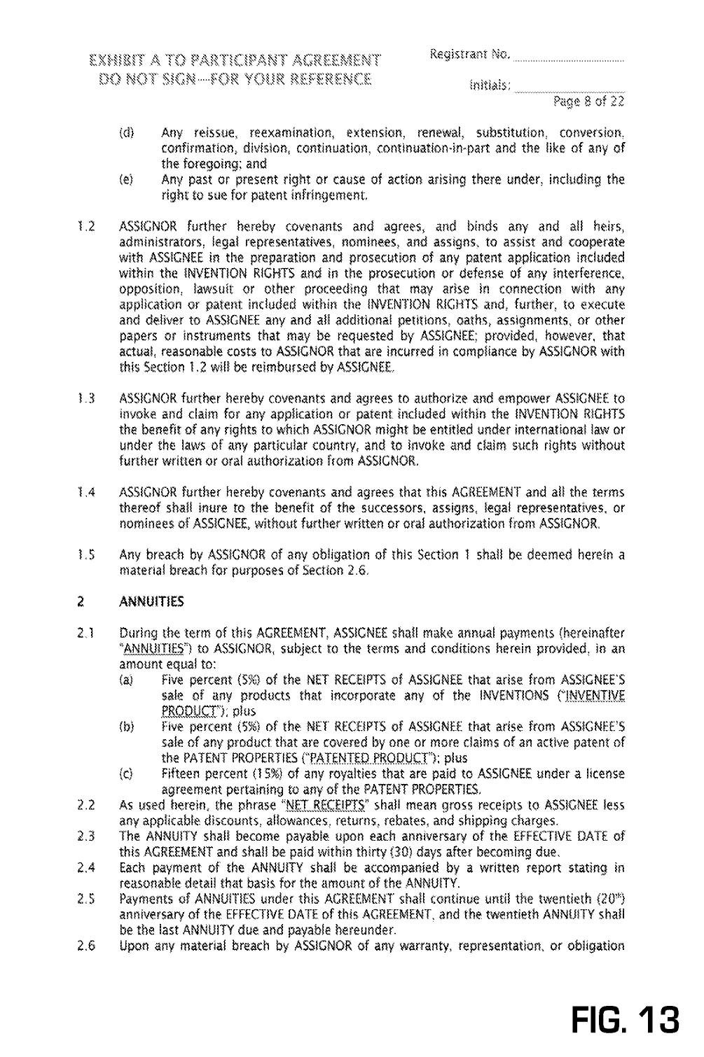

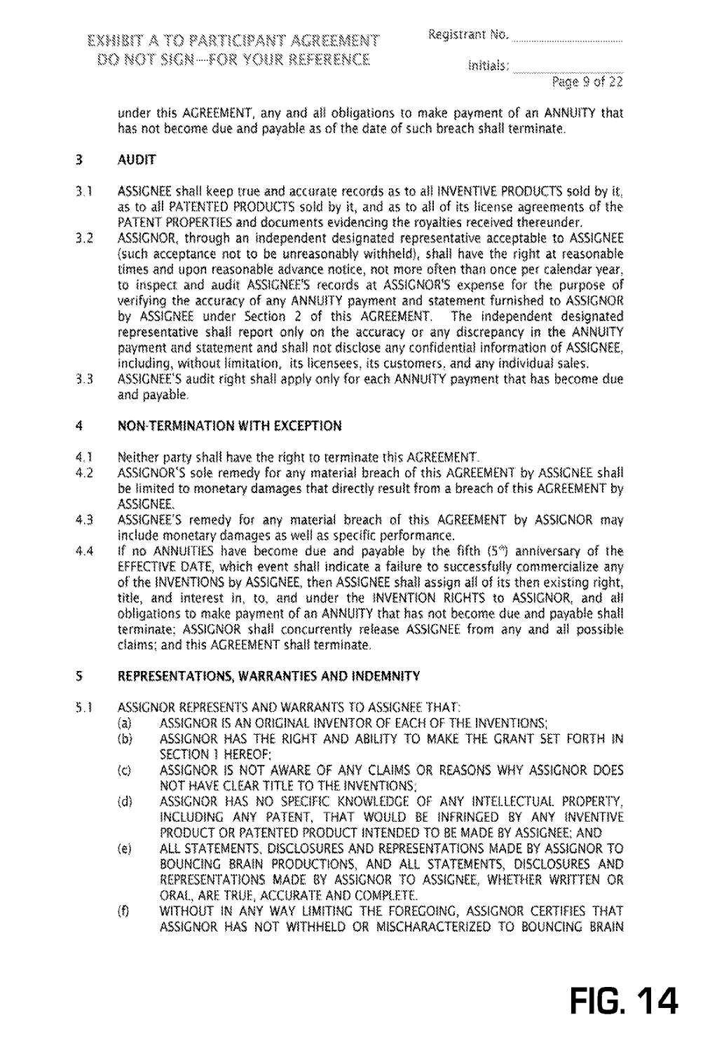

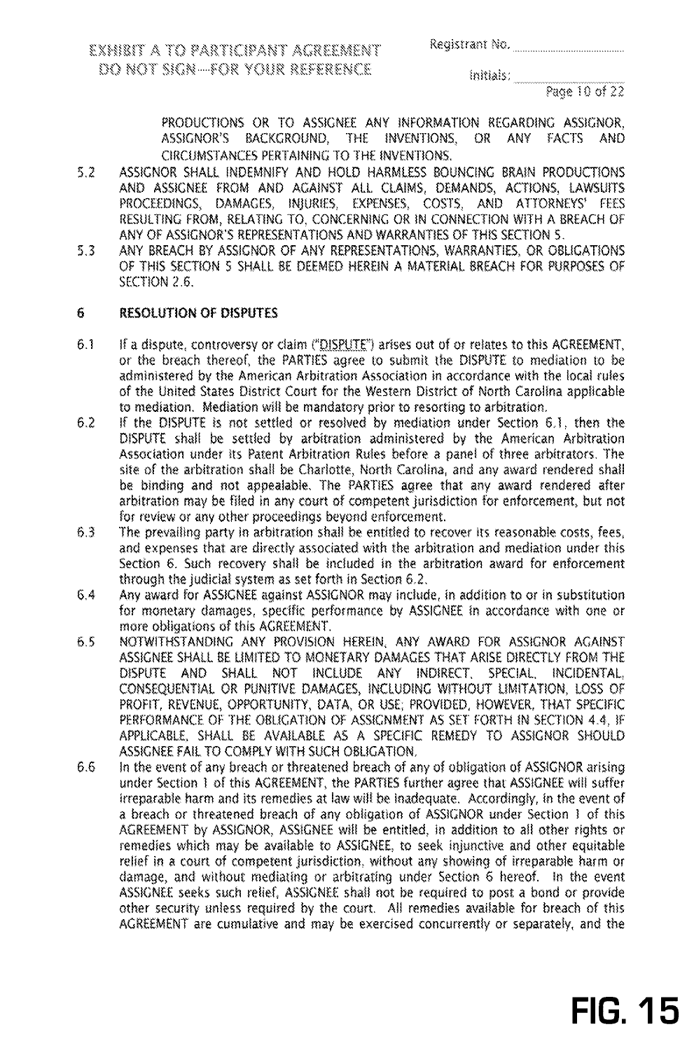

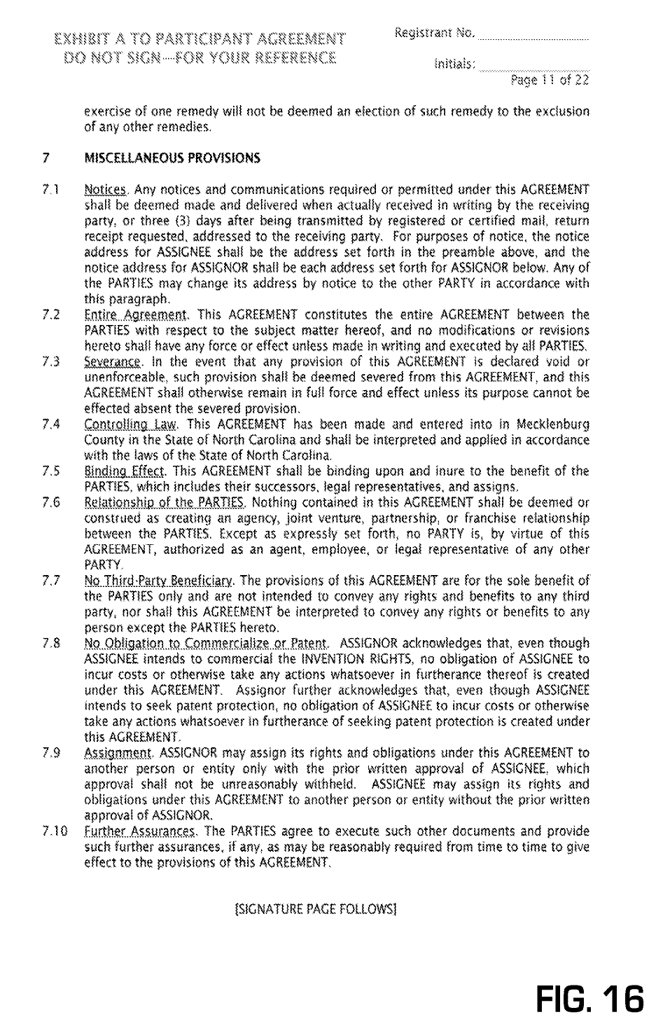

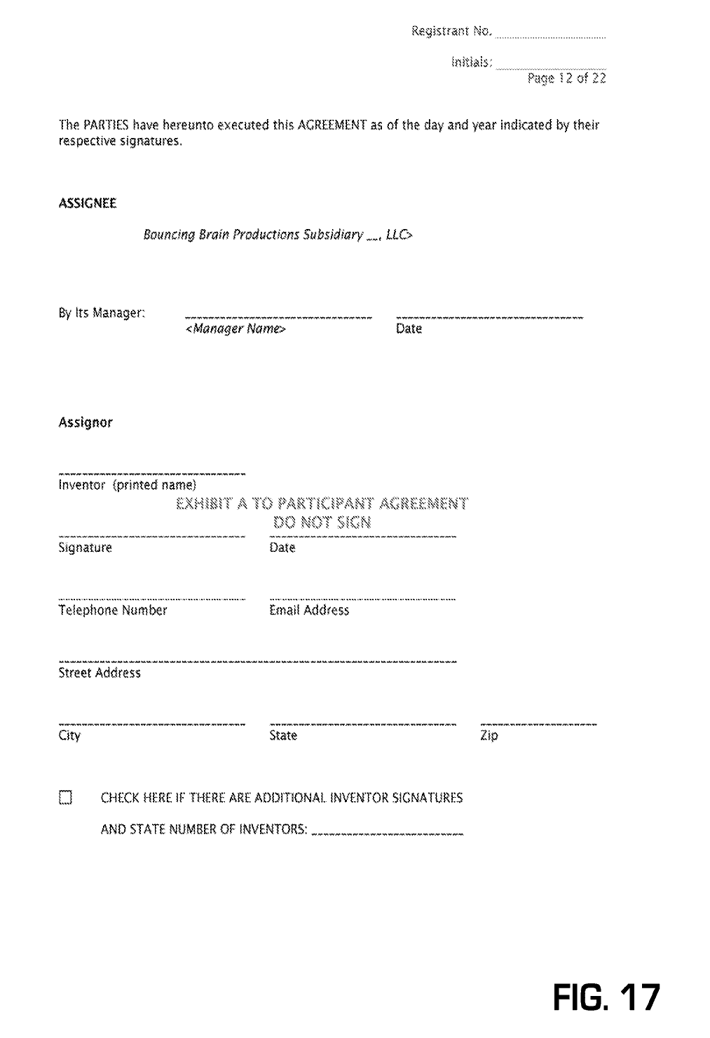

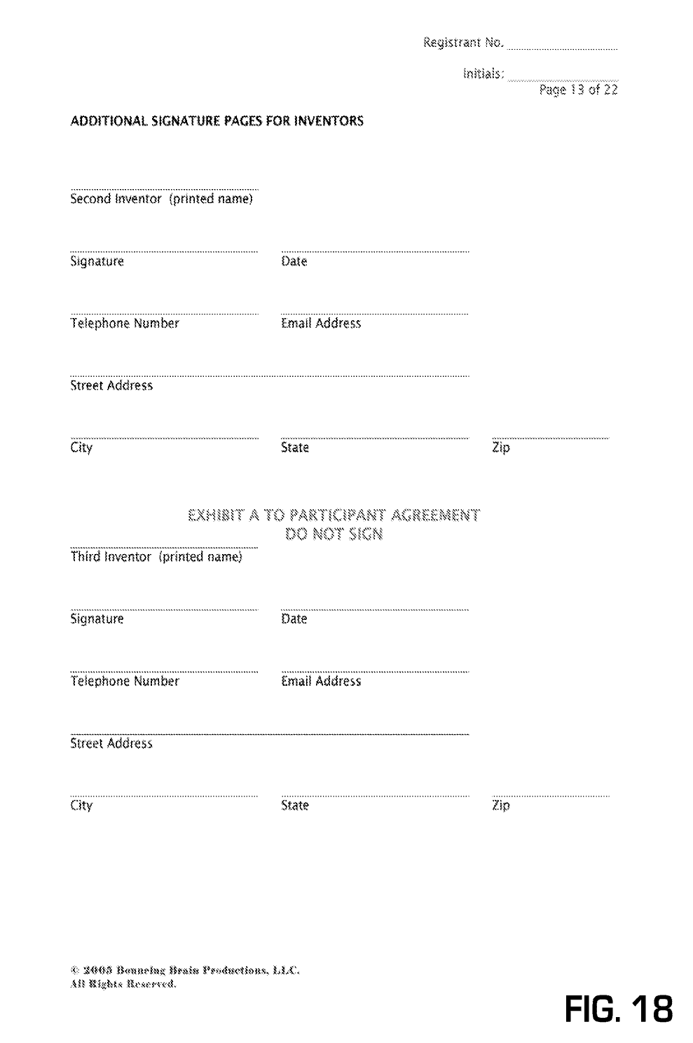

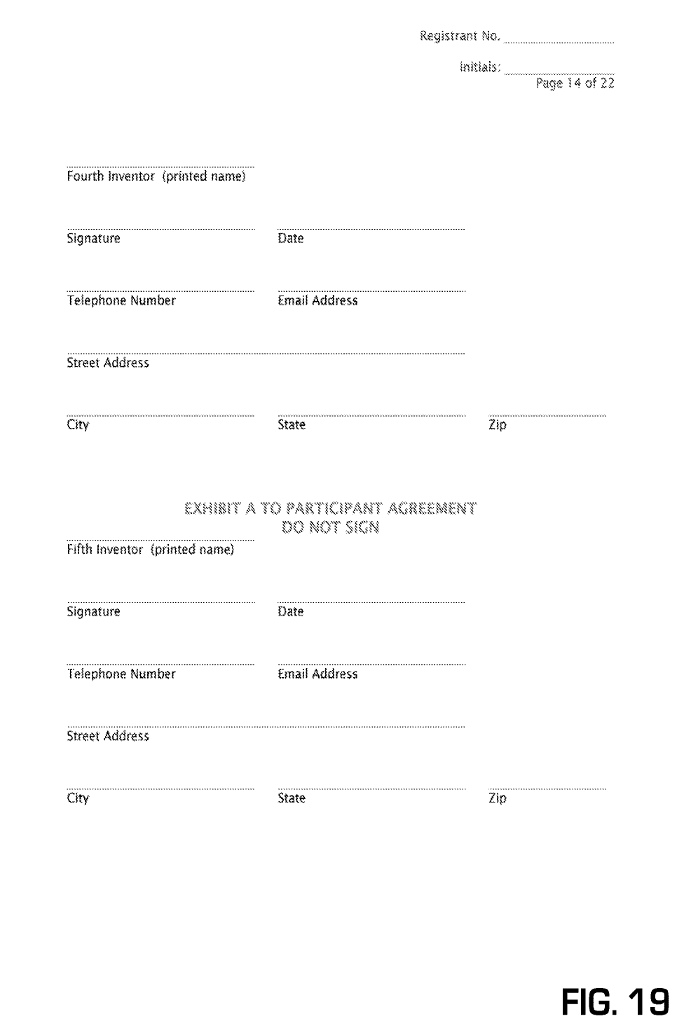

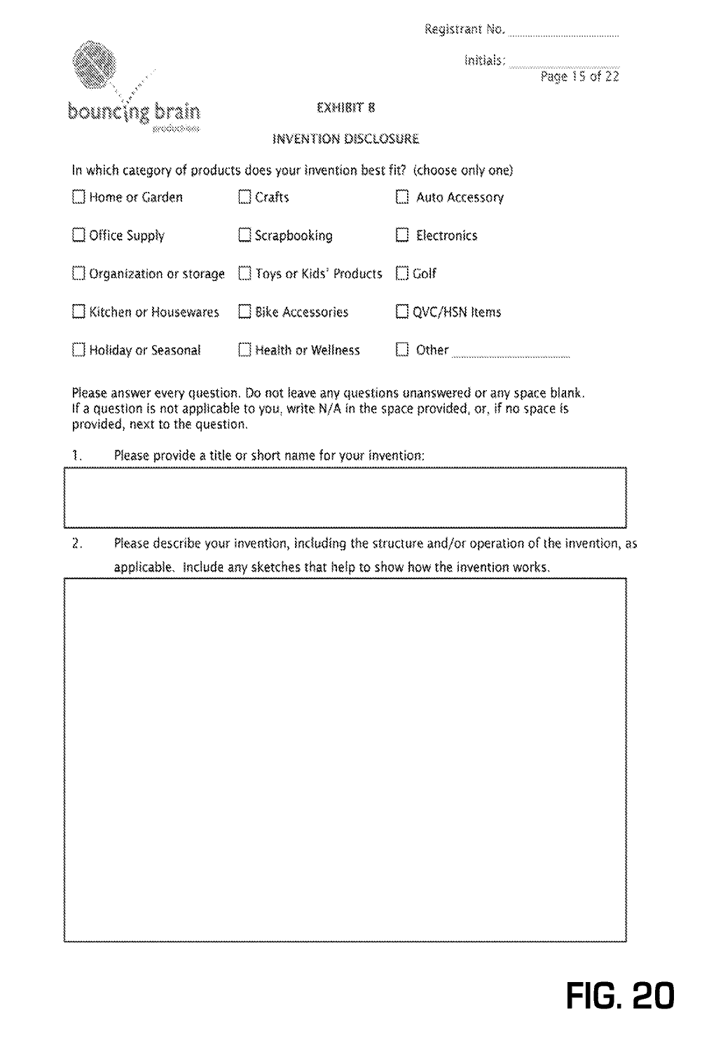

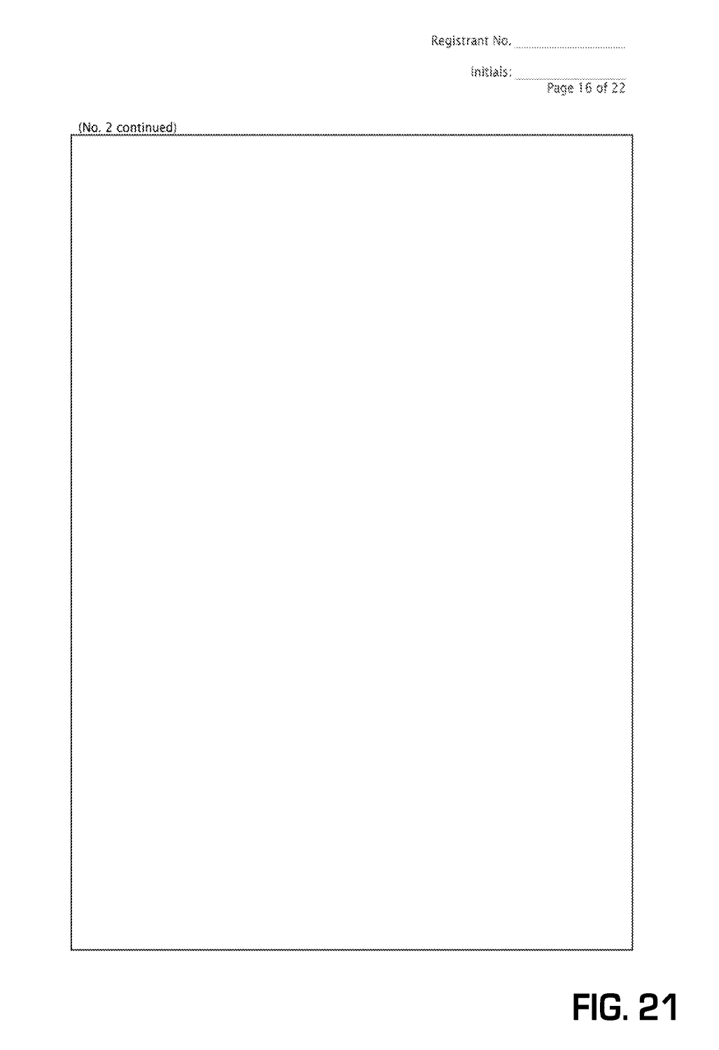

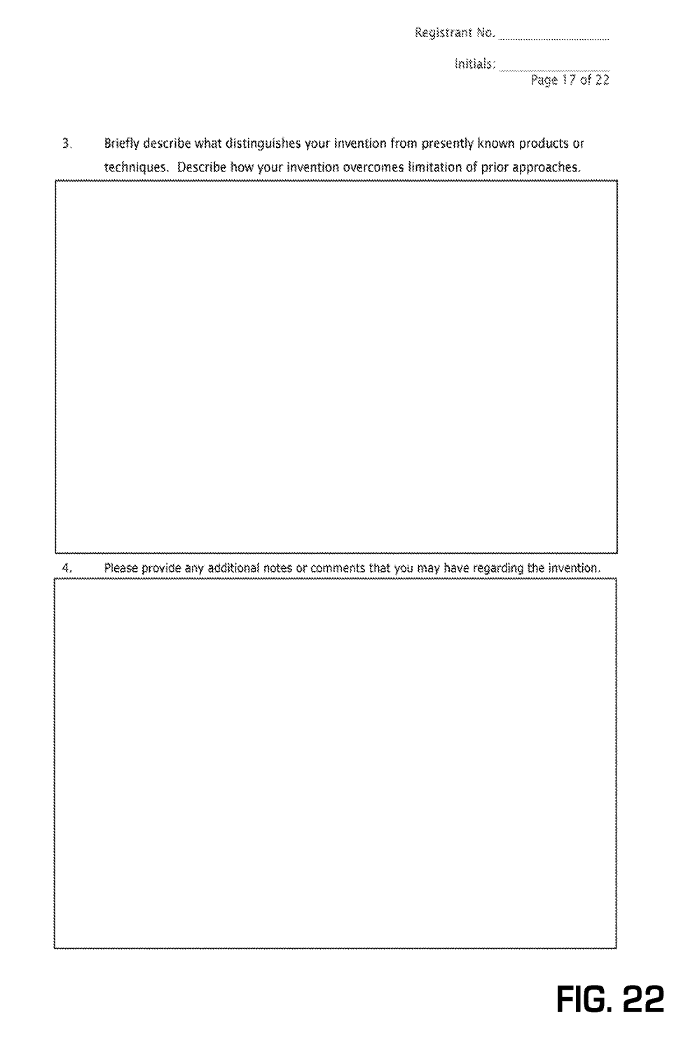

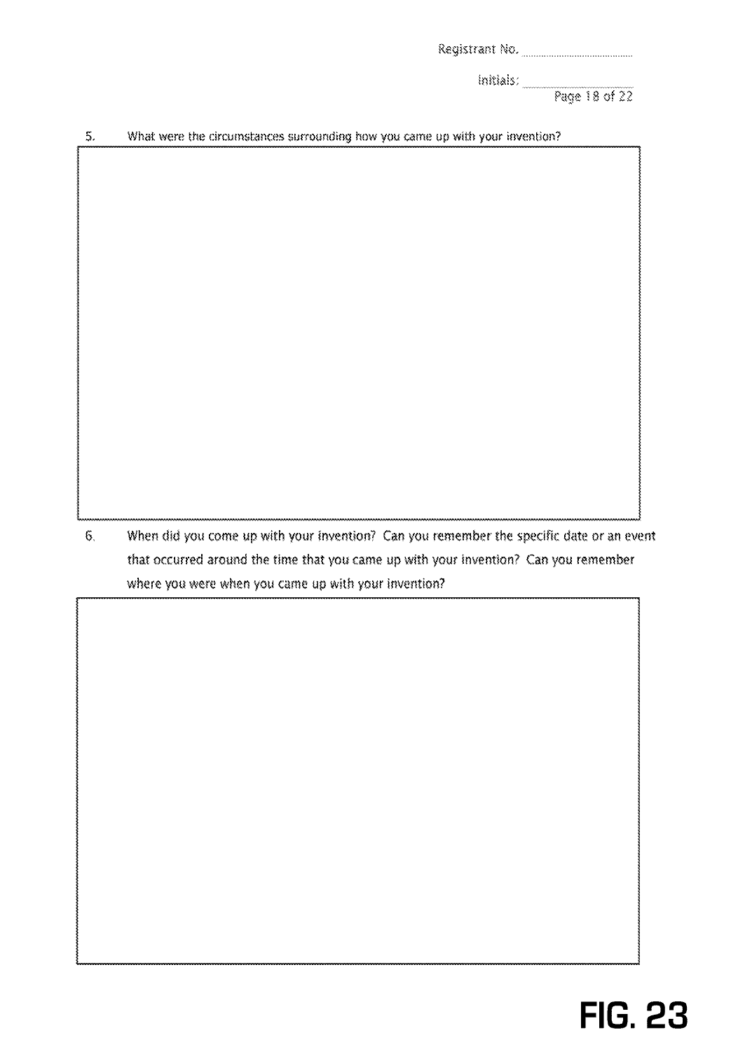

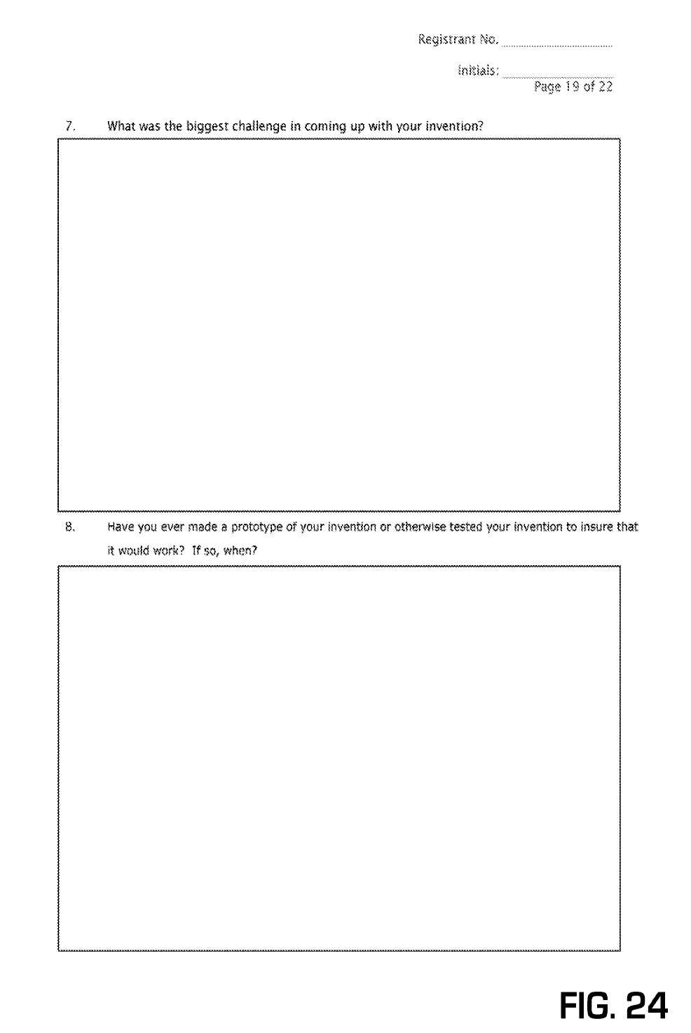

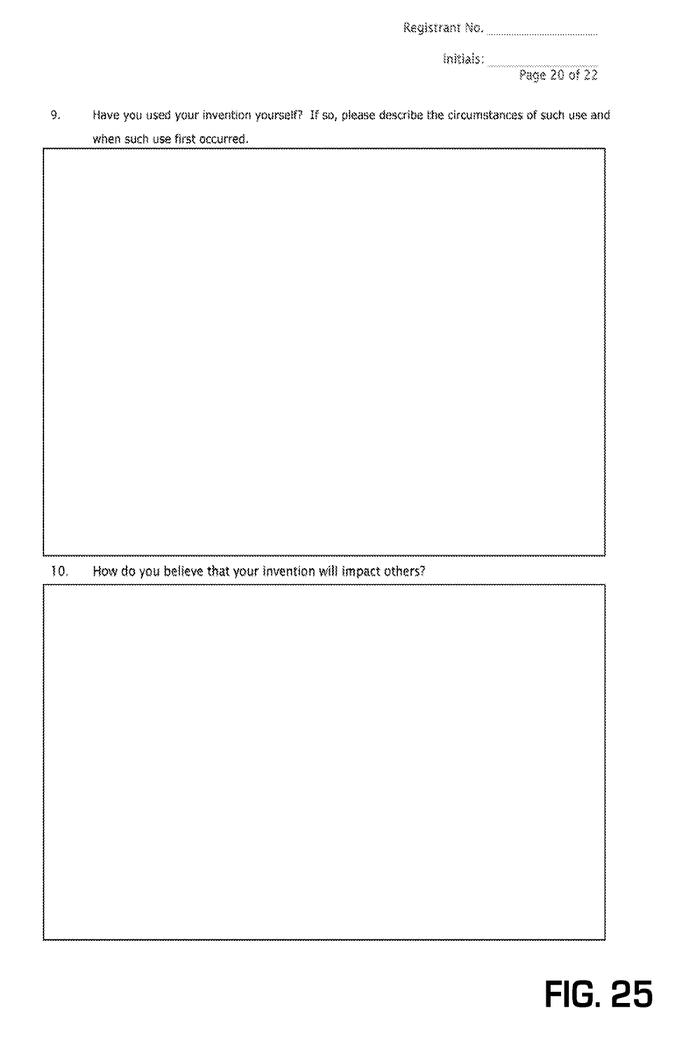

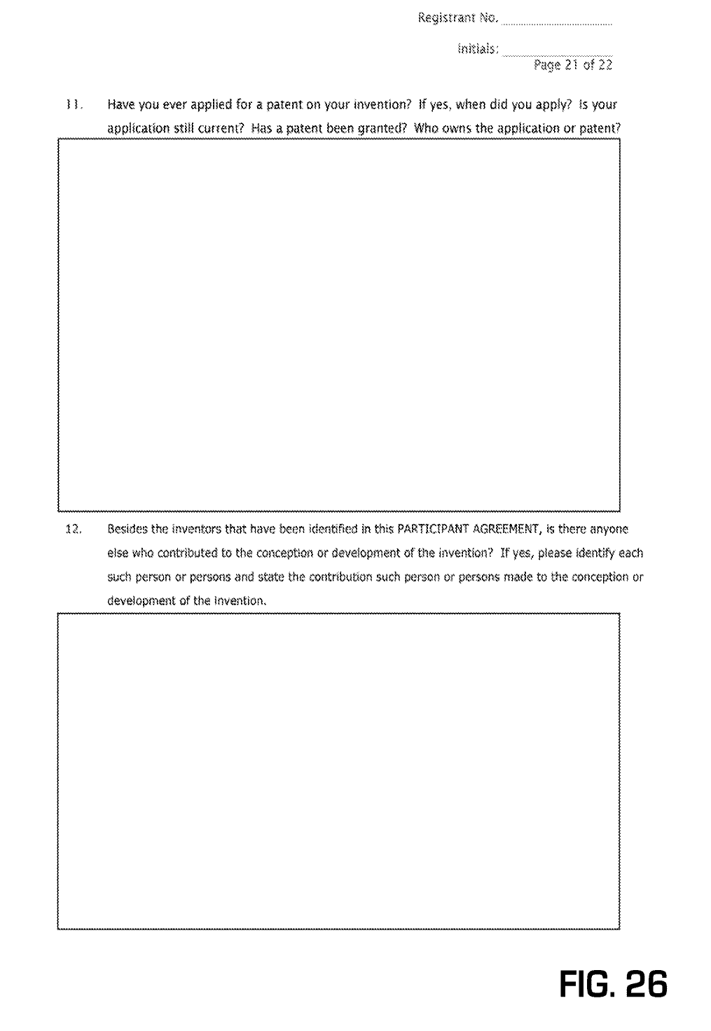

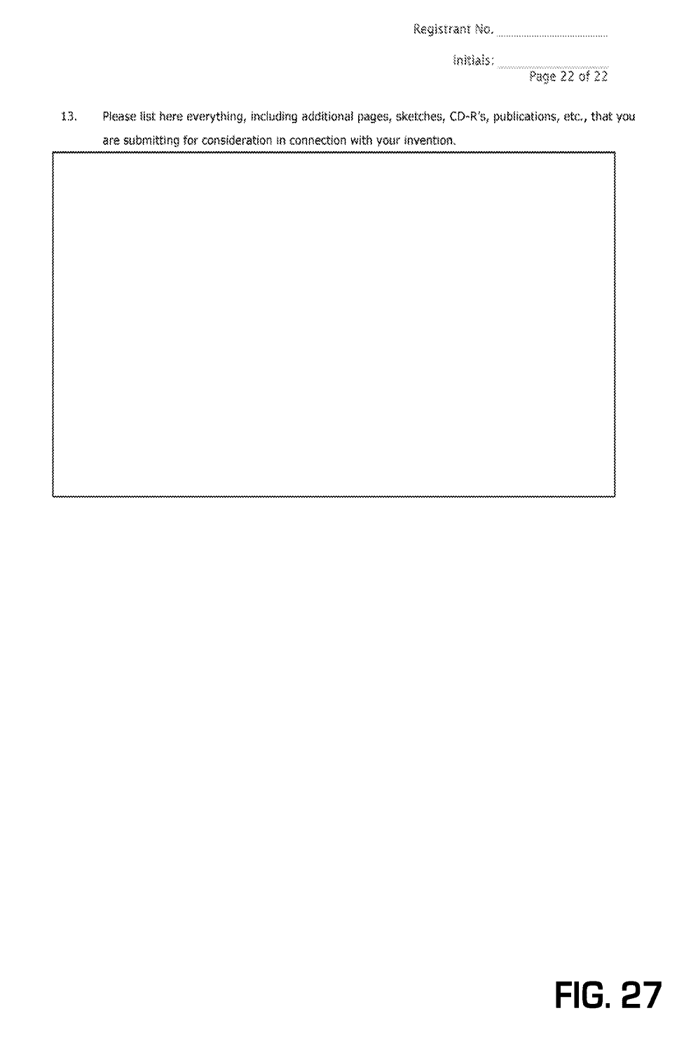

Provided that the Release has been executed and the questionnaire completed and approved in the initial screening process, the person is required to execute a contractual agreement governing that person's participation with BBP in the consideration and selection process (the “Participant Agreement”). An exemplary Participant Agreement in accordance with a preferred embodiment of the invention is set forth in FIGS. 6-27. The person also is required to complete a written disclosure of his or her Invention by completing an “Invention Disclosure” form that is attached to the Participant Agreement as Exhibit B. Preferably, no consideration is given to an Invention if the Participant Agreement is not executed beforehand.

Upon receipt of the completed “Invention Disclosure” form, the merits of the Invention are considered by an initial panel of people. There preferably are a plurality of initial panels and each determines whether a respective Invention advances to a final panel of judges. The initial panel considers such factors as patentability of an invention, technical requirements and skill necessary for design and manufacture of an invention, and potential product sales and product market size for an invention, all of which factors are seen as contributing to the likelihood of success of bringing an invention to market.

Each person submitting an Invention preferably is provided the opportunity to present his or her Invention to one of the initial panels. Depending on the number of people attending a casting call and the number of initial panels operating, a person preferably is provided between two and ten minutes in which to make his or her presentation to the initial panel.

The final panel of judges at a particular casting call determines those Inventions that will be advanced for further consideration, referred to as “final consideration,” such final consideration being based on additional market research and patent research that is conducted after the casting call. Each person whose invention is selected by an initial panel to advance to the final panel preferably is afforded an opportunity to present that person's Invention to the final panel. Each person preferably is given between two and ten minutes to present to the final panel. The presentation preferably is interactive and is video recorded.

Final consideration is given after the casting call (which casting call preferably lasts only a single day), and final consideration is based on research on the Invention that is conducted by BBP. Such research preferably includes market research and patent research. Additionally, all of the Inventions selected for final consideration may be compared against one another, with only the most promising Inventions being selected for commercialization in conjunction with the Show. Each person whose invention is selected for final consideration is informed of a certain date by which a decision will be given as to whether that person's Invention is selected for commercialization in conjunction with the Show (the “Decision Date”).

Importantly, the person submitting the Invention agrees in the Participant Agreement that he or she will not, during the time between the casting call and the Decision Date, assign, license, convey, transfer, or take any other action that would impact rights in, to, or under the Invention, if the Invention is selected by the final panel of judges at the casting call for final consideration. The person further agrees in the Participant Agreement that he or she will enter into a contractual agreement providing for the assignment of all rights in the Invention in exchange for predetermined consideration (the “Assignment and Annuity Agreement”). The Assignment and Annuity Agreement is attached to the Participant Agreement as Exhibit A and also is published for review and consideration by the public at large prior to the casting call.

The Assignment and Annuity Agreement obligates the person to assign all rights in the Invention to a subsidiary of BBP and/or an affiliated entity, and provides generous payments to the person that are made on an annual basis as consideration for the assignment. The annuity payments are based on net sales of products that embody the Invention (preferably between 2-7% and, more preferably, 5%, of such net sales); net sales of products that are covered by one or more patents that are filed and issued based on the Invention (preferably between 2-7% and, more preferably, 5% of such net sales), and royalties that are received from licenses of any such patents (preferably between 10-20% and, more preferably 15% of such royalties).

If a person's Invention is not selected for final consideration, then there are no restrictions on the ability of the person submitting the invention to assign, license, convey, transfer, or take any other action that would impact rights in, to, or under the Invention. Similarly, if a person's Invention is not selected during final consideration for commercialization in conjunction with the Show, then there are no restrictions on that person's ability to assign, license, convey, transfer, or take any other action that would impact rights in, to, or under the Invention after the Decision Date.

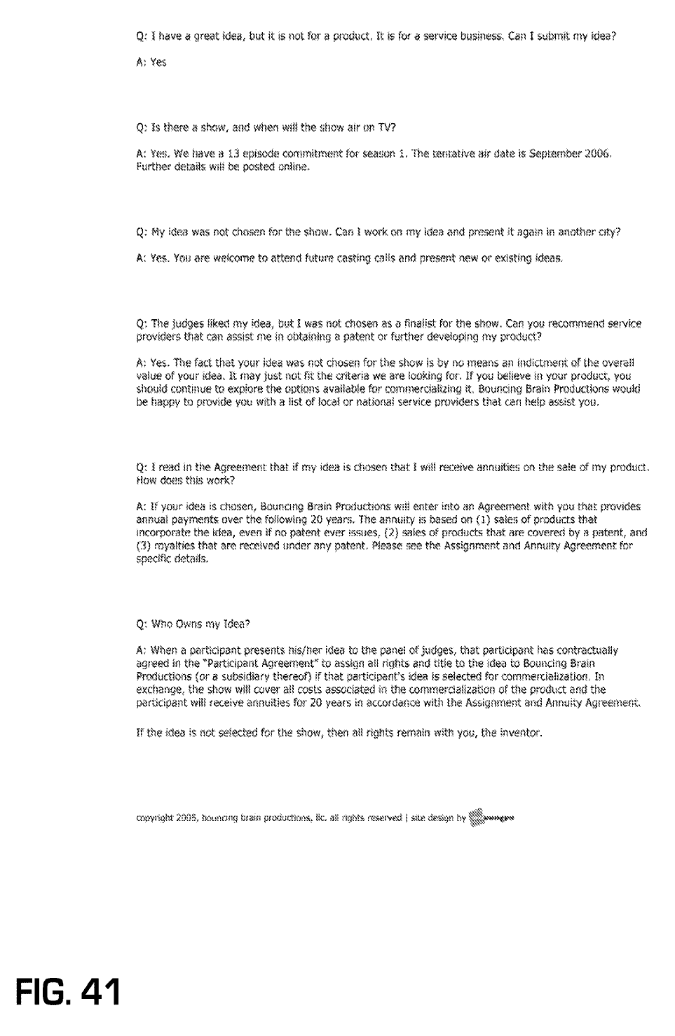

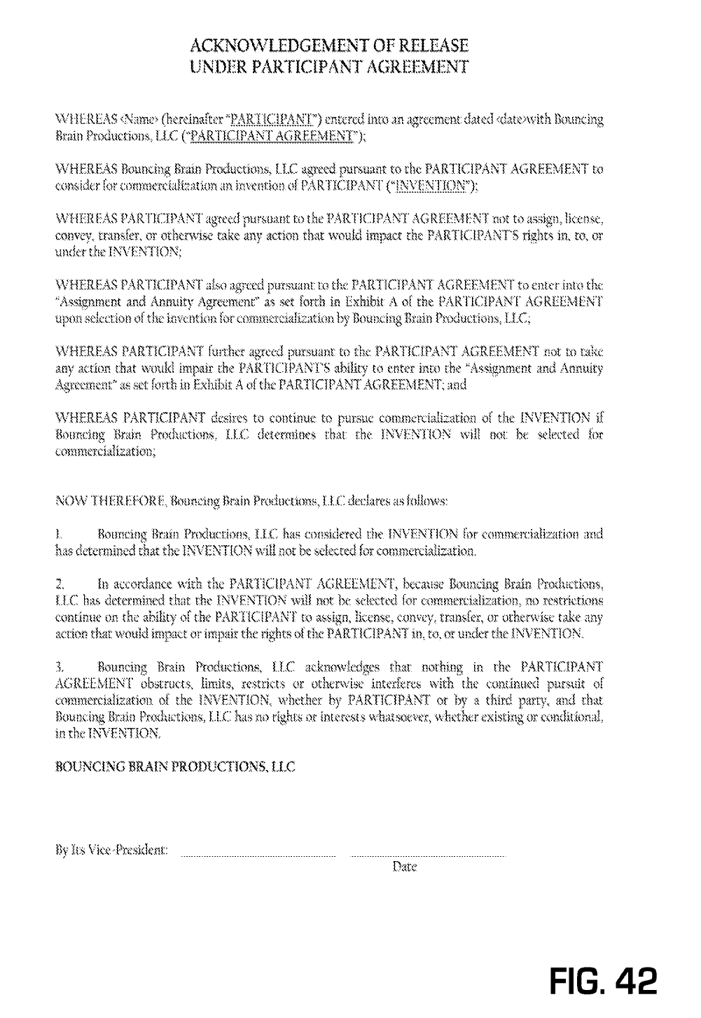

Optionally, during final consideration BBP may no longer desire to continue to consider an Invention further during final consideration and a person who has submitted an Invention that is under final consideration may desire to seek other opportunities. In such case, an acknowledgement that the Invention will not be selected for commercialization by BBP may be desired by the person in order to fully pursue the other opportunities. In such instance, a release as represented in FIG. 41 may be utilized in accordance with preferred embodiments of the invention.

To be eligible for consideration, a person must have full ownership rights to the Invention. A person also should be eighteen or older or, if less than eighteen, then a parent or guardian's signature also must be obtained on the contractual agreements that are signed. Also, if there is more than one inventor, then each inventor must read and sign the Participant Agreement.

A person signing the Participant Agreement also makes several explicit acknowledgments. Those acknowledgements include:
That BBP and its licensees, successors, assigns, parents, subsidiaries, affiliated entities, representatives, partners, sponsors, and any representatives, employees, agents, attorneys, and officers and directors thereof (singly and collectively, “BBP et al.”), are involved in businesses related to inventions and that BBP et al. may receive or may have previously received one or more disclosures overlapping with or similar to the disclosure of that person's Invention;
That nothing in the Participant Agreement shall limit BBP et al. in any way from using, exploiting, commercializing, or working with another third party with regard to such Invention, and that BBP et al. shall have no obligation to use, exploit, commercialize, or work with that person with regard to that person's Invention;
That no obligation of confidentiality or restriction upon use arises under the Participant Agreement or otherwise exists between that person and BBP et al. regarding, without limitation, any information pertaining to that person's Invention;
That nothing in the Participant Agreement creates an agency relationship between that person and BBP, including any of its licensees, successors, assigns, parents, subsidiaries, affiliated entities, representatives, partners, sponsors, and any representatives, employees, agents, attorneys, and officers and directors thereof.
That no attorney-client relationship exists between that person and any law firm participating with and representing BBP in connection with the casting call, with commercialization of inventions, and with the Show;
That the disclosure of that person's invention and/or participation in the casting call may affect that person's ability to seek patent protection in the United States and/or in one or more foreign countries, and that the person may have one year or less in which to file for patent protection within the United States as a result of the disclosure of that person's Invention and/or participation in the casting call; and
That BBP et al. encourages that person to seek legal advice from an attorney in understanding the rights and obligations arising from the Participant Agreement and from the Assignment and Annuity Agreement, and in understanding the effect, if any, on patentability of that person's invention resulting from the disclosure of that person's Invention and/or participation in the casting call.

These acknowledgements are considered important to include upfront in the process and, preferably, in the Participant Agreement.

Upon selection of a person's Invention during final consideration, an Assignment and Annuity Agreement is executed between that person and a selected subsidiary or affiliated company of BBP. In this regard, a number of wholly-owned subsidiary companies preferably are formed and are owned by BBP or an affiliated entity of BBP. Each subsidiary company preferably comprises a limited liability company and may be named “Bouncing Brain Productions Subsidiary #” where the “#” represents the number of the subsidiary company. For example, the second subsidiary company formed under this system would thus be “Bouncing Brain Productions Subsidiary 2, LLC”. As set forth above, BBP is the entity responsible for producing the Show. In contrast, each subsidiary company is responsible for bringing to market, in conjunction with the Show, a respective Invention selected during final consideration.

It is considered important for several reasons to divide the various responsibilities and operations between legal entities. First, division of the responsibilities for producing the Show from the responsibilities for bringing an Invention to market separates potential liabilities associated with the Show from potential liabilities associated with bringing an Invention to market. Moreover, division of the responsibilities for bringing a particular one of the Inventions to market from the responsibilities for bringing another particular one of the Inventions to market separates potential liabilities associated with bringing the former Invention to market from the liabilities associated with bringing the latter Invention to market. Apart from this isolation of liabilities associated with the different responsibilities and operations, this division permits venture capital investment in a particular Invention apart from the merits of the other Inventions, as well as venture capital investment in the Show apart from the commercial feasibilities of the Inventions. Such flexibility is advantageous.

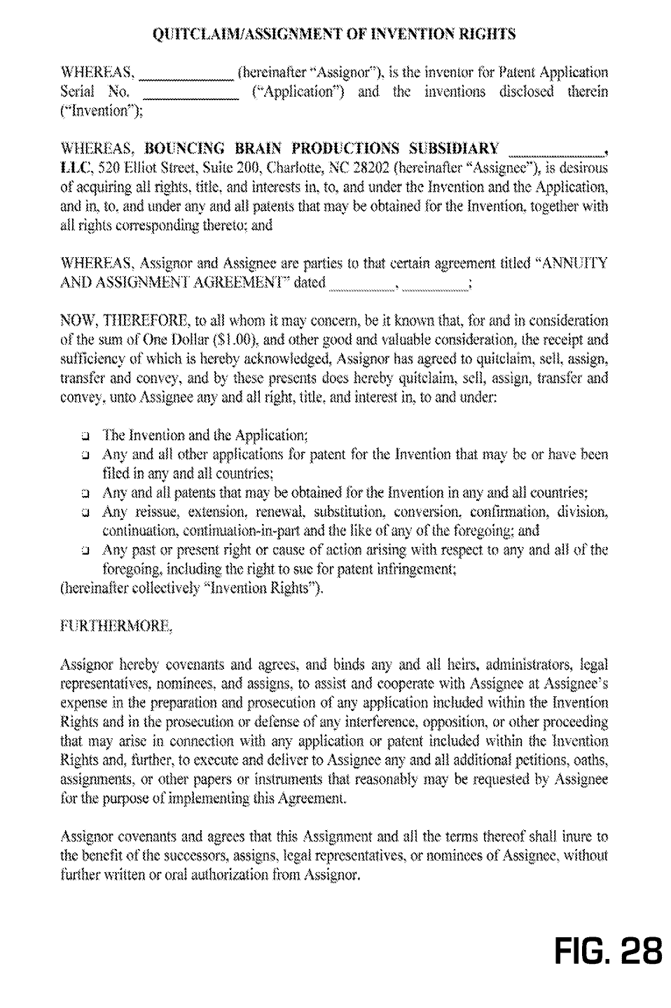

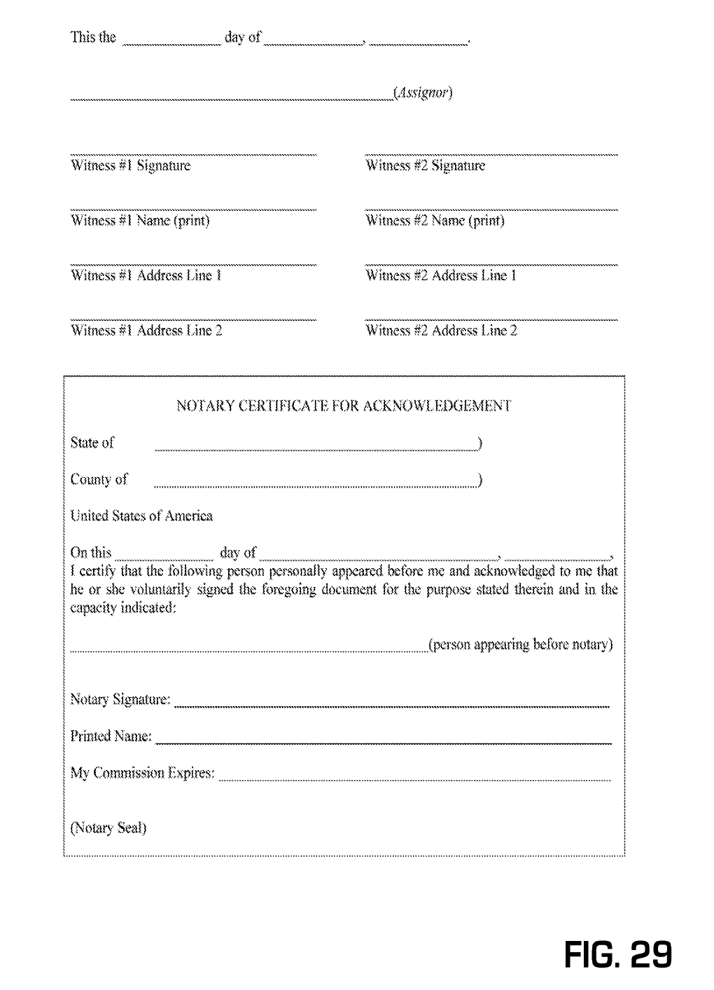

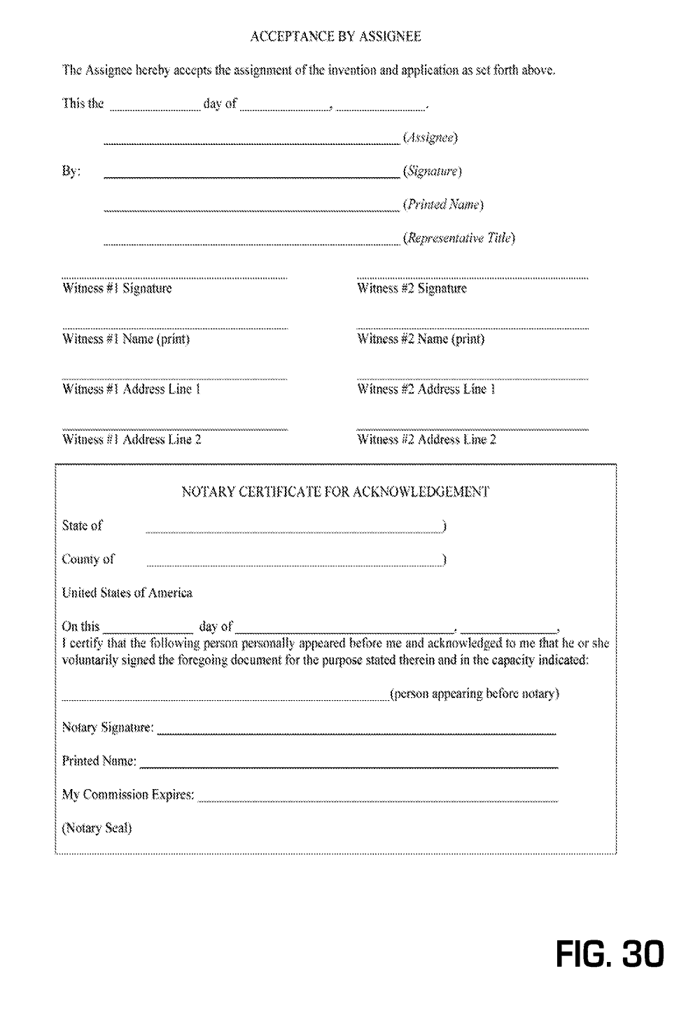

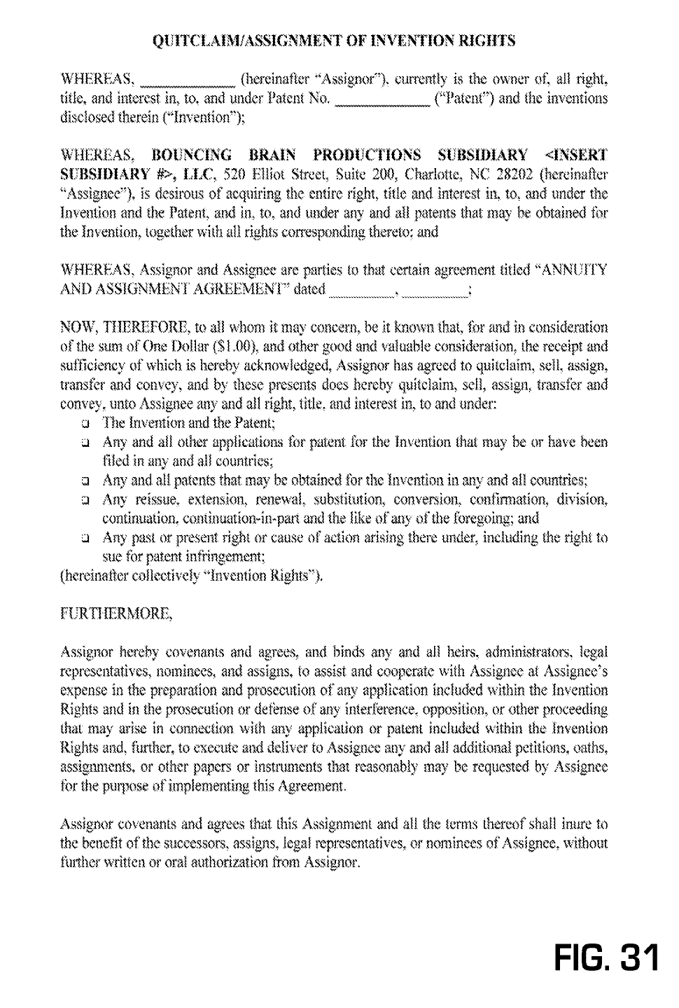

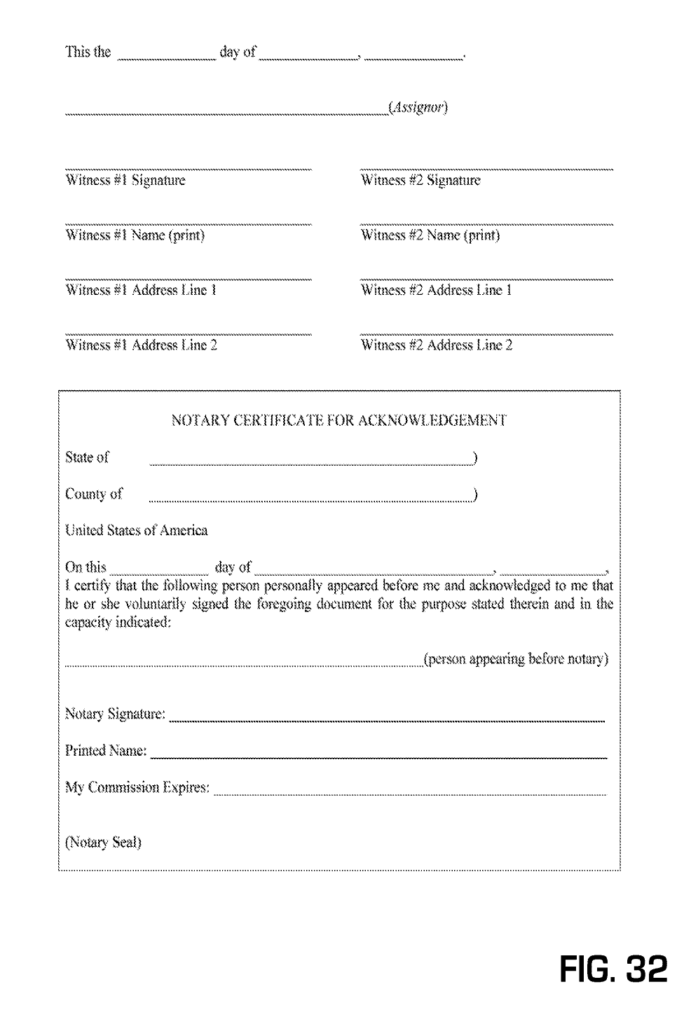

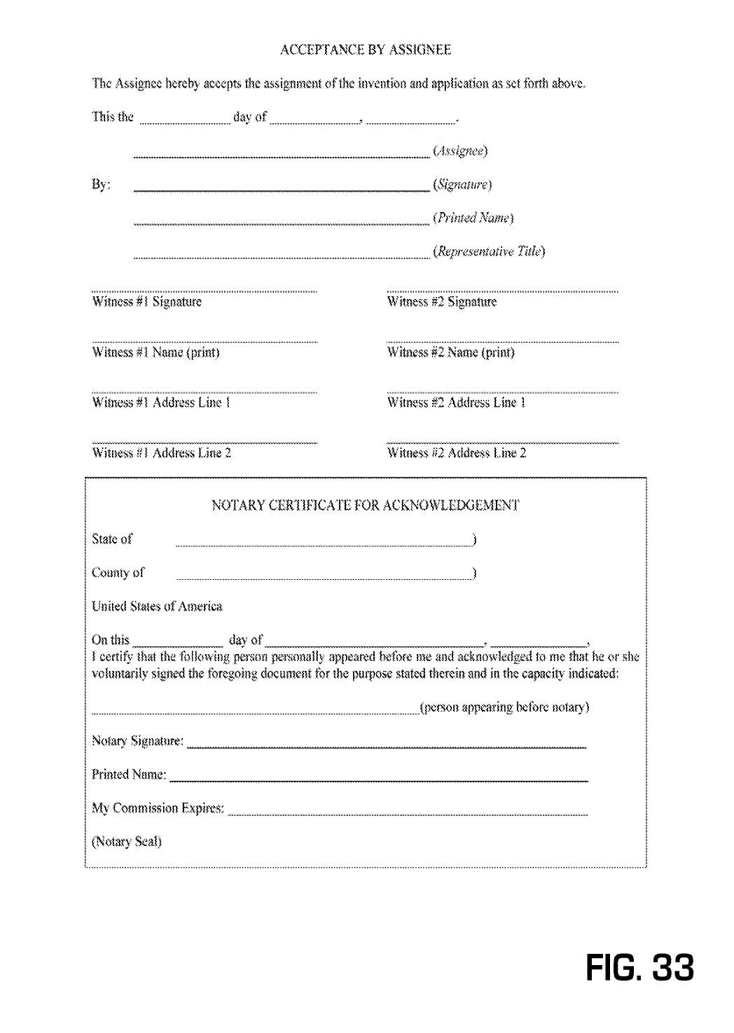

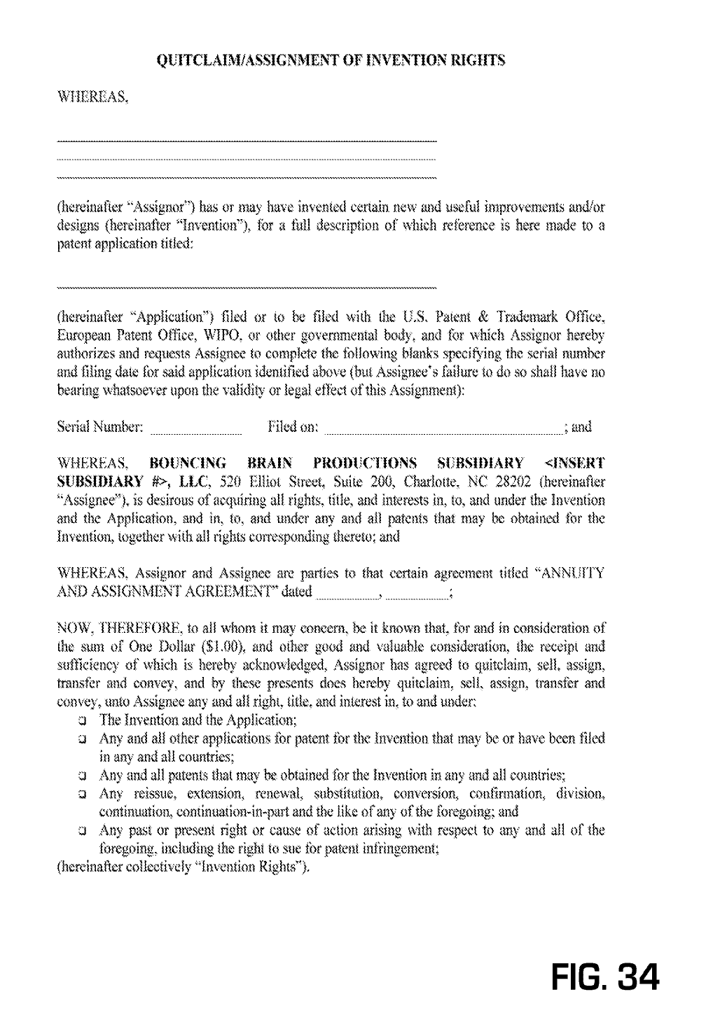

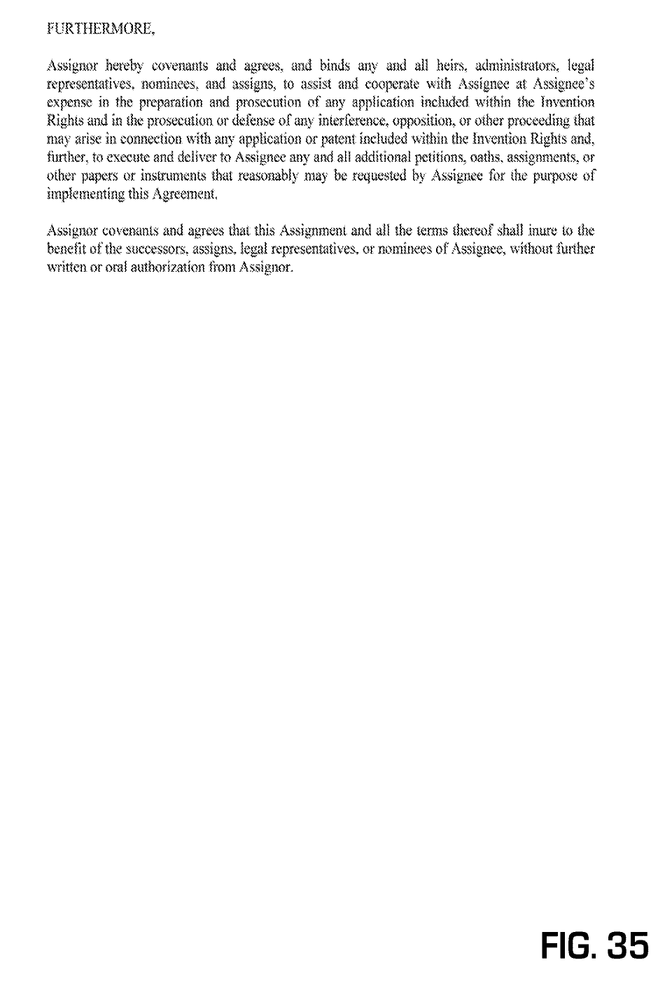

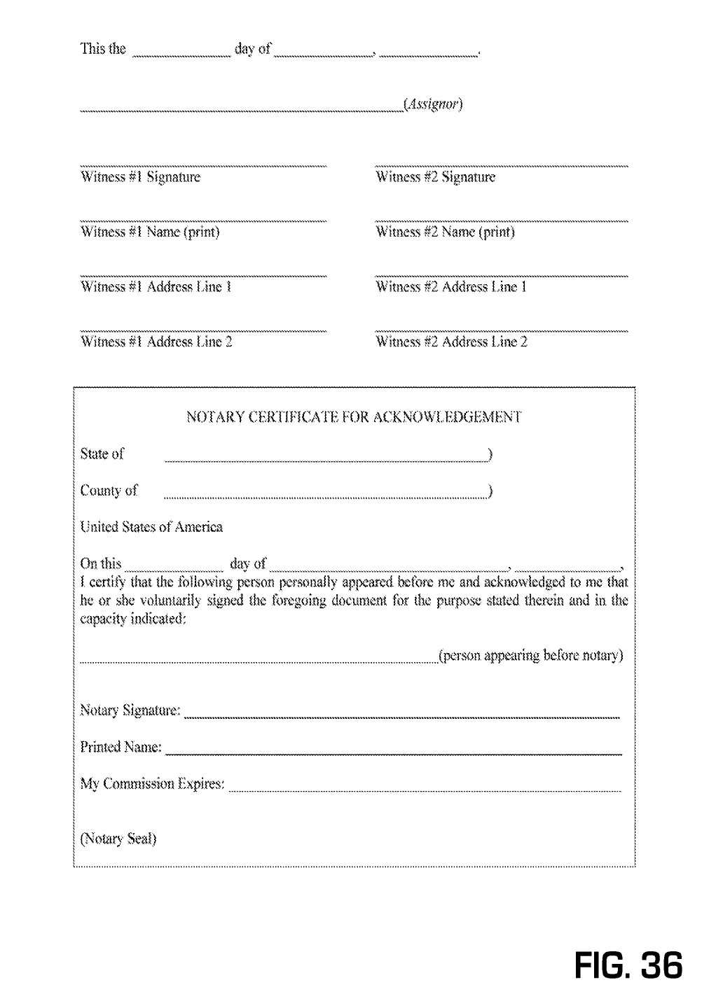

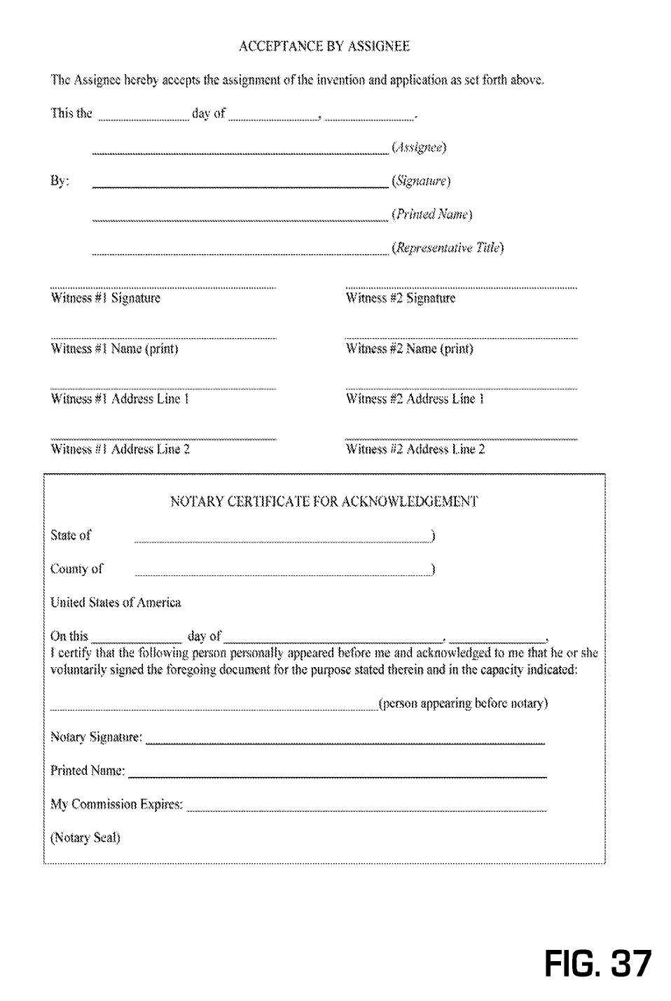

Additionally, at the time that the Assignment and Annuity Agreement is executed, if a patent application has been filed, then an assignment is executed for the pending application. Such an assignment in accordance with a preferred embodiment of the invention is illustrated in FIGS. 28-30. If a patent has granted for the Invention, then an assignment is executed for the granted patent. Such an assignment in accordance with a preferred embodiment of the invention is illustrated in FIGS. 31-33. If neither a patent nor a patent application exists for the Invention, then preferably a provisional patent application based on the disclosure of the Invention received from the person is prepared and filed, and an assignment is executed for filing with the application. Such an assignment is illustrated in accordance with a preferred embodiment of the invention is illustrated in FIGS. 34-37.

After acquiring all rights in the Invention, the appropriate subsidiary company then begins the process of bringing that Invention to market through a commercial product. This may include product ideation, product engineering, product branding, product packaging, and patent preparation and prosecution. Preferably, at least a provisional patent application is filed generally at or before the time of execution of the Assignment and Annuity Agreement that protects the Invention as disclosed, and preferably one or more provisional applications are filed during the product ideation process as deemed desirable. Once product engineering is completed and product manufacturing is ready, a nonprovisional application preferably is filed at least covering the commercial product.

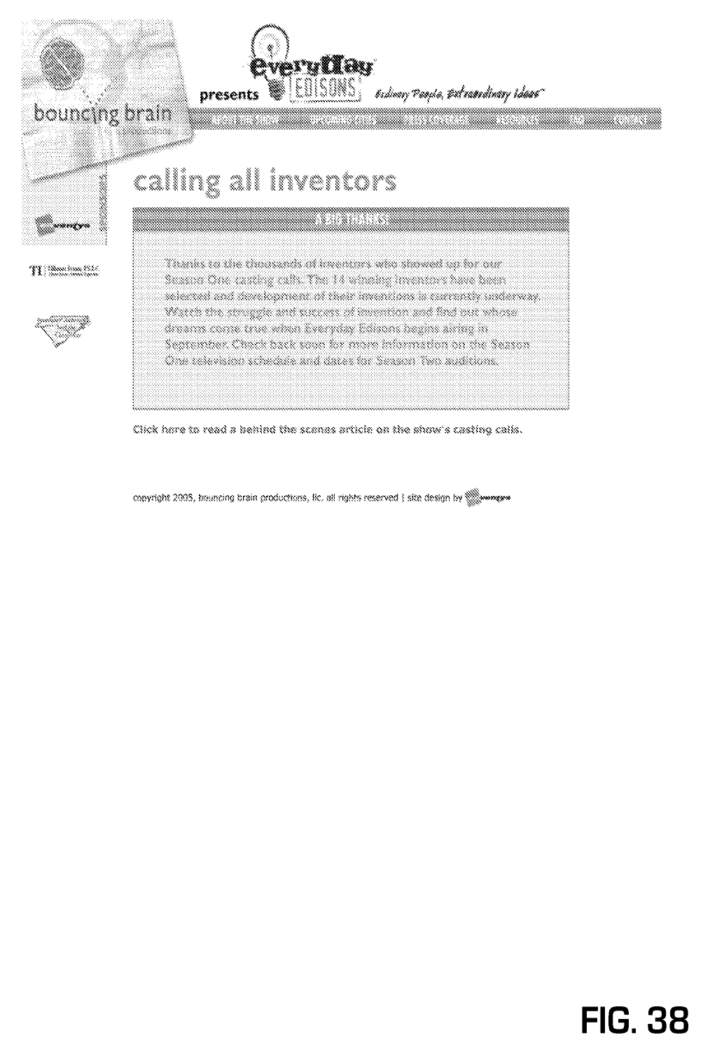

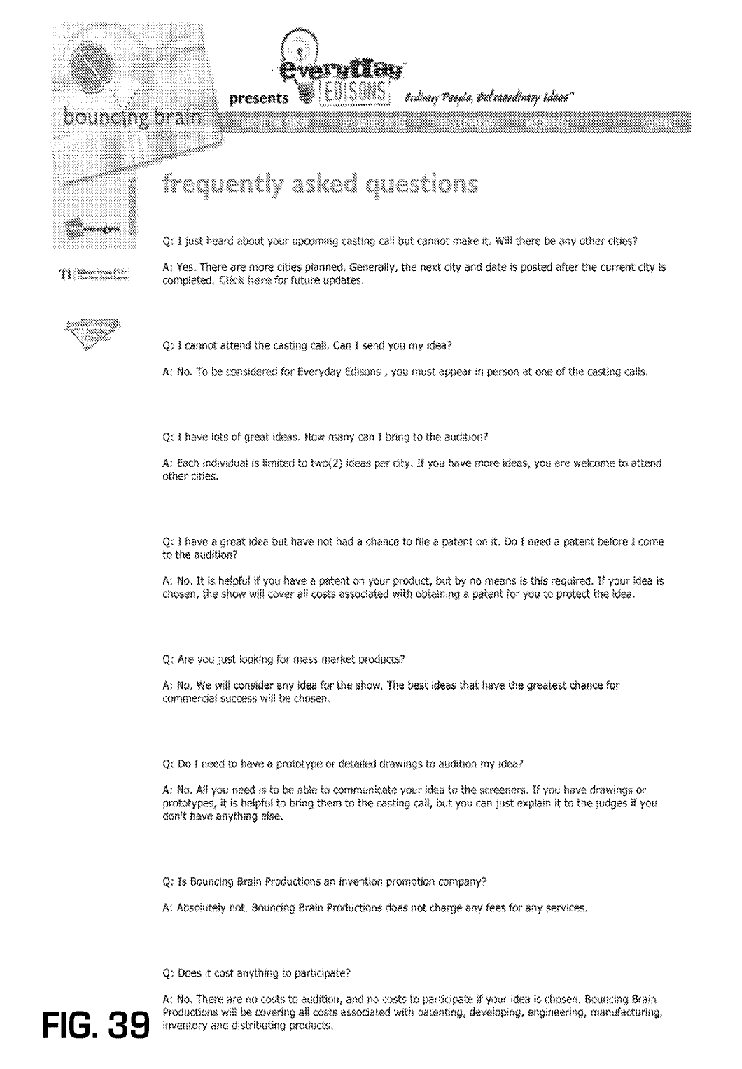

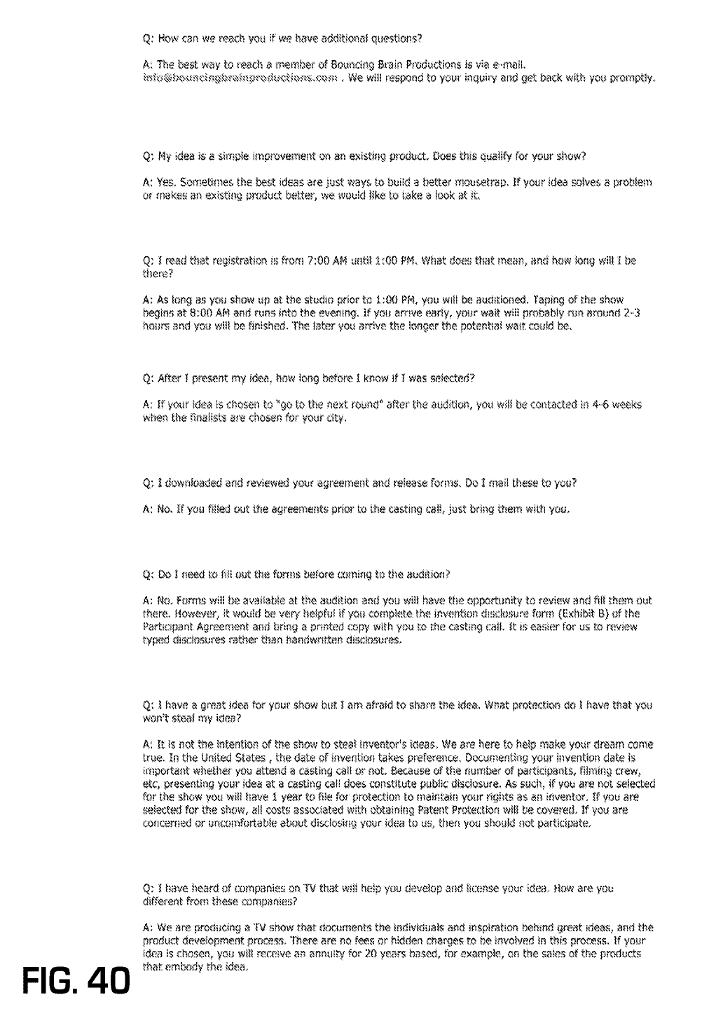

Information about the casting calls and BBP, including the contractual agreements such as the Release and the Participant Agreement, and the Assignment and Annuity Agreement, preferably is published well in advance of a casting call and may be published via an Internet website. An exemplary home page in accordance with a preferred embodiment of the invention published after a first round of casting calls has been held for the first season of the Show is illustrated in FIG. 38. A “Frequently Asked Questions” page, or FAQ page, is also preferably published at such Internet website. A FAQ page in accordance with a preferred embodiment of the invention is illustrated in FIGS. 39-41.

What is believed to be a key feature in many preferred embodiments of the invention includes the contractual agreement, by a person submitting an Invention, to the obligation of assignment of that person's intellectual property rights in the Invention to BBP (or a subsidiary thereof) prior to consideration by BBP of that person's idea for selection. This agreement to an assignment obligation is a “condition precedent” to consideration. Moreover, the fact that the person no longer retains intellectual property rights in the invention is believed to be critical to BBP not being considered an “invention promotion company” under the laws of one or more states. No services are being provided to any persons who are inventors; rather, BBP is bringing to market, and seeking patent protection for, commercial products based on inventions owned outright by BBP or a subsidiary thereof.

Legal consideration to a person signing the Participant Agreement comprises the act of considering that person's Invention for commercialization in conjunction with the Show. This would include “face time” of that person as the inventor, including any human interest perspective that the person brings to bear with relation to the Invention, such as whether the Invention was first made by that person to address a particular problem the person faced in daily life. Consideration for the Assignment and Annuity Agreement includes annual payments for a period of time as provided in the annuity agreement, which period of time preferably is twenty years.

As of the time of filing of the present application, casting calls for the first, second, and third seasons of a Show, in accordance with one or more preferred embodiments of the present invention, have been held. Casting calls have been held for season one of the Show in Charlotte, N.C.; Atlanta, Ga.; Columbia, S.C.; Nashville, Tenn.; and Tampa, Fla. Casting calls have been held for season two of the Show in Indianapolis, Ind.; Houston, Tex.; Chicago, Ill.; Washington, D.C.; and San Diego, Calif. Casting calls have been held for season three of the Show in Atlanta, Ga.; San Jose, Calif.; Dallas, Tex.; Chicago, Ill.; and Providence, R.I.

Applicant has discovered that, by combining (a) the search and commercialization of extraordinary ideas of ordinary people with (b) a video program for television, cable, or network viewing regarding such search and commercialization, i.e., the Show, a synergy occurs that draws many more people than what Applicant believes would be drawn without the Show. Conversely, by watching the Show, Applicant believes that many more people will attend the next season of casting calls than otherwise would attend without having seen the Show. Thus begins an cycle that draws more and more people into the process.

Moreover, Applicant believes that, as a result of this synergy, many more people agree to the Participant Agreement than otherwise would if they did not have the opportunity to appear on the Show. Indeed, it is surprising to Applicant the number of people who are willing to disclose their ideas without obligations of confidentiality, without restrictions on use, and with an obligation of assignment of title and all interests in their ideas in exchange for consideration that is predetermined without regard to the actual ideas.

Still yet, Applicant has been surprised by the number of people that have chosen to participate whom have already been granted a patent, or who have already incurred the expense of preparation and initial prosecution and who have a pending application, but who have not been able to successfully bring the Inventions to market. Indeed, a person who has an extraordinary idea but has not yet filed for patent protection or incurred any significant expense (just such a person is the perfect candidate for the business model of the present invention) nevertheless receives the same consideration as the person who has gone through, and incurred the expenses associated with, the patenting process.

Applicant believes that these surprising results arise from the synergy provided by the combination of the search and commercialization with the Show, and that, if not for the Show, fewer people (whether with or without patents) would choose to participate in the search for, and possible commercialization of, their ideas by BBP.

People have extraordinary ideas, and often those people have neither the means nor the resources, or the knowledge, to bring such ideas to market to the benefit of society overall. Their extraordinary ideas simply fail to reach the public's knowledge. The business model of the invention is directed specifically to capturing and bringing to light such extraordinary ideas. No monetary investment is required and no monetary expense is incurred by a person presenting an idea.

### Website Implementation

In accordance with one or more preferred embodiments of the present invention, a controlling entity contracts with a sponsor that desires to obtain innovative ideas for commercialization. The controlling entity utilizes a website configured to allow administrative users to post searches for innovative products. These searches are publicly viewable by visitors of the website. Visitors can register with the website to become registered users of the website, and, after doing so, can submit innovations to the website for possible commercialization. The controlling entity reviews the submitted innovations and identifies one or more of the submitted innovations as innovative ideas the sponsor might be interested in. The controlling entity then presents the identified innovative ideas to the sponsor, who considers the innovative ideas and chooses whether to pursue commercialization of the one or more innovative ideas. If the sponsor elects to commercialize one or more of the innovative ideas, the sponsor will owe renumeration back to the controlling entity per the contract between the two. Submitted innovations that are not selected for commercialization are maintained in a database. The database may be subsequently searched to locate previously submitted innovations.

It will be appreciated that websites and databases in accordance with one or more embodiments of the present invention as described herein can be implemented using a wide variety of hardware and software known to the Ordinary Artisan. In a preferred embodiment, the website is written using Ruby on Rails and loaded on one or more web servers, and the database is implemented using MySQL, and loaded on one or more database servers. In this way, a website in accordance with one or more preferred embodiments of the present invention can be characterized as being “tied to” one or more web servers, and a database in accordance with one or more preferred embodiments of the present invention can be characterized as being “tied to” one or more database servers.

### Website Implementation—Search Creation

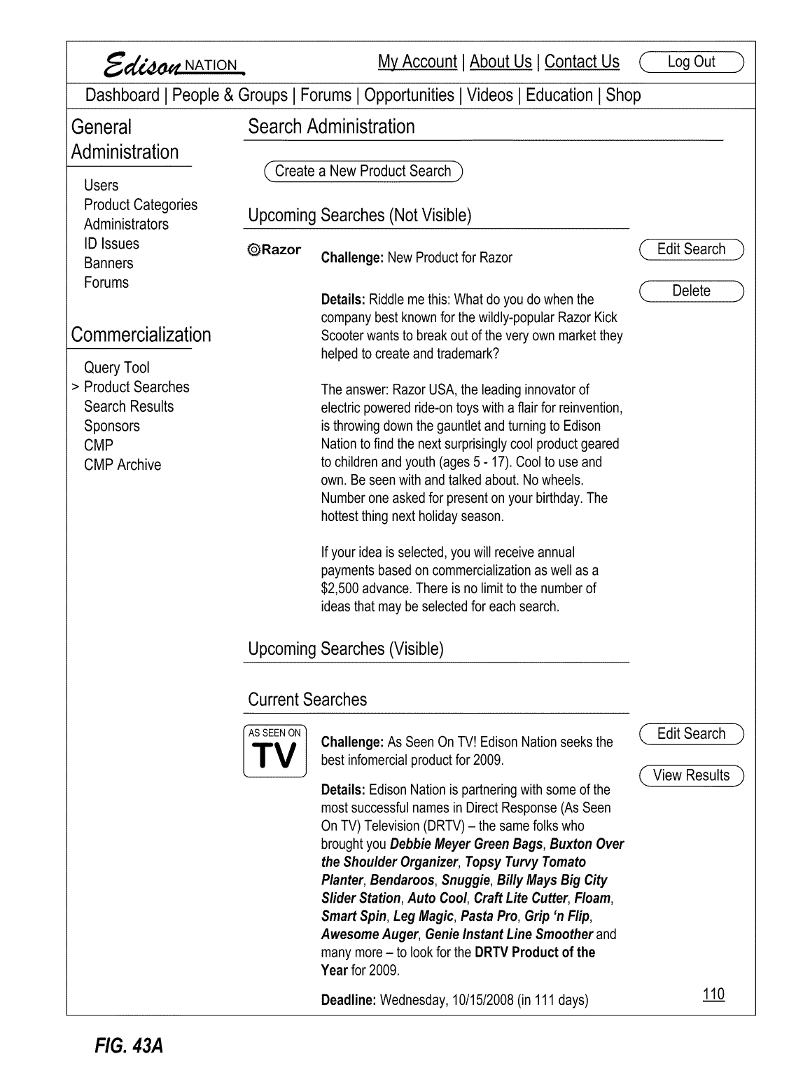

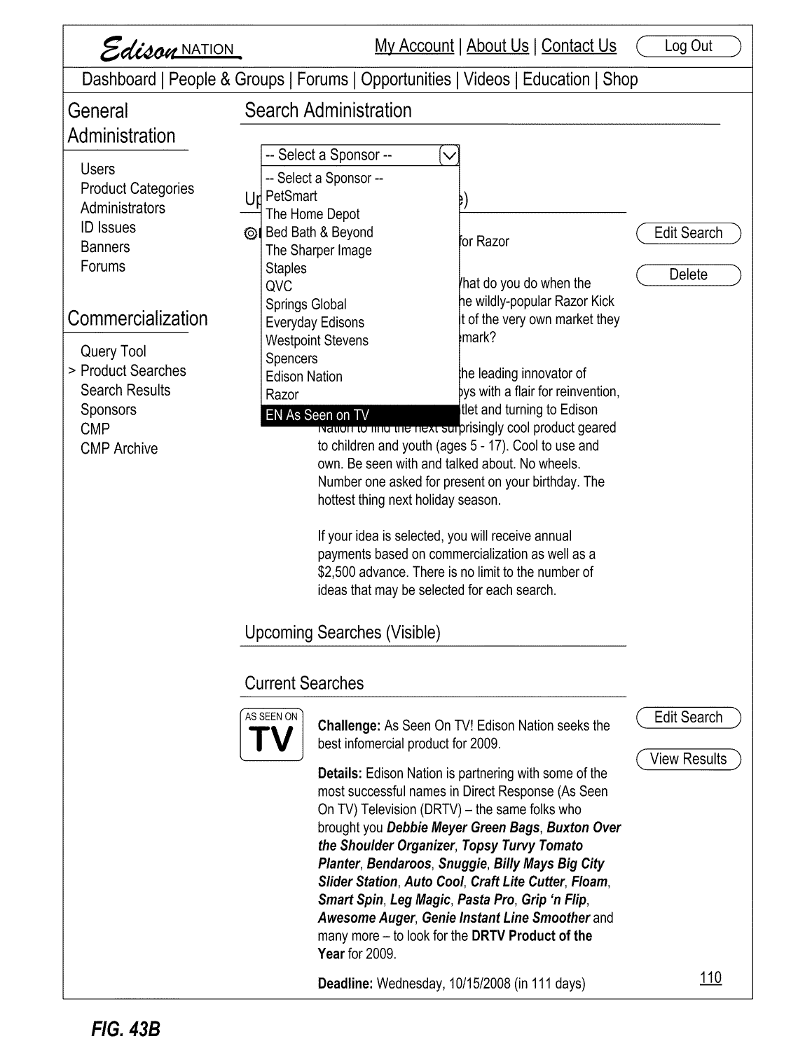

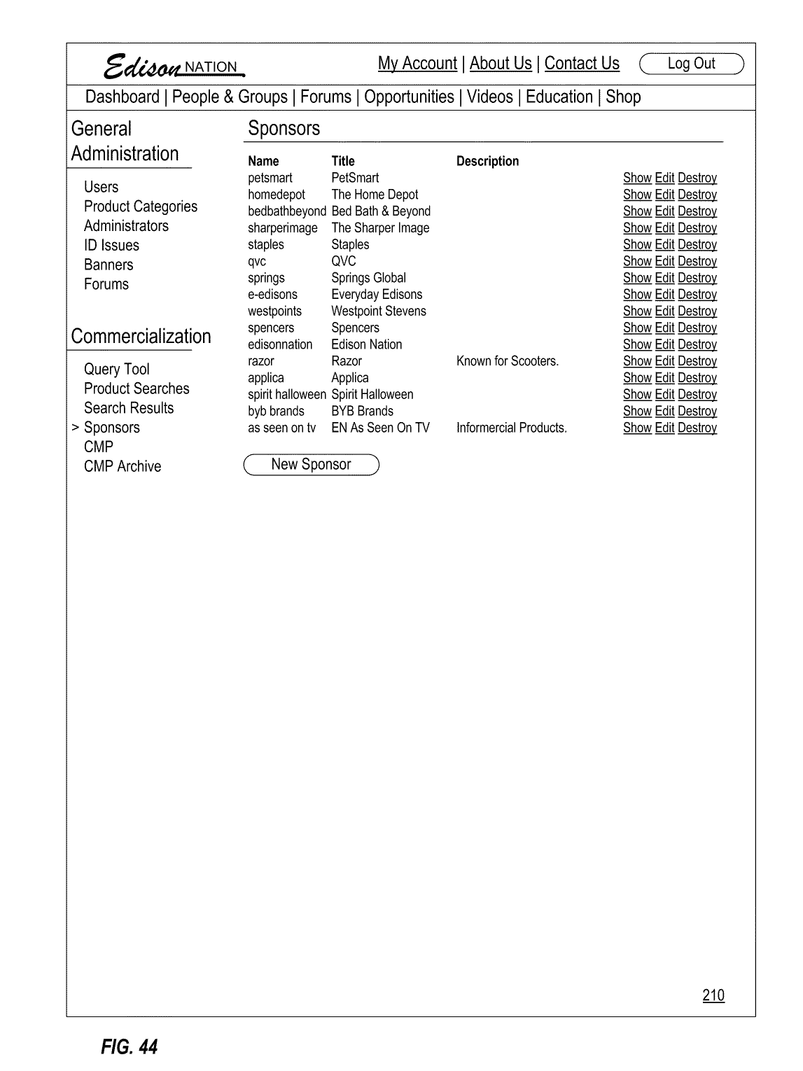

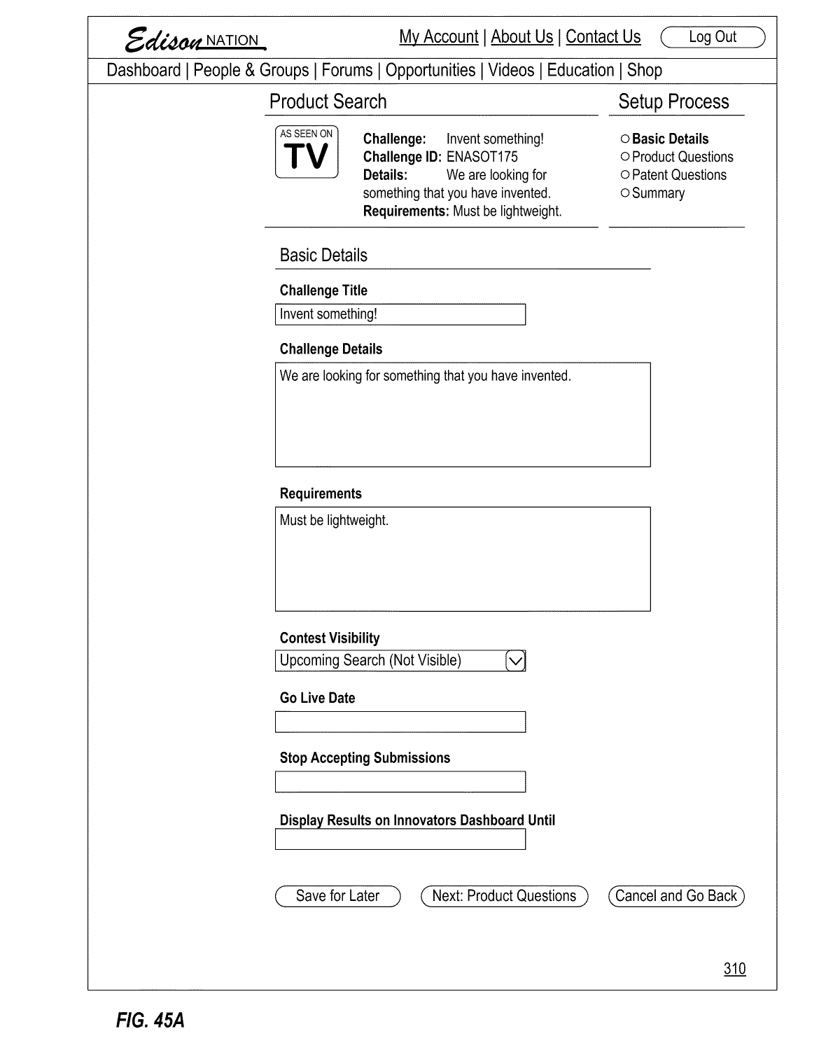

FIG. 43A is a search administration page 110 of an exemplary website in accordance with an embodiment of one or more aspects of the present invention. The search administration page 110 is utilized by an administrative user to create, edit, and delete product searches. Product searches are characterized as either current, upcoming and visible, or upcoming and invisible. A current search is an ongoing search that users can submit ideas to via the website. A visible, upcoming search is a search that users can view information on via the website, but that users cannot yet submit ideas to via the website. An invisible, upcoming search is a search that is not yet visible to non-administrative users of the website.

Existing product searches of all types are available for viewing by administrative users on the search administration page 110. Each search includes a “Challenge” descriptor as well as a more lengthy “Details” descriptor. Each of these descriptors contains information that is, or will be, provided to users as information pertaining to the search. Each search also displays one or more logos associated therewith.

Each of these searches is associated with a sponsor. Preferably, the sponsor is an entity on whose behalf the search is being performed to obtain one or more ideas for commercial products. To create a new search, an administrative user clicks on a create new product search button. After clicking this button, a dropdown menu is displayed which allows the administrative user to select a sponsor for the new search, as can be seen in FIG. 43B.

The list of sponsors available for selection is editable by administrative users via a sponsors page 210 of the website. Each sponsor is associated with a name, a title, and a description. Clicking on a display link associated with a sponsor allows an administrative user to view a sponsor page which may include more detailed information. Clicking on an edit link associated with a sponsor allows an administrative user to edit the information associated with that sponsor. Clicking on a destroy link associated with a sponsor allows an administrative user to delete that sponsor. Lastly, clicking on a new sponsor button allows an administrative user to create a new sponsor.

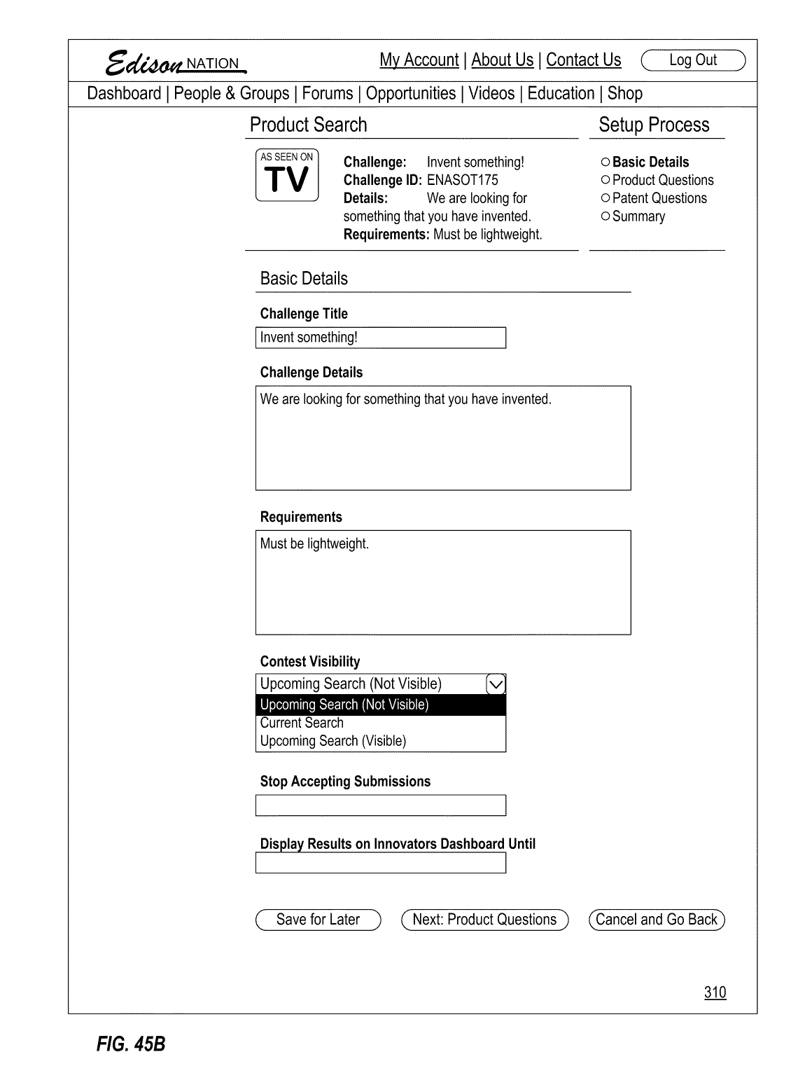

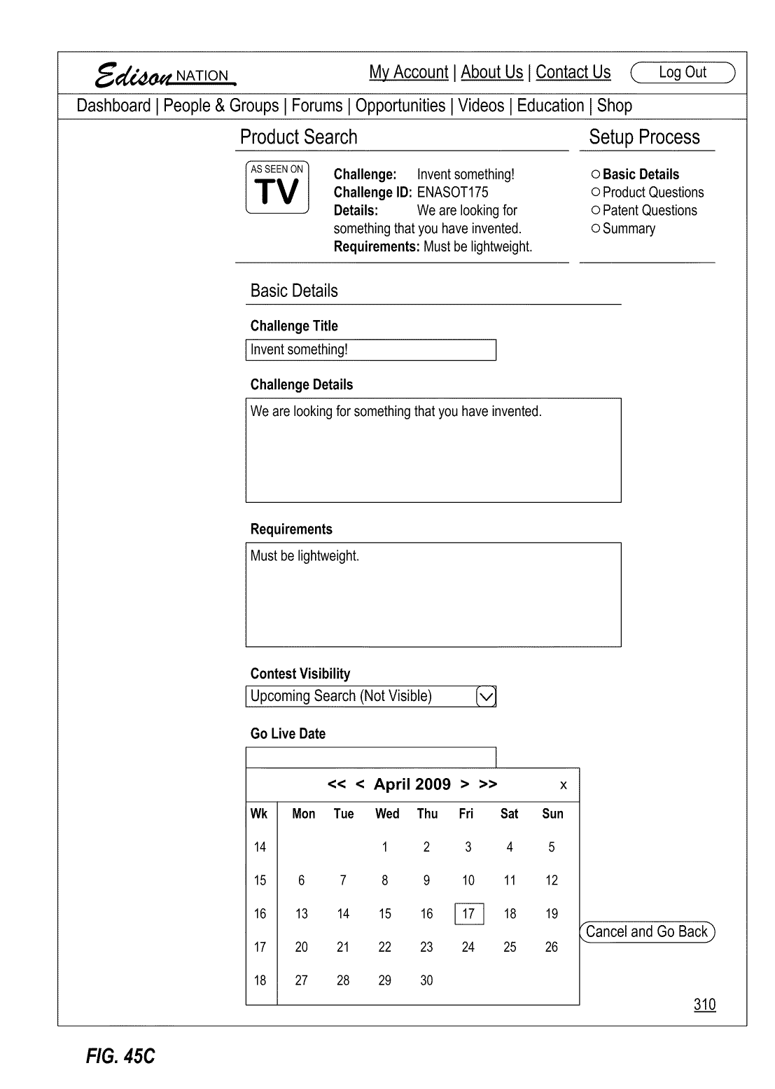

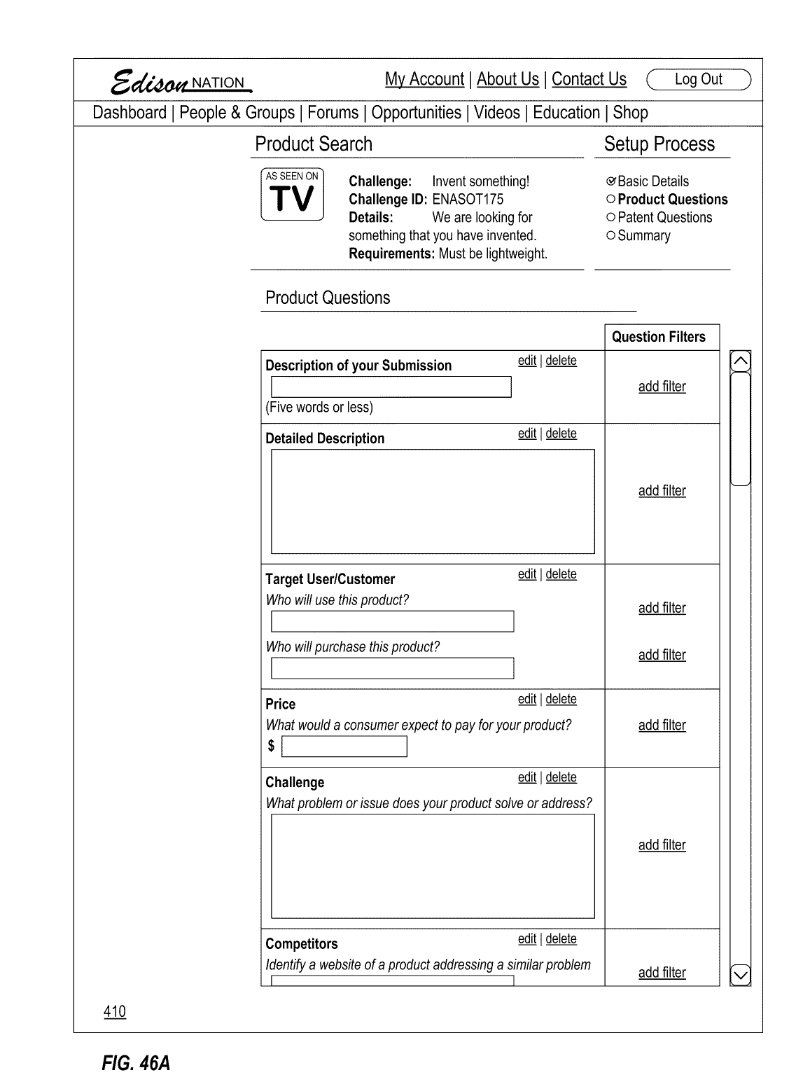

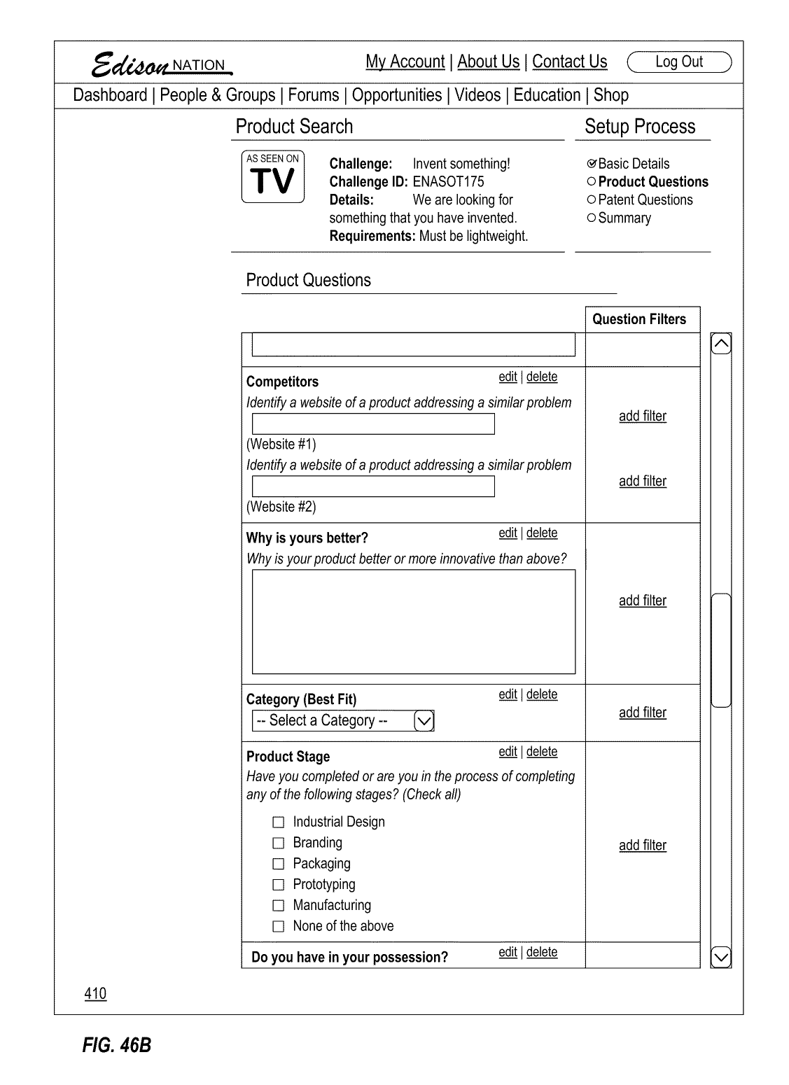

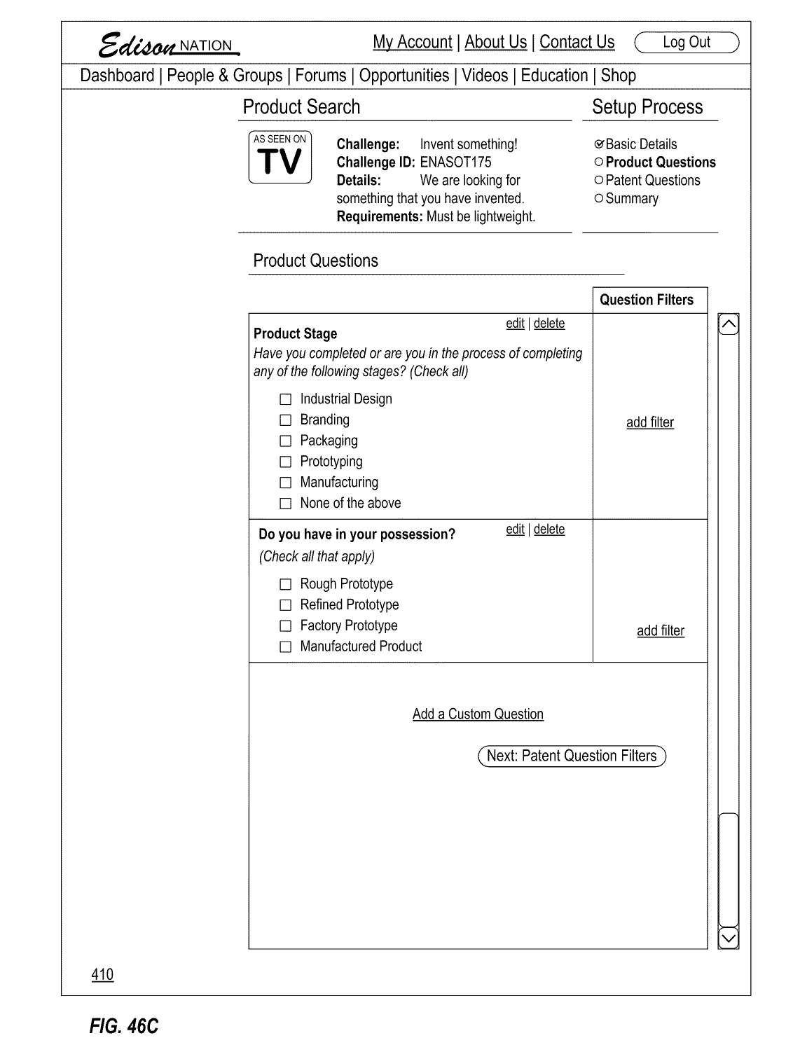

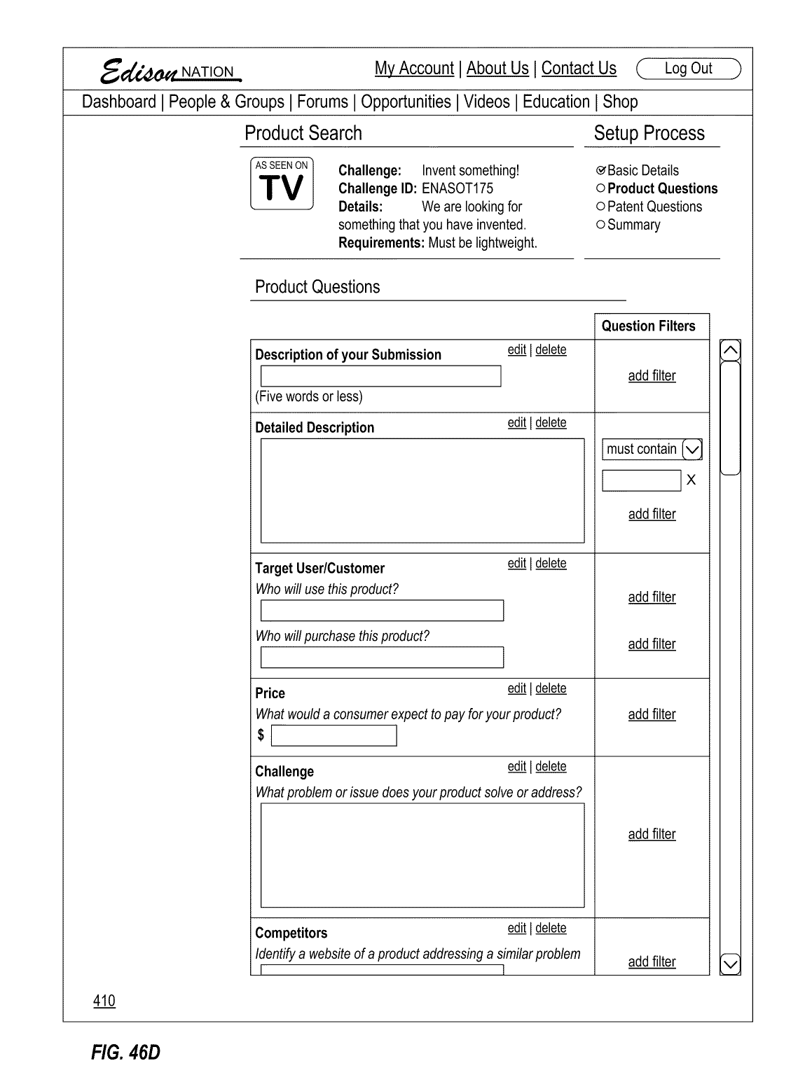

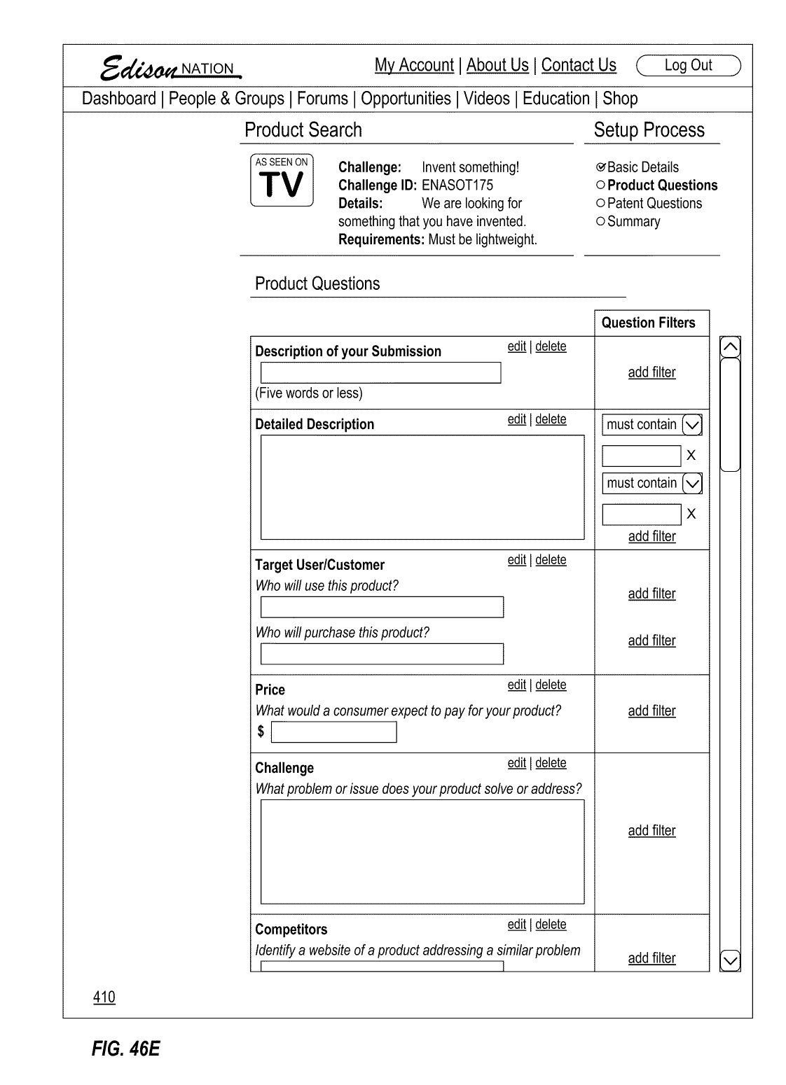

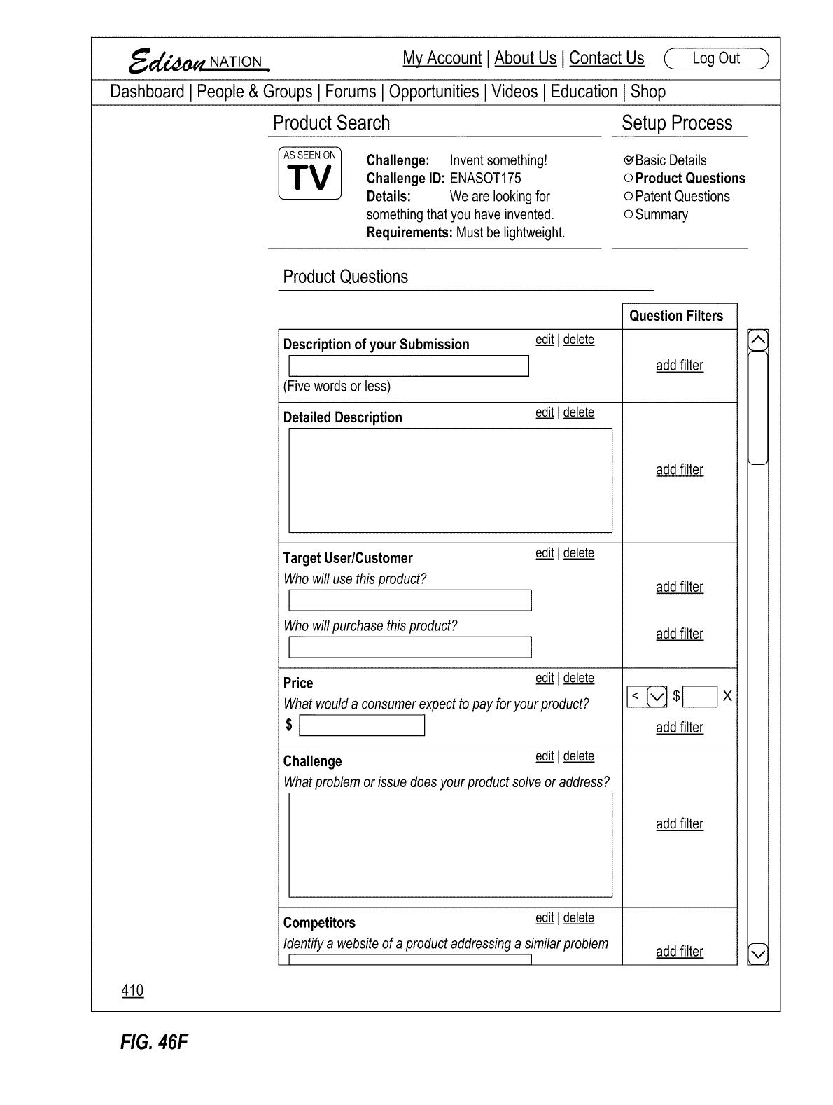

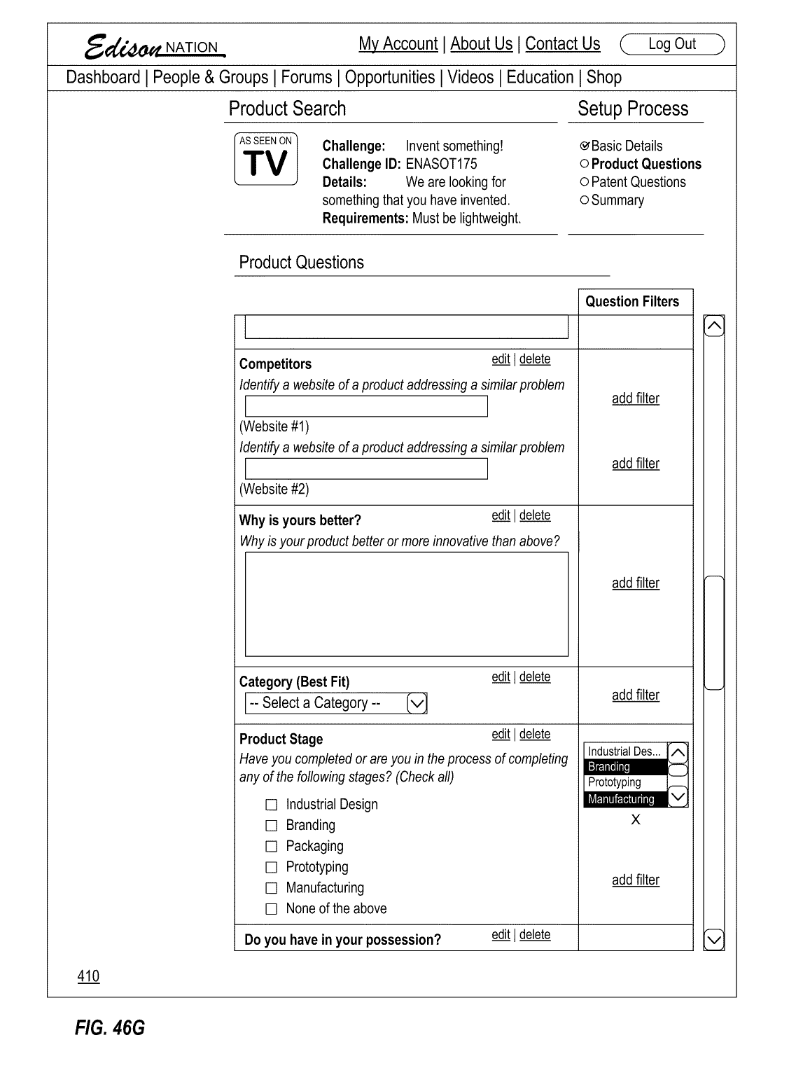

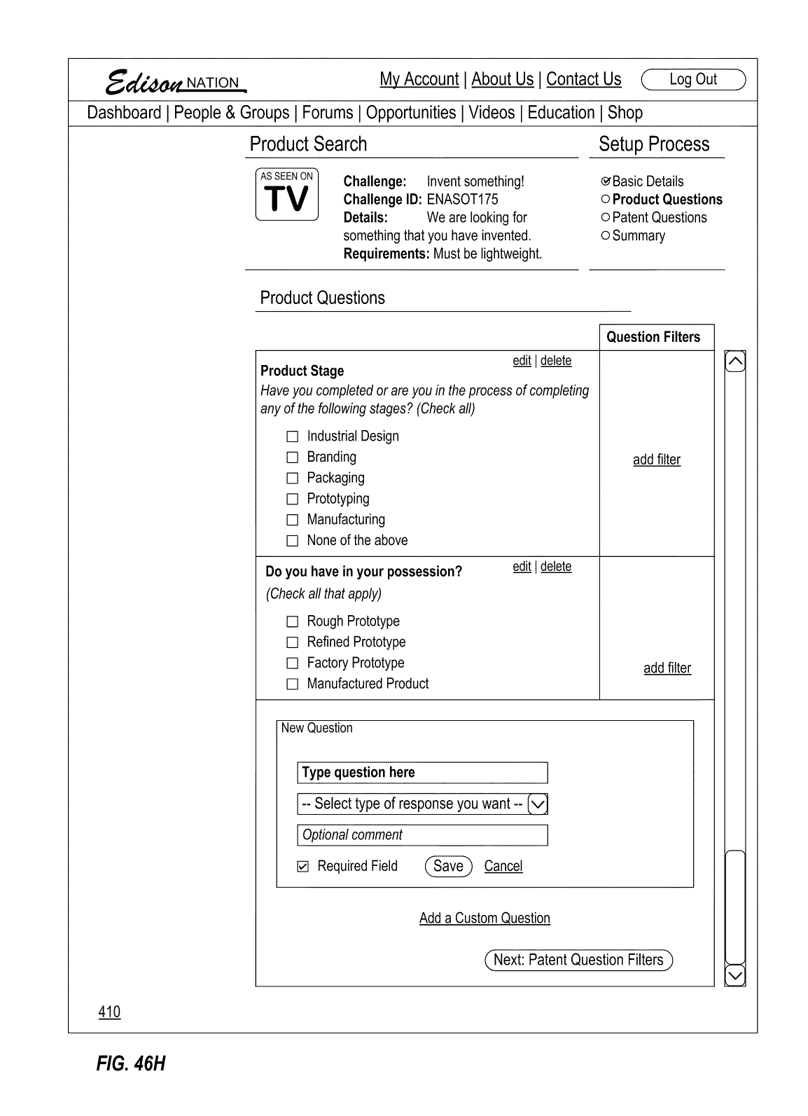

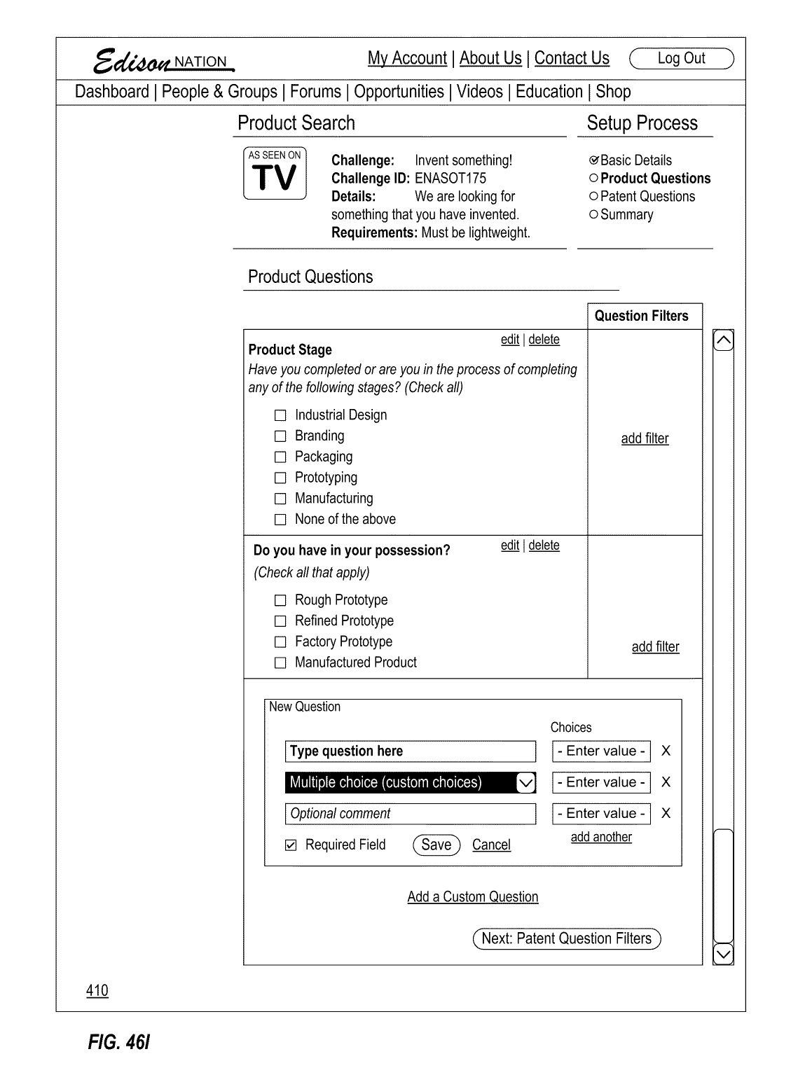

Returning to the search administration page 110, after an administrative user selects a sponsor from the dropdown menu, navigation is effected to a basic details setup page 310, as can be seen in FIG. 45A. On the basic details setup page 310, an administrative user enters a title, details, and requirements associated with the search via text input fields. The administrative user then selects, via a dropdown menu, whether the search is an upcoming search that should currently be visible, a current search, or an upcoming search that should currently be invisible, as can be seen in FIG. 45B. Next, the administrative user selects a go live date, a date that submissions will no longer be accepted, and a date until which results will be displayed on a submitter's dashboard (which will be described in more detail hereinbelow). A pop-up calendar enables quick selection of a specific day, as can be seen in FIG. 45C. The basic details setup page 310 further includes a save button, a next button, and a cancel button. Clicking the save button saves the information entered so that it can be accessed later. Clicking the cancel button cancels the creation of a new search. Clicking the next button effects navigation to a product questions setup page 410, as can be seen in FIG. 46A.

The product questions setup page 410 enables an administrative user to specify questions that a user will have to answer when submitting an innovation to the search. More specifically, the product questions setup page 410 allows a user to create forms that will be presented to a user for input, to set text associated with these forms that will be displayed adjacent these forms, and to create filters for each form that will automatically parse a user's input for that form.

Additionally, the product questions setup page 410 includes a plurality of predefined questions, together with predefined input forms, which are designed to query a user for information that might typically be desired in a search. FIGS. 46A-4I illustrate exemplary such predefined questions and input forms. The product questions setup page 410 allows an administrative user to edit or delete each of these predefined questions and forms.

The product questions setup page 410 includes an “Add a Custom Question” link that allows an administrative user to add one or more custom questions, as noted above. Upon clicking the “Add a Custom Question” link, an administrative user is presented with an interface that allows a user to create these custom questions, which interface can be seen in FIG. 46H. An administrative user types a question into a text field; selects, via a dropdown menu, the type of response that a user submitting an innovation should enter in response to the question; selects, via a checkbox whether the question is a required question; and optionally includes a comment as well via another text field. The administrative user then saves the custom question using a “Save” button or cancels creation of the custom question using a “Cancel” link. It will be understood that a plurality of different response types can be presented to an administrative user to select, each of which will utilize a type of input form associated therewith, including “text”, which will utilize a text field; “lots of text”, which will utilize a text box; “number with no decimal places”, which will utilize a text field configured to accept integers, i.e. numbers without a decimal point; “number”, which will utilize a text field configured to accept numbers; “date”, which will utilize a pop-up calendar allowing a user to select a date identical to the one illustrated in FIG. 45C; “multiple choice (custom choices)”, which will further allow an administrative user to enter a plurality of custom choices utilizing text fields, these custom choices will be presented to users as radio buttons; “multiple choice (yes or no)”, which will present users with only two choices as radio buttons, namely “yes” and “no”; “single answer checkbox”, which will utilize a single checkbox; “multiple answer checkbox”, which will utilize a plurality of checkboxes, and “dollar amount”, which will utilize a text field configured to accept monetary amounts, e.g. “$95.50”. It will further be understood by those skilled in the art that a plurality of other response types, each associated with a type of input form, could be presented for selection by an administrative user as well.

Additionally, for each response, there exists an associated predefined filter form. An administrative clicks on an “add filter” link associated with each predefined or custom question to create a filter for that question. For example, an administrative user clicks on the “add filter” link associated with the “Detailed Description” question of FIG. 46A to display a filter creation interface, which is illustrated in FIG. 46D. The filter creation interface allows an administrative user to specify that input of a user submitting an innovation must contain, or not contain, a certain word or phrase. An administrative user can add additional filters by clicking the “add filter” link again, as illustrated in FIG. 46E. Filters for other question types can include filters for determining whether a value is greater than, less than, greater than or equal to, less than or equal to, or equal to, another value; whether one or more certain checkboxes were checked; and whether a certain radio button was selected. It will be understood that a wide variety of filters known to the Ordinary Artisan could be made available for use by administrative users. Each filter is removable by an administrative user via an “X” link located adjacent the filter.

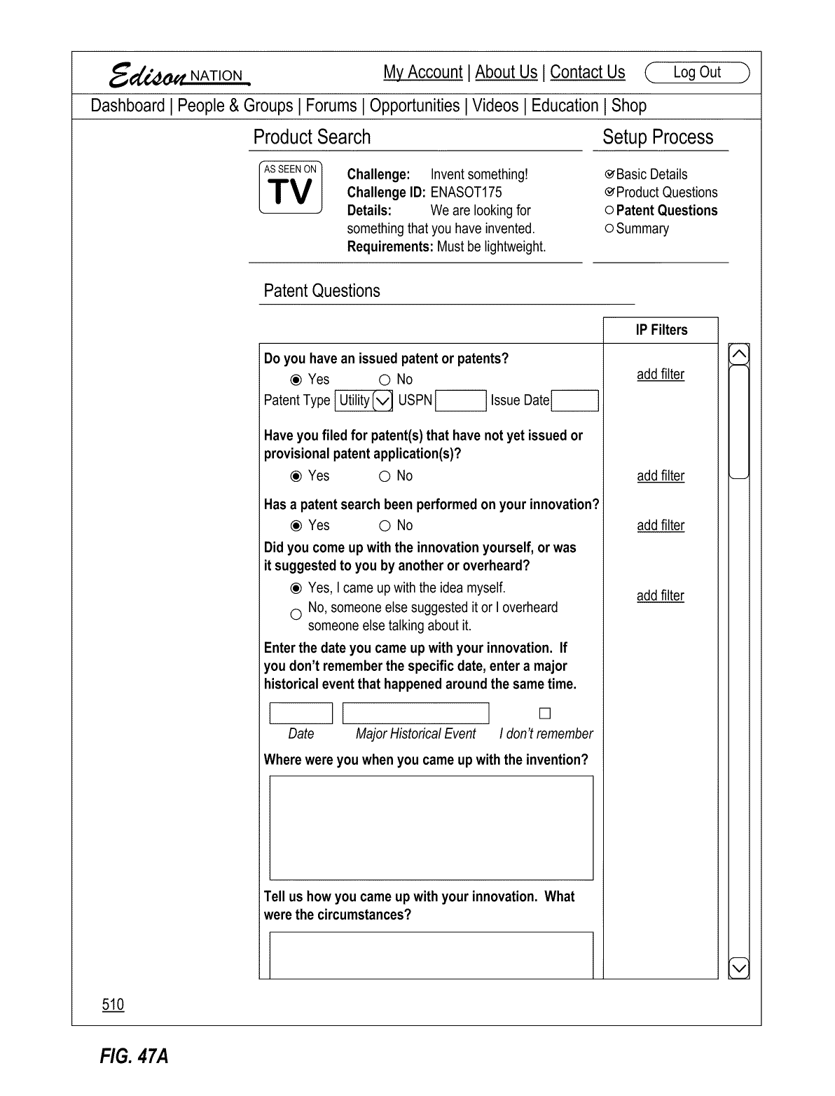

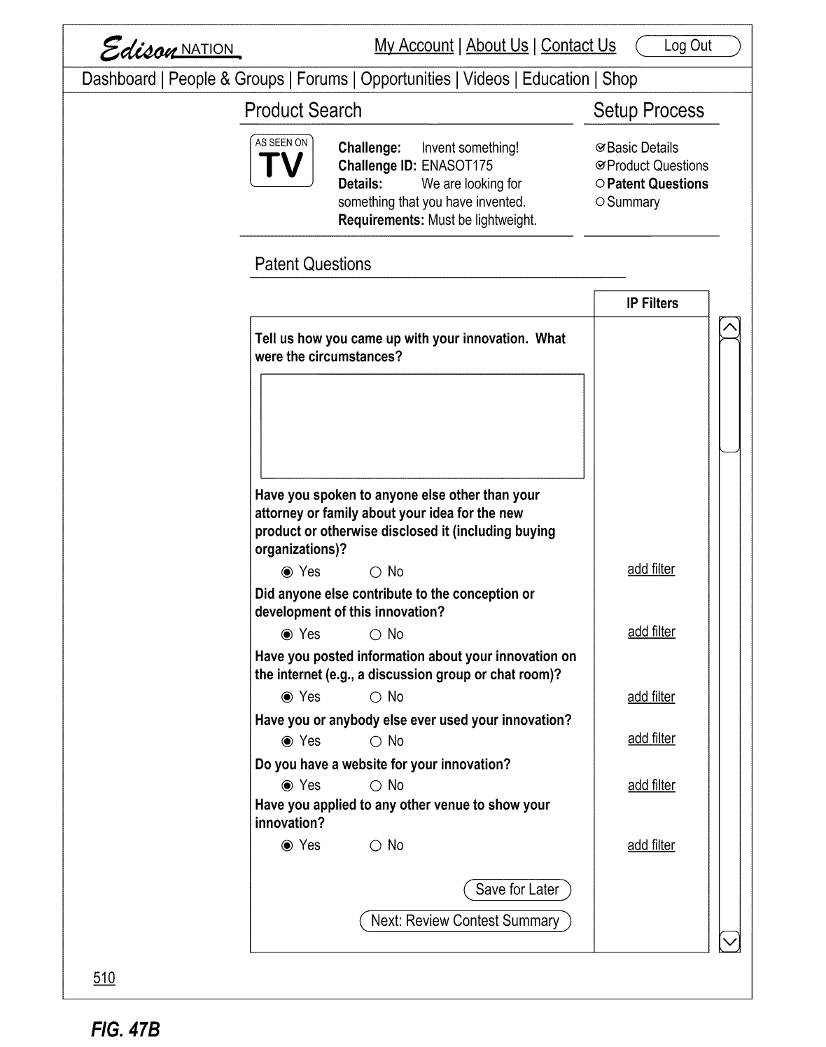

After an administrative user is satisfied with a certain set of custom and predefined questions and associated filters, the administrative user clicks a “Next” button to effect navigation to a patent questions setup page 510, which is illustrated in FIGS. 47A and 47B.

The patent questions setup page 510 includes a plurality of predefined questions which prompt a user for input regarding an innovation that the user is submitting. More specifically, the questions are directed to information concerning existing intellectual property associated with the innovation, as well as facts relevant to the pursuit of additional intellectual property in connection with the innovation. Preferably, this information includes information material to patentability of the innovation. Notably, a majority of these questions are yes or no questions which are associated with yes and no radio buttons. As with the product questions setup page 410, and as can be seen in FIGS. 47A and 47B, each yes or no question has an “add filter” link associated therewith that allows an administrative user to create a filter for that question.

After an administrative user is satisfied with a certain set of filters (which could include no filters at all), the administrative user clicks a “Next” button to effect navigation to a summary page. The summary page displays the information on the search entered via the basic details setup page 310 together with the questions and forms selected via the product questions setup page 410 and patent questions setup page 510. If the administrative user is satisfied with all of the details, questions, and forms as displayed on the summary page, the administrative user clicks a “Post” button to post the contest to the website. If the administrative user has selected that the search is a “current” search or is an “upcoming and visible” search then the search will be visible to users of the website. If the administrative user has selected that the search is a “current” search, the users of the website will not only be able to view the search, but further will be able to submit entries for the search.

### Website Implementation—Submitting a Search Entry

The website is configured to allow registered users to submit entries to all current searches. Preferably, submission of entries is limited to registered users who enjoy a “preferred status”. In at least one embodiment, a user obtains preferred status by paying a monthly fee.

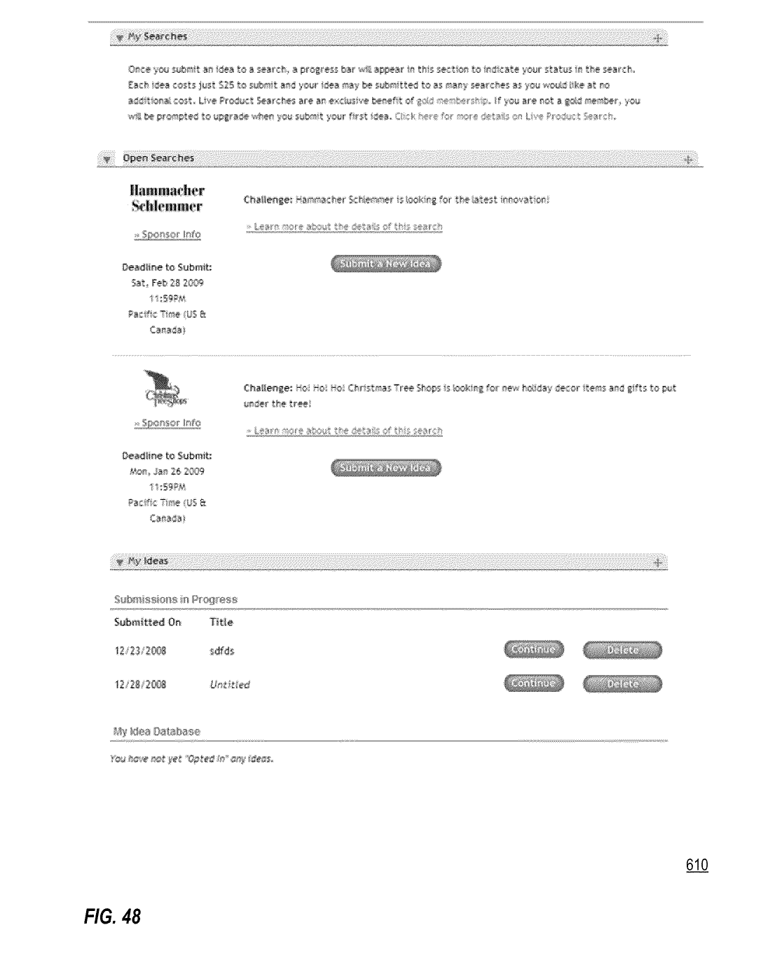

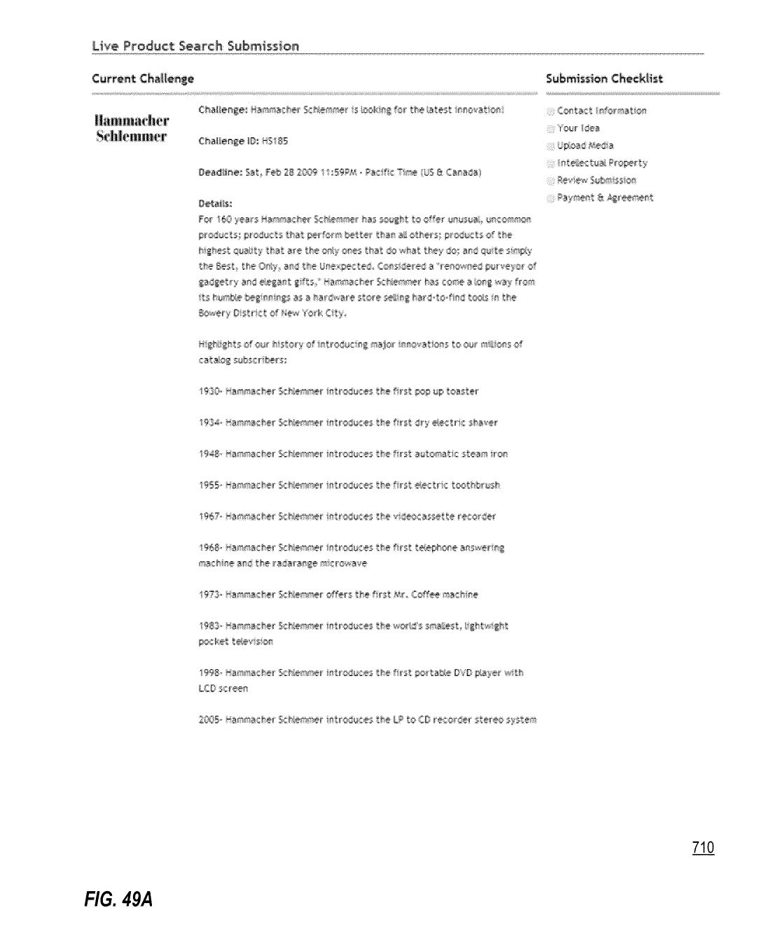

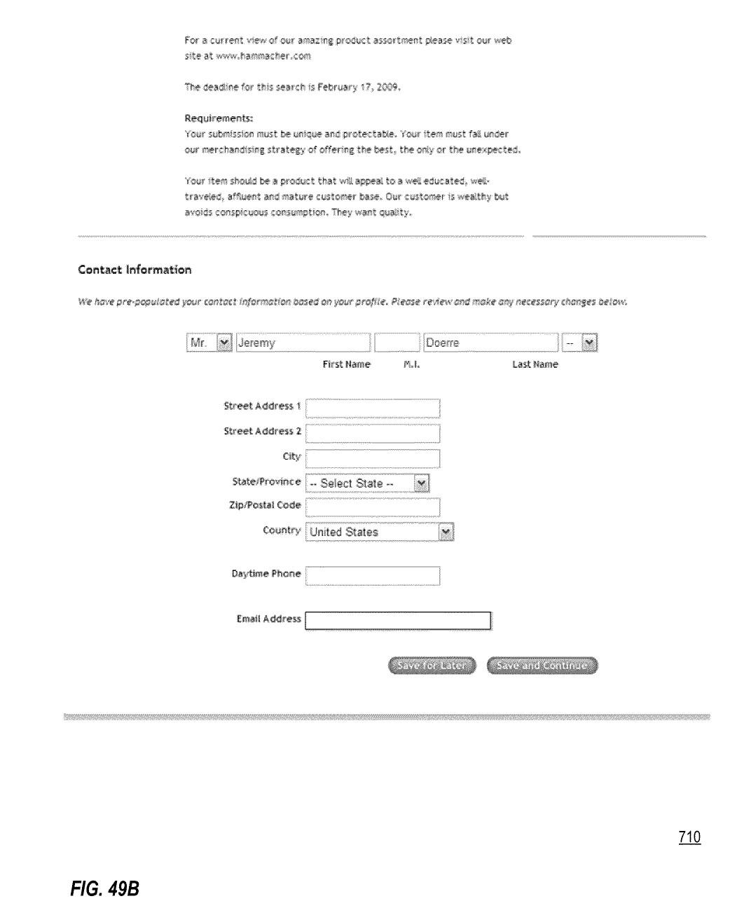

A user eligible to submit entries to a search does so via a dashboard page 610 of the website, as can be seen in FIG. 48. A user's dashboard page 610 displays all current searches that the user is able to enter a submission into. To begin entering a submission, a user clicks a “Submit a New Idea” button on the dashboard page 610 to effect navigation to a submission opening page 710, illustrated in FIGS. 49A-B. The submission opening page 710 displays basic details related to the search that were entered by an administrative user via the basic details setup page 310. The submission opening page 710 further prompts the user to enter his or her contact information via forms, as can be seen in FIG. 49B.

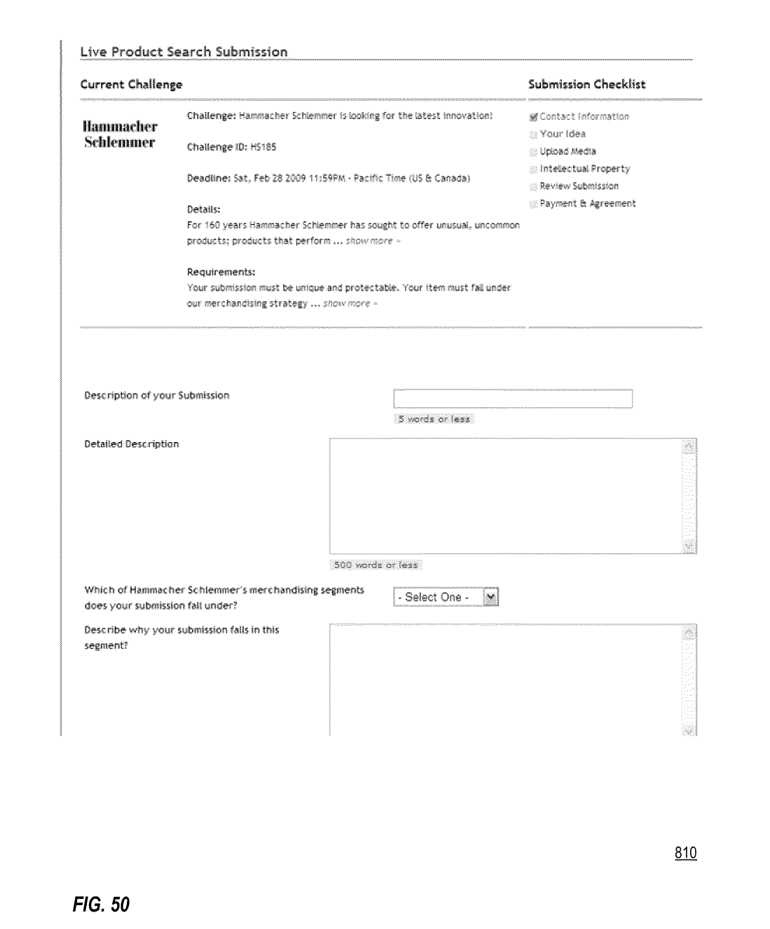

After reviewing the basic details and entering his or her contact information, the user effects navigation to a submission details page 810 by clicking a “Continue” button. The submission details page 810, as can be seen in FIG. 50, allows the user to answer questions related to his or her innovation using forms that were selected by an administrative user via the product questions setup page 410.

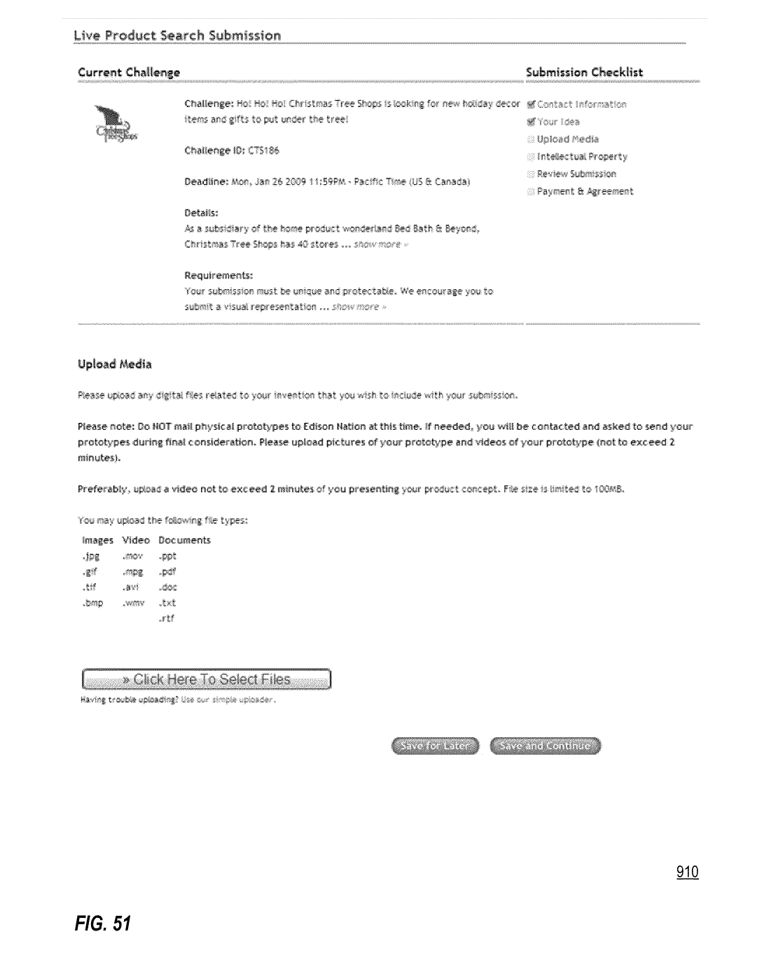

After entering information into the forms, the user effects navigation to an upload page 910 by clicking a “Continue” button. The upload page 910, which can be seen in FIG. 51, allows a user to upload files to a secure server accessible by administrative users of the website. The upload page 910 prompts a user to upload pictures and/or a video of a prototype product in accordance with their innovation, and further prompts the user to upload a video presentation of the innovation, not to exceed two minutes in length. In at least one embodiment, an interface of the upload page 910 allows a user to upload any type of file, but preferably uploads are limited to files with the following extensions: “.jpg”, “.gif” “.tif”, “.bmp”, “.mov”, “.mpg”, “.avi”, “.wmv”, “.ppt”, “.pdf”, “.doc”, “.txt”, and “.rtf”.

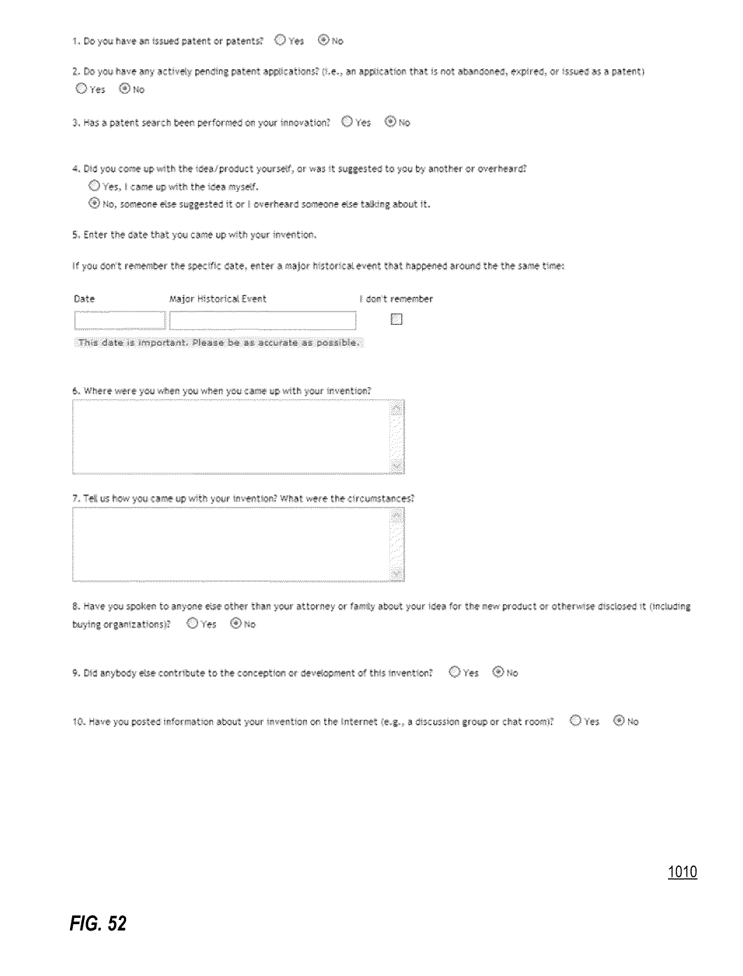

After uploading files as desired, the user effects navigation to an IP page 1010 by clicking a “Continue” button. The IP page 1010, which can be seen in FIG. 52, allows the user to answer questions related to intellectual property rights in his or her innovation using forms that were selected by an administrative user via the patent questions setup page 510.

After entering information into the forms, the user effects navigation to a submission summary page by clicking a “Continue” button. The submission summary page displays the information entered by the user on the preceding pages, and provides the user an opportunity to edit any of the entered information. If the user is satisfied with the information that he or she input, then the user effects navigation to a submission final page by clicking a “Continue” button.

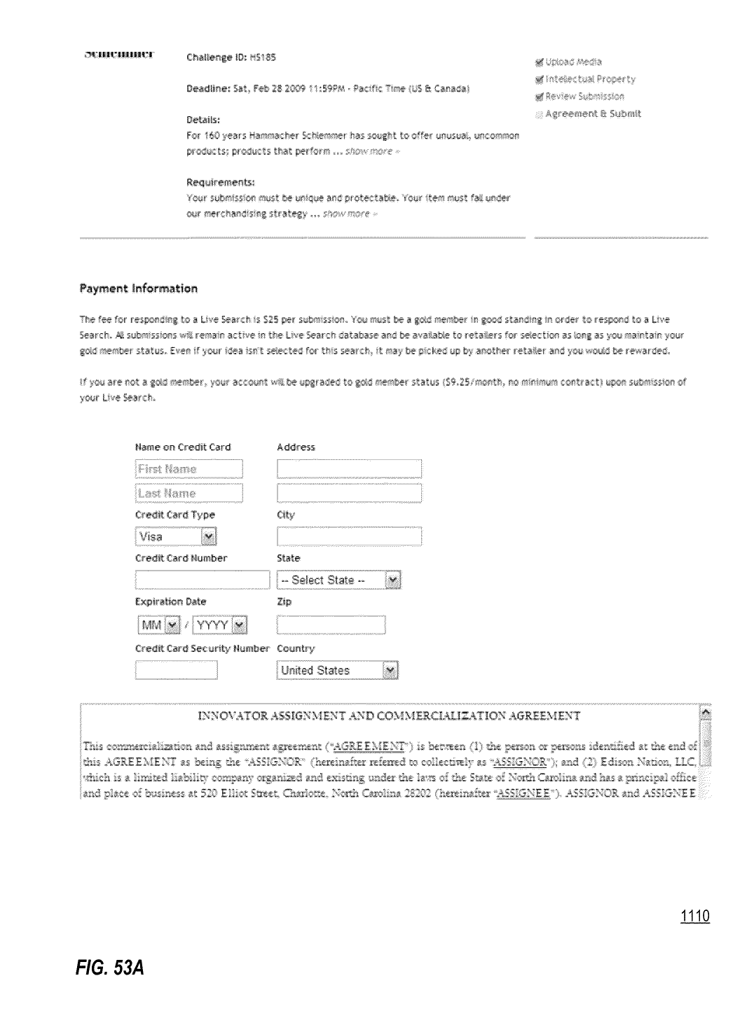

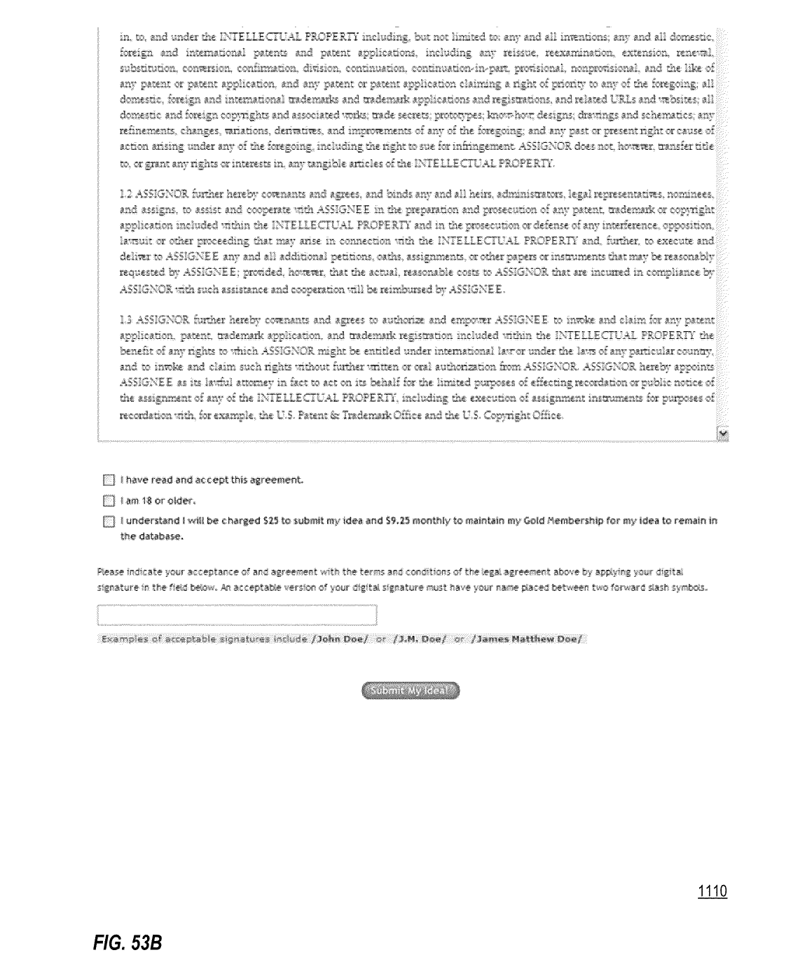

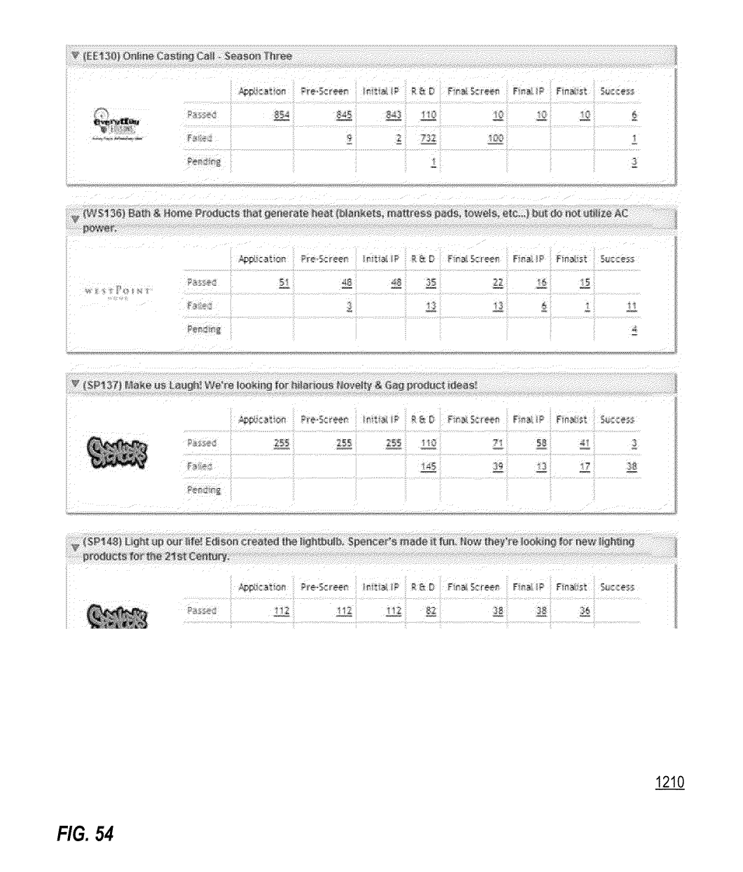

The submission final page 1110, which can be seen in FIGS. 53A-B, displays an “Innovator Agreement” for review by the user before submission. The Innovator Agreement is a legal agreement between the user and an entity named in the Innovator Agreement. Prior to completing their submission, a user must check a checkbox indicating that they have read and agree to the Innovator Agreement. A complete copy of an exemplary Innovator Agreement is attached as Appendix A hereto.

The submission final page 1110 also allows a user to view an “Innovator Assignment and Commercialization Agreement”, which is a companion agreement to the Innovator Agreement. A complete copy of an exemplary Innovator Assignment and Commercialization Agreement is attached as Appendix B hereto. Preferably, by accepting the Innovator Agreement, a user agrees to execute and enter into the Innovator Assignment and Commercialization Agreement if the submitted innovation is selected for commercialization. The Innovator Assignment and Commercialization Agreement preferably assigns all rights to the innovation to a named entity in exchange for a promise to pay an annuity stemming from successful commercialization to the user.

The submission final page 1110 preferably also includes a plurality of forms which allow a user to input payment information, such as, for example, credit card information. Preferably, a user must pay a fee, such as, for example, twenty five dollars ($25), in order to submit an innovation. In at least one embodiment, if a user submitting an innovation does not enjoy preferred status, the user will be charged the standard rate to obtain preferred status, and automatically upgraded to preferred status. The user will continue to be charged each month to maintain this preferred status as long as the submitted innovation is still being considered.

A checkbox is preferably included which requires a user to indicate that they understand they will be charged a certain amount for the submission, and, when applicable, that they will be charged each month for preferred status.

Another checkbox is included which requires a user to indicate that they are eighteen (18) years of age or older. Preferably, a user must check all of the checkboxes on the submission final page 1110 and then further electronically sign their name into an input form using forward slashes, i.e. a user named John Doe would sign “/John Doe/”.

After entering payment information, reviewing the applicable agreements, checking all required checkboxes, and signing their name, the user presses a “Submit” button to submit their innovation.

After making such a submission, a user can view the status of the submission on their dashboard page 610 of the website. The status of each submission is indicated through the use of stages. At each stage, the submission will either be passed through to the next stage, or else failed. If a submission successfully passes through a stage, this success will be indicated on a user's dashboard, preferably via a green “light”. If, on the other hand, a submission fails a stage, this will be indicated on the user's dashboard, preferably via a red “light”. Preferably, there are eight stages a submission must pass through, namely an “application” stage, a “pre-screen” stage, an “initial IP” stage, an “R&D” stage, a “final screen” stage, a “final IP” stage, a “finalist” stage, and a “success” stage. In alternative embodiments, however, these stages may be in a different order, have different names/functions, and include different and/or additional stages. In some preferred embodiments, one or more of these stages are automated, i.e. performed by one or more software functions. For example, in at least one embodiment, at the IP stage a filter eliminates all submissions that do not include an issued patent. In alternative embodiments, filters, as detailed hereinabove, can be used to pass or fail submissions at each stage.

In order for an innovation to be selected for commercialization, the submission it is associated with must successfully pass through each stage. In the preferred embodiment outlined above, a submission must pass through all eight stages in order for its innovation to be selected for commercialization.

Once a submission fails at any stage it will not proceed to the next stage, and will not be selected for commercialization. The stage at which it failed will be indicated on the user's dashboard page 610 of the website by a red light. After an innovation fails with respect to one search, however, the website will allow the user to submit the innovation in a new submission to a different search. Further, each submission will stay in a database of the website for consideration in future searches and queries (as detailed hereinbelow).

### Website Implementation—Sponsored Searches

Each search created as outlined above is preferably a sponsored search. A sponsored search is characterized thusly because it is undertaken on behalf of a sponsor which desires to obtain one or more innovations for purposes of commercialization.

As an example, consider Acme Corporation (“Acme”), a company which makes anvils and desires to bring a new anvil to market. In order to obtain innovative ideas relating to anvils, Acme contracts with an entity, “EN”, which controls a website in accordance with one or more aspects of the present invention, such as, for example, the exemplary website of FIG. 43A. EN and Acme enter into an agreement such as, for example, the “Master Agreement” attached hereto as Appendix C. In exchange for monetary or other consideration, EN promises to furnish Acme with knowledge of innovations obtained via the website. This monetary consideration preferably comprises a flat fee for each sponsored search posted on the website by EN, such as, for example, a flat fee of $2500. Preferably, a flat fee for running queries (as detailed hereinbelow) is included as well.

After EN runs a search, or query, (both of which are detailed hereinbelow) and identifies one or more innovations suitable for Acme, EN furnishes Acme with knowledge of the one or more innovations. Acme then considers the innovations for commercialization. Under the agreement between EN and Acme, if Acme decides to commercialize any of the innovations, Acme agrees to enter into an Innovation Agreement with respect to that innovation. Under the Innovation Agreement, Acme agrees to pay fees to EN quarterly. Preferably, these fees are equal to seven percent (7%) of gross receipts that arise from sales of products derived from the innovation. Additionally, Acme agrees to pay a success fee to EN for each innovation Acme selects for commercialization.

It will be appreciated that aspects and features of the present invention are not limited to the context of a website, but instead include the business method of EN outlined above.

It will further be appreciated that the above scenario with respect to EN and Acme is merely exemplary in nature. Embodiments in accordance with aspects and features of the present invention will be understood to encompass not only this exemplary scenario, but variations thereof as well.

### Website Implementation—Search Results

FIG. 54 is a screenshot of a search results page 1210 of the website of FIG. 43A. The search results page displays a summary of submissions that passed or failed at each stage, as well as submissions that are still pending at a current stage. Each summary numeral is a clickable link, i.e. an administrative user can effect navigation to a stage summary page 1310 displaying the 854 submissions that passed the application stage of the search “(EE130)” by clicking on the displayed “854” link.

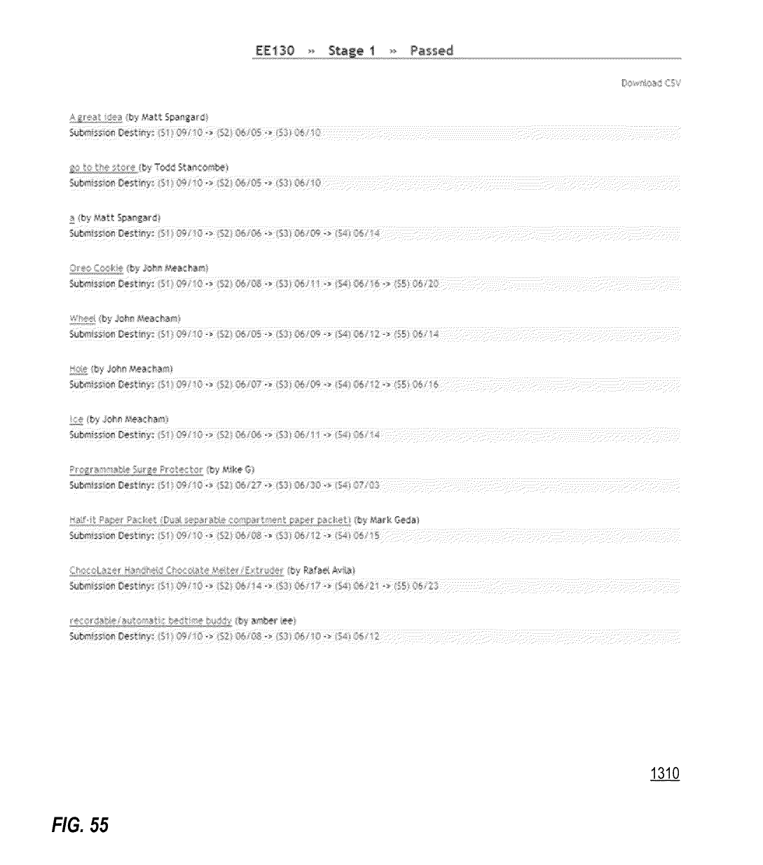

FIG. 55 illustrates this submissions page 1310. The stage summary page 1310 includes a clickable “Download CSV” link which downloads a spreadsheet file with a .csv extension which includes all of the details related to each of the submissions on that page. The stage summary page 1310 displays dates that each displayed submission received a red or green light at each stage, and further includes a clickable link associated with each submission. An administrative user clicks the clickable link associated with a submission to effect navigation to a submission summary page 1410.

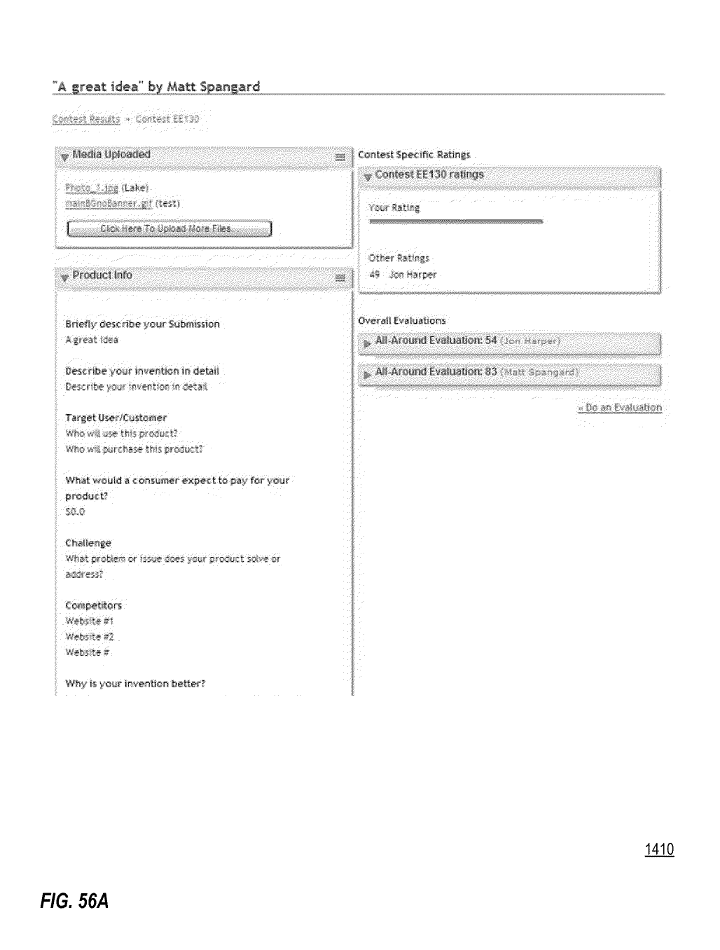

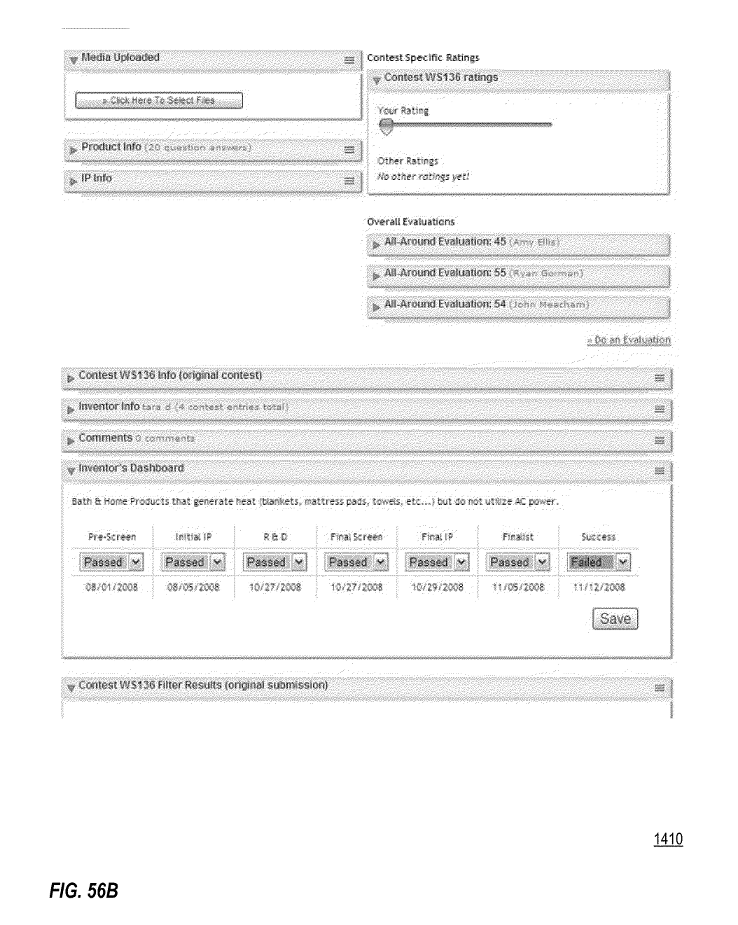

FIGS. 56A and 56B are exemplary submission summary pages 1410. Each submission summary page 1410 displays information entered as part of the submission, including any files uploaded as part of the submission, plus ratings by administrative users specific to that search, evaluations by administrative users that are not specific to that search, information on the search, information on the filters applicable to the search. A rating or evaluation can comprise both a numeric rating on, for example, a scale of 1 to 100, as well as comments regarding the submission. Preferably, these comments are displayed on each submission summary page 1410 as well.

Further, each submission summary page 1410 displays a summary of the red and green lights at each stage on the dashboard of the user who submitted the submission. An administrative user can change the status of the submission at any particular stage, for instance, an administrative user could change the submission from being “Pending” at the “Finalist” stage to having “Passed” the finalist stage, and save this change by clicking a “Save” button. After saving this change, the user's dashboard would indicate that they had passed the Finalist stage via a green light.

### Website Implementation—The Submission Database and Querying

As referenced above, after a submission fails at a stage of a particular search, the submission will not be selected for commercialization for that search. However, rather than having no chance of commercialization at that point, the submission remains in a database maintained by EN for as long as the user who submitted it remains a preferred member, unless the submission is withdrawn by that user. Alternatively, the submission remains in the database even if the user is no longer a preferred user.

When a new sponsored search is instituted, EN preferably reviews the submissions in the database to determine whether any innovations therein are responsive to the new sponsored search. The submissions that are determined to be responsive are submitted to the new sponsored search, and will be evaluated just as other submissions to the sponsored search will be.

Additionally, as mentioned above, rather than paying for a full search, sometimes a sponsor will merely wish to determine whether any submissions currently in the database meet certain criteria they have.

In order to make these determinations, a query will be run on the database. It will be appreciated that querying databases is well known, and these known methods of querying are utilized in one or more embodiments.

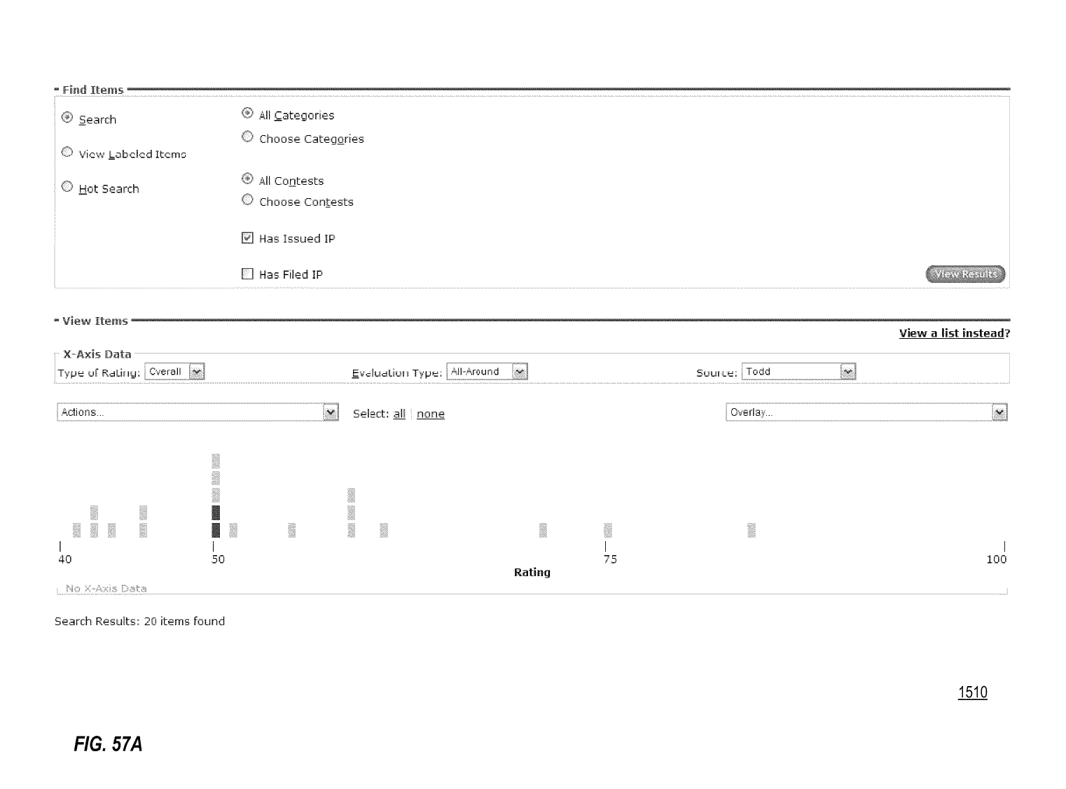

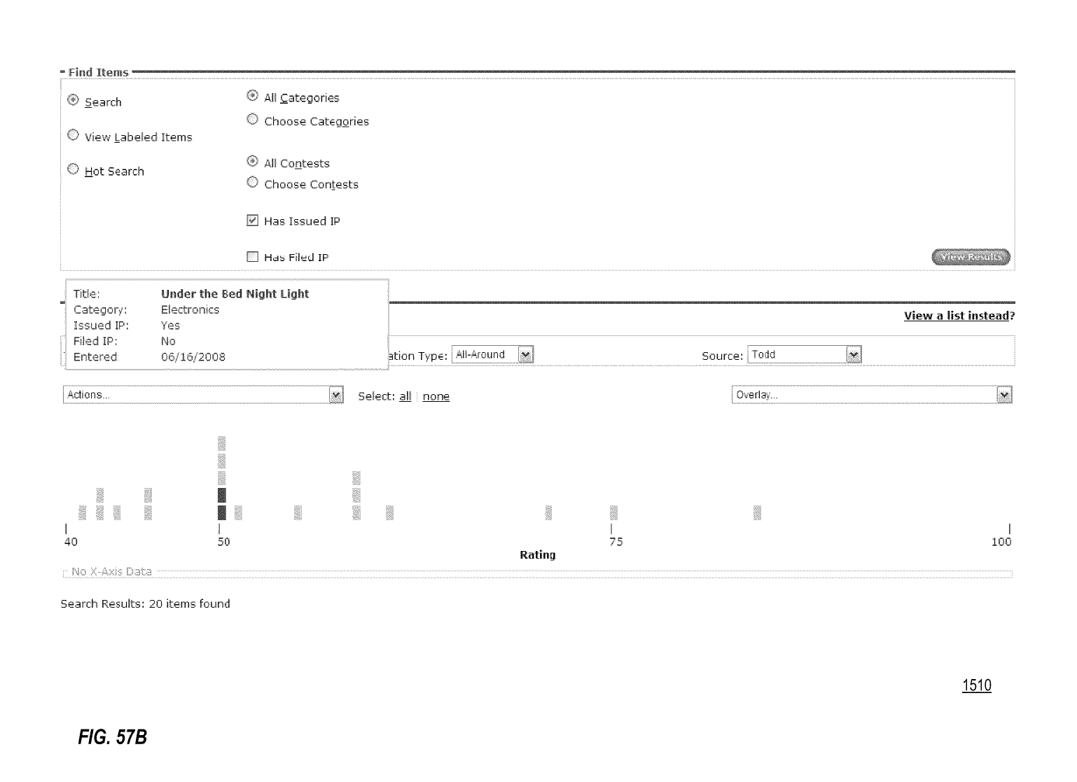

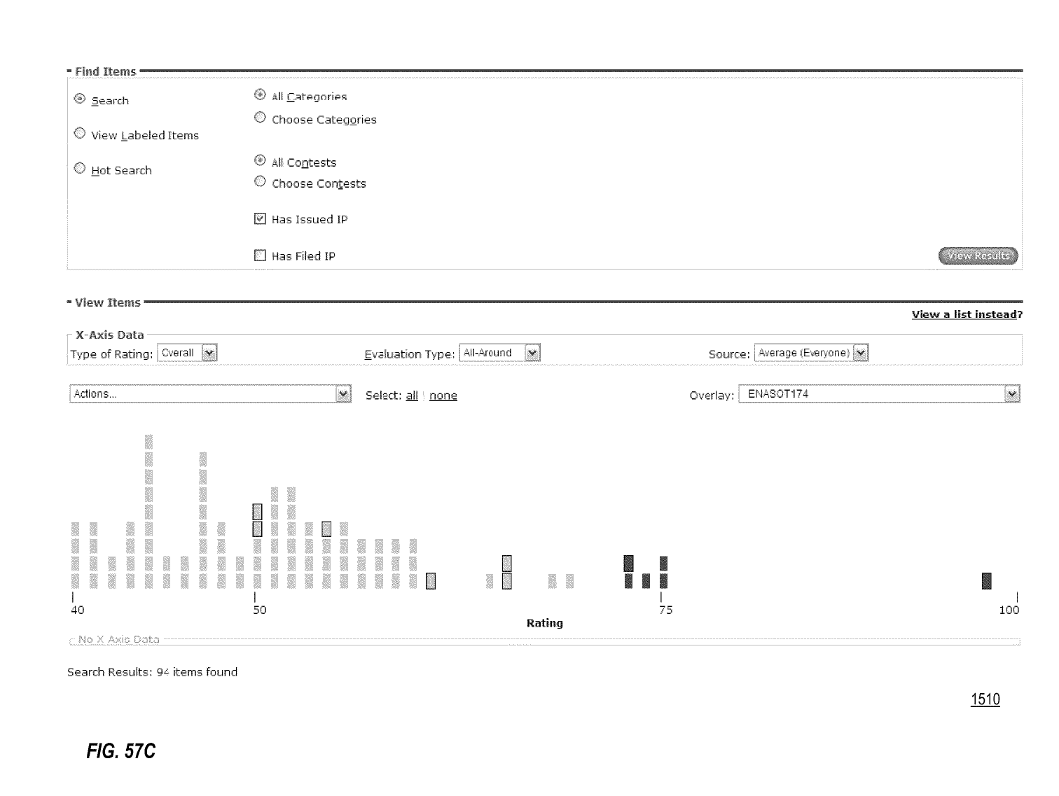

Preferably, however, the website includes a query page 1510, as can be seen in FIGS. 57A and 57B. The query page 1510 provides an interface which allows an administrative user to query the database for submissions having certain attributes. For example, the query page 1510 preferably allows an administrative user to run a query for all submissions which include an issued patent. In response, all submissions which are in the database that were submitted with an issued patent will be returned, as can be seen in FIG. 57A. Each submission returned is displayed on a graph as a rectangle. The submissions are plotted based on an evaluation score of the submissions. An administrative user can select whether they are plotted based on an average score, or based on a score by a particular administrative user.

When an administrative user mouses over a plotted submission, details associated with that submission are displayed, as can be seen in FIG. 57B. The administrative user can click on any of the plotted submission to open the submission summary page 1410 associated with that submission.

Further, the query page 1510 allows an administrative user to quickly determine additional information about displayed submissions via an overlay feature. Using an overlay selection drop down menu, an administrative user selects an attribute to generate an overlay for. For example, if an administrative user selects search number “ENASOT174” via the drop down menu, then each plotted submission which was submitted in that search is highlighted. Similarly, if an administrative user selects a particular administrative user's name via the drop down menu, then each plotted submission which was evaluated by that user is highlighted. It will be appreciated that similar highlighting can be performed for other attributes.

### Website Implementation—Other Website Functionality

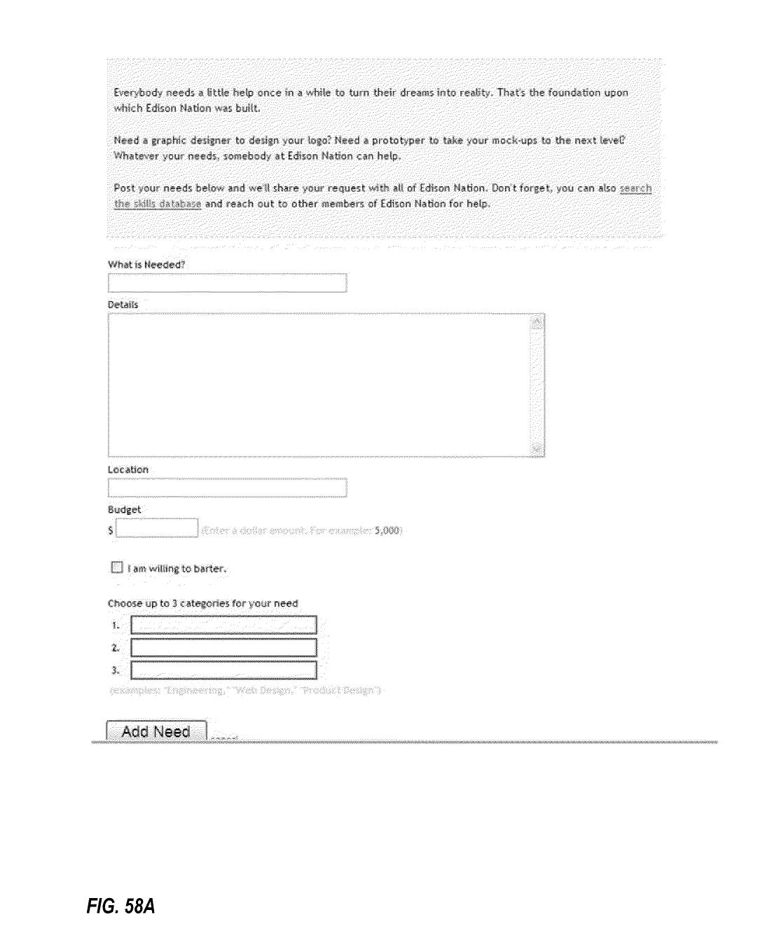

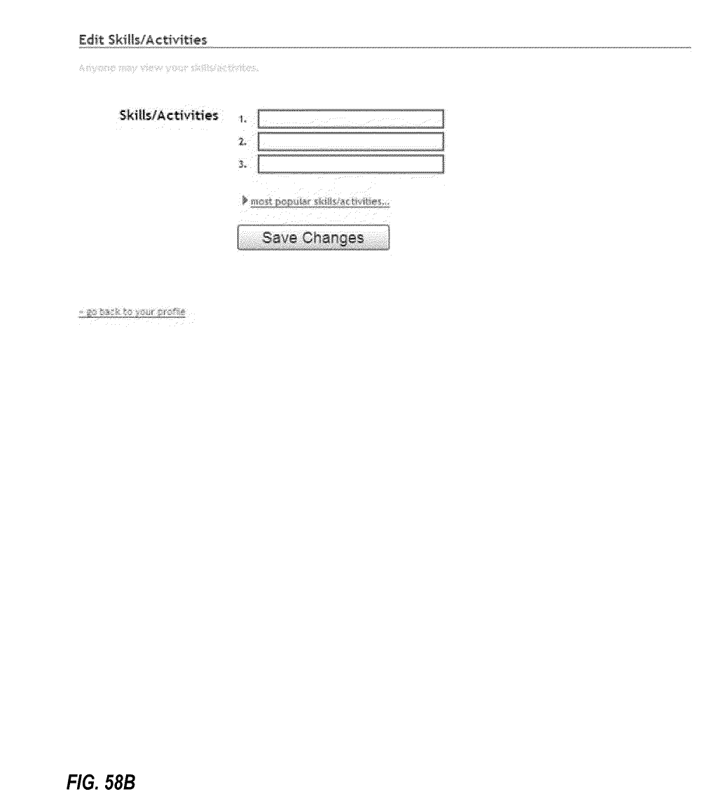

In addition to being able to make submissions to product searches, registered users of the website are able to utilize a wide variety of website functionality. Each registered user is able to create their own custom profile and display information from their custom profile on a custom webpage accessible via the website. Custom user profiles and user pages are well known, such as for example those of MySpace, Facebook, and LinkedIn. While one or more preferred embodiments utilize functionality known on these sites, the website further allows registered users to list their skills and their needs. Utilizing this functionality, a user can post needs that he or she has, list his or her skills, and view the needs of other users to determine whether or he or she might be able to meet those needs, as can be seen in FIGS. 58A and 58B.

The website additionally includes a forum, and allows registered users to post thereon. In preferred embodiments, the website also includes instant messaging, and allows two users logged on to the site to send instant messages in real time to one another. Similarly, the website preferably includes email, whereby registered users receive an email address and are able to access email sent to this email address via the website.

Still yet further, the website preferably includes an online store. The online store sells products to visitors of the site, including products commercialized or derived from innovations submitted to the website. The products sold by the online store are preferably shipped to a purchasing visitor.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1-42. (canceled)

43. A method of finding ideas of people for commercialization, the method comprising the steps of:
(a) receiving, by a first party, from each of a plurality of persons, a disclosure of an idea of that respective person without any obligation of confidentiality and without any restriction upon use by the first party;
(b) for each person from whom a disclosure of an idea is received in said step (a),
(i) identifying, by the first party, a good or service (collectively “Product”) embodying the disclosed idea;
(ii) considering, by the first party, patentability of the Product; and
(iii) considering, by the first party, commercial feasibility of the Product;
(c) selecting, by the first party, an idea from the plurality of received ideas based on the considerations of said step (b); and
(d) acquiring, by the first party, all intellectual property rights in the idea selected in said step (c) in exchange for certain consideration that is predetermined prior to receiving the disclosure of the selected idea in said step (a);
(e) wherein said step (b) is performed by a panel of people, and wherein the method further comprises the video recording, by a video recording device to a storage medium, of a disclosure to the panel of a subset of the ideas received in said step (a); and
(f) wherein the method further comprises producing a program utilizing the video recording of said step (e), and publicizing the program.

44. The method of claim 43, further comprising the step of requiring each person, from whom an idea is received in said step (a), to first agree to an obligation of assignment of all intellectual property rights in the idea from such person to the first party if the idea is selected in said step (c), the agreement to the obligation of assignment being a condition precedent to performance of the method by the first party with regard to such person's idea.

45. The method of claim 43, further comprising the step of requiring each person, from whom an idea is received in said step (a), to first consent to the video recording of the person for use in the program, the consent being a condition precedent to performance of the method by the first party with regard to such person's idea.

46. The method of claim 45, wherein the program comprises a reality television program or a documentary.

47. The method of claim 43, wherein the certain consideration comprises the right to receive a percentage of monies received from sales of the Product.

48. The method of claim 43, wherein the certain consideration comprises an annuity agreement between the first party and the person from whom the disclosure of the selected idea is received.

49. The method of claim 43, wherein the certain consideration comprises the right to receive a percentage of monies received from sales of any good or service that is covered by a patent that is filed disclosing the Product.

50. The method of claim 43, wherein the certain consideration comprises the right to receive a percentage of monies received from licensing of rights under a patent that is filed disclosing the Product.

51. The method of claim 43, wherein the first party is one of a limited liability company, a corporation, a partnership, and a trust, and wherein the first party further comprises any subsidiaries and affiliates thereof.

52. The method of claim 43, wherein said step (b) further comprises considering patentability and commercial feasibility of a variation of the Product.

53. The method of claim 43, wherein said step of considering commercial feasibility of the Product comprises considering design and manufacturing of the Product and considering market demand and size of the market for the Product.

54. The method of claim 43, wherein said step (b) is performed by a panel of people including at least one of a patent attorney, an engineer, and a marketing person.

55. The method of claim 43, wherein title to a patent property is acquired in said step (d).

56. The method of claim 55, wherein the patent property comprises a patent application or an issued patent, or both.

57. The method of claim 43, further comprising performing said step (a) at a publicly advertised casting call for ideas and, before the casting call, publicizing a contractual agreement governing the relationship between the first party and each respective person disclosing an idea in said step (a), execution of the contractual agreement being a condition precedent to performance of said step (a) by the first party.

58. A method of finding ideas of people for commercialization, the method comprising the steps of:
(a) receiving, by a first party, from each of a plurality of persons, a disclosure of an idea of that respective person without any obligation of confidentiality and without any restriction upon use by the first party;
(b) for each person from whom a disclosure of an idea is received in said step (a),
(i) identifying, by the first party, a good or service (collectively “Product”) embodying the disclosed idea;
(ii) considering, by the first party, patentability of the Product; and
(iii) considering, by the first party, commercial feasibility of the Product;
(c) selecting, by the first party, an idea from the plurality of received ideas based on the considerations of said step (b);
(d) acquiring, by the first party, all intellectual property rights in the idea selected in said step (c) in exchange for certain consideration that is predetermined prior to receiving the disclosure of the selected idea in said step (a); and
(e) requiring each person, from whom an idea is received in said step (a), to first agree both to,
(i) an obligation of assignment of all intellectual property rights in the idea from such person to the first party if the idea is selected in said step (c), the agreement to the obligation of assignment being a condition precedent to performance of the method by the first party with regard to such person's idea, and
(ii) consent to the video recording of the person for use in a program, the consent also being a condition precedent to performance of the method by the first party with regard to such person's idea;
(f) wherein said step (b) is performed by a panel of people, and wherein the method further comprises the video recording, by a video recording device to a storage medium, of a disclosure to the panel of a subset of the ideas received in said step (a); and
(g) wherein the method further comprises producing the program utilizing the video recording of said step (f), and publicizing the program.

59. A method of finding ideas of people for commercialization, the method comprising the steps of:
(a) receiving at a publicly advertised casting call for ideas, by a first party, from each of a plurality of persons, a disclosure of an idea of that respective person without any obligation of confidentiality and without any restriction upon use by the first party;
(b) for each person from whom a disclosure of an idea is received in said step (a),
(i) identifying, by the first party, a good or service (collectively “Product”) embodying the disclosed idea;
(ii) considering, by the first party, patentability of the Product; and
(iii) considering, by the first party, commercial feasibility of the Product;
(c) selecting, by the first party, an idea from the plurality of received ideas based on the considerations of said step (b);
(d) acquiring, by the first party, all intellectual property rights in the idea selected in said step (c) in exchange for certain consideration that is predetermined prior to receiving the disclosure of the selected idea in said step (a); and
(e) before the casting call, publicizing a contractual agreement governing the relationship between the first party and each respective person disclosing an idea in said step (a), execution of the contractual agreement being a condition precedent to performance of said step (a) by the first party;
(f) wherein said step (b) is performed by a panel of people, and wherein the method further comprises the video recording, by a video recording device to a storage medium, of a disclosure to the panel of a subset of the ideas received in said step (a); and
(g) wherein the method further comprises producing a program utilizing the video recording of said step (f), and publicizing the program.

60. The method of claim 59, wherein the contractual agreement requires each person, from whom an idea is received in said step (a), to agree both to,
(i) an obligation of assignment of all intellectual property rights in the idea from such person to the first party if the idea is selected in said step (c), and
(ii) consent to the video recording of the person for use in the program.

61-91. (canceled)
